(19) United States
(12) Patent Application Publication
(10) Pub. No.: US 2013/0290106 A1
(43) Pub. Date: Oct. 31, 2013

(54) SYSTEM AND METHOD FOR PROVIDING DIRECTIONS TO ITEMS OF INTEREST

(71) Applicant: Augme Technologies, Inc., New York, NY (US)

(72) Inventors: Nathaniel T. BRADLEY, Tucson, AZ (US); Jim G. CRAWFORD, Fall City, WA (US); Joshua S. PAUGH, Tucson, AZ (US); Douglas F. BENDER, Scotts Valley, CA (US)

(21) Appl. No.: 13/790,786

(22) Filed: Mar. 8, 2013

Related U.S. Application Data
(60) Provisional application No. 61/608,340, filed on Mar. 8, 2012.

(51) Int. Cl. G06Q 90/00

(52) U.S. Cl. CPC G06Q 90/20
USPC 705/14.64; 705/323

(57) ABSTRACT

The system and method directs or routes a user on a path within the mercantile environment which is either i) the quickest path from the user's position to a given product within the mercantile environment, or ii) a path that exposes the user to a plurality of products of potential interest to the user.

### CROSS-REFERENCE TO RELATED APPLICATIONS

The present invention claims priority to U.S. Provisional Application Ser. No. 61/608,340, filed Mar. 8, 2012 and is related to co-pending, commonly assigned U.S. Patent Application Publication No. US 2011/0264527A (the '527 Published Application), both of which are hereby incorporated in their entirety by reference.

### BACKGROUND OF THE INVENTION

The present invention relates generally to systems and methods for product-directed routing of shoppers within a mercantile environment. More specifically, the present invention provides a system and method that directs or routes a user on a path within the mercantile environment which is either i) the quickest path from the user's position to a given product within the mercantile environment, or ii) a path that exposes the user to a plurality of products of potential interest to the user.

### SUMMARY OF THE INVENTION

The system and methods for providing directions to items of interest permits a person to shop within the three dimensional space of a shopping environment, e.g., a free standing store, a store within a shopping mall, a shopping mall, itself, a shopping zone within a defined geographical area or even within a municipality, while being directed to items of actual or potential purchase interest by a communication device, such as a mobile phone or smartphone. The term “digital device” is used herein interchangeably with the term communication device. A shopper, synonymously termed herein a user, employing the communication device interacts with the communication device to have the digital device direct him or her to business establishments which may have an item of interest to the user. The digital device queries a user profile that may be stored on the digital device, may be stored on a server system and/or may utilize combined data stores consisting of a local user data store and a remote data store maintained on a server system or a database system. It will be understood, by those skilled in the art, that remote data stores are intended to include both single and distributed shared data resources, such as those shared data resources accessible over the Internet in what has become commonly known as “the Cloud.”

The shopper's profile will generally consist of user-specific information, such as user preferences, shopping history, shopping location history, brand preferences, pricing preferences, shopping locale or destination preferences, sizes, styles, or like information. Once the digital device acquires the shopper's profile, identifying information about the store or stores that carry the item(s) of interest may be displayed on the digital device. The user may then select a store, or the store in closest proximity to the user may be automatically selected as a default. Once the digital device formulates a user response, the device then displays the response in either a map form or a direction listing form, the response identifying the location or locations of the item(s) of interest in a tri-level mapping formula depicting the location of the product of interest within a multi-dimensional or three-dimensional shopping environment. Multi-dimensional may include several dimensions including three physical dimensions from a particular point in space, where a user can move are up/down, left/right, and forward/backward. Multi-dimensional may include also the temporal dimension, which is a dimension of time. An exemplary non-geopositioning planographic method of locating a user relative to items present within a three dimensional space, such as a retail shopping space, is described more fully in co-pending, commonly assigned U.S. Patent Application Ser. No. 61/493,223, which is hereby incorporated by reference.

Currently, remote or virtual shopping is accomplished using a computing digital device, such as a mobile phone, smartphone, tablet computer, laptop computer, desktop computer, or the like. A computing device user may either browse the Internet for items of interest to purchase, such as merchandise, services, music, videos, or the like, or may interface with advertising that display barcodes that, when captured by an image capture device connected to the computer device, immediately direct the user to a site on the Internet, typically a Uniform Resource Locator (URL) address where the user may obtain further information, offers, or the like pertaining to the subject matter of the advertising.

The digital device may also have an associated data capture device, which by capturing data to the data capture device, recognizes defined attributes within the captured data, processing the recognized attributes and returning a response to the user based upon the recognized attributes. The data capture device may consist, for example, of an RFID reader, a code reader, a web browser, a USB or other I/O device, a camera, a display, or other digital capture device. The data captured may be single mode or multi-modal data, and may consist, for example, of any sensory-type input, e.g., visual, auditory, olfactory, haptics, or gustatory obtained by capturing data from an artifact of interest to a user. Artifacts may consist of any type of product, activity, service, or media, or parts thereof that may serve to identify and distinguish the artifact of interest.

Cellular telephones have evolved from simple voice and text communication devices to mobile computing platforms complete with processors, Internet browsers, operating systems, and even software plug-ins such as JAVA. Today, Internet enabled “smartphones” have become a leading driver of growth in Internet traffic and utilization by consumers. Due to that growth, publishers are refocusing to reach consumers through mobile websites, social media, and commercial initiatives.

The accessibility of consumers while roaming also presents opportunities for capturing data from and about users of smartphones and other digital devices. These data are potentially valuable assets that may be used to generate consumer profiles, which may be used by marketing companies to generate targeted advertisements. For example, using location data generated by a smartphone, a consumer's location relative to the location of retailers may be tracked. These data may be used to provide the consumer information about a retailer and its products and services, and to offer consumers discounts to try a product and/or to remain loyal to a product. Additionally, these data may be used to provide the retailer information about the consumer and his or her likes and dislikes, and permits the retailer, marketer, or marketing company to target advertising or offers to individual consumers or groups of consumers based upon the acquired data.

Alternatively, there is a growing concern among digital device users to maintain their anonymity and keep their personal data, e.g., location, purchases, buying habits, Internet browsing habits, etc., confidential and protected from marketing companies or other commercial vendors seeking to target potential customers based upon digital device user profiles or usage habits. By providing means for maintaining user anonymity, the user's profile and personal data is not transmitted to or accessible to retailers, marketing companies, or other commercial vendors.

Visual inputs may consist of image capture, pattern recognition, text recognition, bar codes such as UPC or QR codes, hand gestures, or the like. Auditory inputs may consist of music, sound recognition, sound pattern recognition, spoken word recognition, or the like. Olfactory inputs may consist of inputs from artificial noses, such as that described by Stitzel, S. E., et al. in Artificial Noses, Ann. Rev. Biomed. Eng. Vol. 13, 1-25 (August 2011) or in U.S. Pat. No. 7,261,857, gas chromatographs or other instruments for detecting the presence of airborne elements. Haptic inputs may consist of data acquired by virtue of surface roughness measurements, such as by atomic force microscopy, by a tactile-sensing system such as that described by Decherchi, S., et al., IEEE Transactions on Robotics, 27(3), 635-639, June, 2011, or by tactile sensors as described in U.S. Pat. No. 7,823,467, each of which is expressly incorporated by reference. Finally, gustatory, or the taste inputs, may be obtained by employing a taste sensor, such as that described in U.S. Pat. No. 7,858,036 or the taste sensor data system described in U.S. Patent Application Publication No. 20040107053, each of which is expressly incorporated by reference.

The captured artifact data may then be used to either query the user with response options, e.g., purchase, add to shopping cart, add to favorites, etc., or may be further processed and compared with data in a data repository that recognizes the data input and returns a response to the user. The returned response may consist of further data associated with or related to the input data. Examples of the returned response may be, without limitation, an advertising campaign, ties to social networking communities, business-to-business information, suggestions of other products of interest to the user based upon the user's selection of the input data, suggestions of points of purchase which may be combined with pricing information, or the like.

Barcodes take the form of linear barcodes, such as Uniform Product Codes (UPC), matrix barcodes also known as 2D codes which encode a greater quantum of data in the barcode than linear barcodes, or three-dimensional or 3D barcodes which may be like either a linear barcode or a 2D code, but are typically embossed or engraved into a product surface and have regions of differing heights to provide still another source of data based upon height differentials of the different encoding regions of the 3D barcode. Irrespective of the type of barcode employed on advertising or a product, the current systems and methods typically solely rely upon the single mode of optical image capture from the barcode to direct the computer device user to a specific pre-defined URL or set of pre-defined URL's on the Internet.

From the perspective of a consumer, systems that, without the permission of the consumer, track his or her location and utilize these data for marketing and other purposes raise significant privacy issues regardless of any benefits the consumer may have received in return. From the perspective of a seller of products and services, the promise of mobile tracking systems may be costly to realize because control over the geographic information exposed in mobile network usage remains with the wireless network operators or the suppliers of the mobile devices, and may be less than advertised because of consumer privacy concerns.

The embodiments disclosed herein provide digital device users with a map or directions to product(s) of interest based on their past shopping or purchasing preferences. This may entail using Cookie-based map driven product recommendations based upon a user's profile. Mapping may be based upon an ant colony optimization algorithm to lead the user on a quickest path through the store to a product of interest, may be based upon bundled savings programs, or may be based upon other selection criteria presented to the user.

The embodiments disclosed herein allow the user to interact with artifacts representative of commercial products or services of interest to the user, and to use data acquired from such artifacts to compile a user-specific set of data regarding purchased products or services, or services or products of interest to a user.

The embodiments disclosed herein further comprise coupons or offers may be presented to the user, by displaying such coupons or offers on the user's digital device, based upon the user's profile and/or identified product or services of interest.

In another embodiment related to the above description, the user may be able to determine the range in which he or she would be interested in locating the item of interest. Much like the eBay shopping experience the user would be able to select a range of “local” (i.e. within the current shopping location [mall, retail store, etc.]), within 1 mile, 5 miles, 10 miles, etc.

The function of building the map for use by the user in locating products of interest which are based on prior buying experiences and/or preferences utilizes, is, in one embodiment, a tri-level mapping schema, such as that described in co-pending, commonly assigned U.S. Patent Application Ser. No. 61/493,223, which is hereby incorporated by reference; however, other mapping formulas or schemas are also possible for building the map which can then be used to inform the user, via their digital device, of location(s) where products or services of interest can be found.

Users frequently browse through on-line web sites showing products of various types which can be purchased by consumers. Often, these web sites store cookies on the user's digital device for future use by the web site to inform it of prior user visits/history on the site. Cookies can be used to indicate a particular preference by brand, style, color, size, etc. The preferences reflected by a cookie can be utilized by this invention to build the user map for directing the user to the location or locations of a product or products of interest.

Ambient data can also be utilized by the embodiments disclosed herein as a means for user product selection and subsequently utilized by a tri-level mapping formula or algorithm in directing the user, via their digital device, to a location or locations where products of interest can be found.

In an embodiment, a user is walking by a Starbucks and notices an ad for Loreal makeup on a passing public bus. The user scans the ad which is recognized by the digital device, a process more fully described in co-pending, commonly assigned U.S. patent application Ser. No. 13/658,448, filed Oct. 23, 2012, and the user selects an option which builds a location map (such as the tri-level mapping described in co-pending, commonly assigned U.S. Patent Application Ser. No. 61/493,223) which directs them, via their digital device, to a location or locations where the product(s) of interest can be found.

Embodiments are directed to mapping mobile marketing engagements of consumers who voluntarily agree to participate (i.e., “opt-in”) in product marketing campaigns to geospatial locations without the use of information generated by mobile network usage.

In an embodiment, an anonymous statistical model relates opted-in consumer engagements to three data layers that make up a tri-level mapping system. In this embodiment, the engagements are tracked, not the consumers. An anonymous consumer record is produced that transforms data used to associate user profiles with products, brands and retail real estate into actionable and valuable mobile marketing analytics.

In an embodiment, retail environments are mapped. Using this mapping, intelligence and econometrics can be derived without any geographic information being taken from the mobile device. Mobile engagements are anonymously tracked as they overlap with retail real estate and as they relate to products, promotions, and brands. The opt-in nature of any consumer engagement allows the consumer to engage and enjoy rich mobile marketing experiences on an anonymous basis without the data intrusion, identity exposure, and geo-location traction that occurs with existing GPS based consumer tracking systems.

The embodiments disclosed herein provide a more robust and flexible system and method based upon multi-modal sensory data inputs. The multi-modal sensory data inputs may include, but are not limited to optical image capture from barcodes. Other sensory data inputs may be that obtained from optical image capture from visual pattern recognition, environmental or contextual recognition, text recognition, color recognition, or motion detection, capture and recognition, e.g., hand or body gestures. Auditory sensory data inputs may also be employed with the system and method of the embodiments disclosed herein. Examples of auditory sensory data may include, for example, music, sound patterns, natural or artificially-generated sounds, or the like. Olfactory sensory data may include, for example, data representing scents from foods, perfumes or colognes, environmental pollutants, ambient atmospheric scents, gases emitted in agricultural or industrial production, or the like. Tactile sensory data may include, for example, data representing textiles, material surface characterization, such as that during planarizing or patterning processes, e.g., sanding, finishing, spinning, polishing, etching, etc. or in artwork, or the like. Finally, gustatory sensory data may include, for example, data pertaining to relative sweetness, tartness, bitterness, spiciness, acidity, basicity, or other qualities pertaining to the taste of food-stuffs.

In accordance with one embodiment, there is provided a method of allowing a user to shop using portable devices using image recognition in a multi-modal mobile response engagement/promotion system or image capture technology in a multi-modal mobile response system tied to a data repository that recognizes the multi-modal data inputs. The user is allowed to shop using a mobile computing device, such as a smartphone or tablet computer, use the image recognition or image capture capabilities of the mobile computing device to recognize multi-modal data input and eliminate the need for the presence of barcode, e.g., QR, DM, or any type of tag code technology, associated with advertising or product offerings. The system and method are, therefore, independent of barcode technology and GPS-based locational systems and methods. Rather, because the multi-modal data inputs may be, for example, voice, music, brand images, brand texts, product images, textile patterns, hand or body gestures, or environmental patterns (such as building, signage or intersection landmarks), responses returned to the user may similarly be multi-modal and/or multi-variant.

In accordance with another embodiment, there is provided a system and method for enabling a user who is browsing a retailer's media, such as a print catalog, on-line web site, on-line advertisement, print advertisement, video, etc., to select an item of potential purchasing interest reflected in the retailer's media by pointing the user's computing device to the media. The computing device recognizes at least one data artifact in the media, i.e., product image, product brand, trademark, audio signal, etc., communicates with a remote data repository and prompts the user to select among a number of options that may include the option of adding the product to a shopping cart, the option of marking the product as a favorite, the option of obtaining more detailed information about the product, the option of searching and viewing similar product items, the option of finding competitive pricing or alternative points of purchase for the product, or the like.

In accordance with the embodiments disclosed herein, a user with a supported computing device listens to music, such a song or instrumental, and decides he or she wants to purchase the music either for download or on a recorded medium. The supported computing device recognizes the song, either through acoustic recognition, data recognition from header information encoded with the music, such as ID3 tags, or from image capture of print media associated with recorded media for the music. The system then prompts the user to disposition an action on the song, e.g., purchase, move to shopping card, add to a playlist or suggest other music in the musical genre or by the same artist of the music of interest. While conceptually similar to the GENIUS BAR portion of ITUNES, where music of possible interest to a user is suggested to the user within the ITUNES application, the embodiments disclosed herein is asynchronous with any particular media service application and permits the user to encounter media of interest across many different points of encounter, e.g., shopping mall, restaurant, home theater system, nightclub, etc., and register interest by capturing data from the media of interest and acting on it as described in the embodiments disclosed herein.

In accordance with yet another aspect of the embodiments disclosed herein, there is provided a system and method for a user, in combination with a supported computing device, to target an advertisement with his or her computing device, which causes the computing device to recognize the advertiser's brand, such as by the trademark, logo, or product configuration; data identifying the advertiser's brand is then communicated to a data repository and the user is prompted to select among a number of response types to upload from the data repository to the user's computing device, such as what other products this advertiser may have that the user may be interested in, upload information about the particular product advertised, upload information about alternative products or services from competitive sources other than the advertiser, or present the user with the advertiser's full internet affiliate site, e.g., the full site, mobile site, sub-site related specifically to the item reflected in the targeted advertisement, or the like. The user may also be prompted to initiate and/or complete a purchase process.

In accordance with another aspect of the embodiments disclosed herein, there is provided a system and method for exchange of coupon offers between socially networked groups based upon the one group encountering a coupon offer and exchanging the coupon offer with other members of the socially networked group. In this embodiment, one user with a supported computing device is physically present at a business establishment, e.g., STARBUCKS, at a first geographical location. Another member of the socially networked group, e.g., a friend, is present at a similar business establishment, e.g., another STARBUCKS, at a remote geographical location. Both members of the socially networked group have already “checked in” via their social network. The first user targets an offer existing in the first business establishment with his or her computing device, e.g., a “special offer” on a STARBUCK'S coffee cup or a “special offer” posted in the store, and communicates the “special offer” via the social network to the second user. The second user is then able to target the “special offer” in the second business establishment location, and initiate a purchase process activity within his or her respective business establishments and locations.

These and other aspects, objectives, features and advantages of the embodiments disclosed herein will be described hereinafter with reference to the embodiments disclosed herein. Generally, the system of the embodiments disclosed herein employs a Code Triggered Information Server (“CTIS”) and a CTIS Database.

Content providers, such as providers of services, print content, display content, electronic content, video content, musical content, retailers, wholesalers, web-site providers, mercantile product providers, industrial product providers, or virtually any other type of commercial, informational, educational or service provider, will participate in providing content (generally and broadly referred to herein by the term “Ad” or “Directions”) for ultimate dissemination to users. The CTIS Server stores the Directions from the content providers and delivers the Directions to users based upon users registering interest in particular artifacts of interest to the users. The Directions may be stored on the CTIS server itself, storage directly coupled to the CTIS server or on third party servers referenced by the CTIS server.

Users may register for access to the CTIS via the internet, telephone, postal mail, and/or the like. If a particular embodiment of the CTIS requires client software for the user to install, this could be supplied upon successful user registration. In an alternative embodiment, a basic user identification packet (e.g., a “cookie”) is sent with a user's first code scan, thus establishing a basic user profile that can be filled in with greater detail at a later time.

The functionality of the CTIS and its operation and cooperation with the CTIS Database will be described in greater detail hereinafter. However, generally, the CTIS Database, which may be centralized or distributed, may be proprietary or may be an open database capable of operating across multiple database sites on the Internet, in the Cloud or across various search engines, to look up data either residing with the CTIS Database or retrieve the data from external sources and incorporate the data into the CTIS Database. The CTIS Server, therefore, acts as a type of gateway between artifacts captured by the user and Directions in the CTIS Database to be distributed to the user based upon the user captured artifacts.

As used herein the terms “Ad” or synonymously “advertising” are intended to broadly include any type of information contained within a Reply Message (described hereinafter) that either prompts a user to take an action or for a disposition on information provided or provides information to a user relevant to the artifact or alternatives to the artifact.

As used herein, the term “Directions” is intended to broadly include any type of information contained within a Reply message (described hereinafter) that directs a user from their current position to the location of a product/service of interest to the user, and may include advertising content related to the product/service of interest to the user.

As used herein the term “artifact” is intended to include, without limitation, products, activities, services, print, visual, electronic or audible media, barcodes, brand names, product configurations, including, for example, packaging or container configurations, shapes or color combinations for products (e.g., pharmaceutical capsule color coding or pill shapes), video, body movements or gestures, olfactory scents, haptic or tactile stimuli, sound stimuli, and/or gustatory or taste stimuli.

### BRIEF DESCRIPTION OF THE DRAWINGS

FIGS. 1a-b show combined logic and data flow block diagram illustrating a general overview of embodiments of a Code Triggered Information Server (CTIS) for delivering Reply Messages;

FIG. 2a shows a particular, exemplary embodiment of the GCSI/CTIS, wherein contextual Directions, information, and advertising are served to the user related to a news article in the business section of a media publication; FIG. 2b shows a particular, exemplary embodiment of the GCSI/CTIS, wherein contextual Directions are served to the user related to a code/artifact scan from a Loreal advertisement; FIG. 2c shows a particular, exemplary embodiment of the GCSI/CTIS, wherein contextual Directions are served to the user related to a Ralph Lauren product of interest;

FIG. 3a is a block diagram illustrating a network for collecting and processing consumer engagement data according to an embodiment; FIG. 3b is a block diagram illustrating data structures of a tri-level mapping system according to an embodiment; FIG. 3c is a block diagram illustrating a facility and floor plan datastore of a tri-level mapping system according to an embodiment; FIG. 3d is a block diagram illustrating a product placement location datastore of a tri-level mapping system according to an embodiment; FIG. 3e is a block diagram illustrating a consumer engagement datastore according to an embodiment; FIG. 3f is block diagram illustrating a correlation model according to an embodiment;

FIG. 4 shows an embodiment of the web interface for user registration;

FIG. 5a shows three types of 2D barcodes that may be employed within the CTIS; FIGS. 5b-c show logic flow for code enhancement in one embodiment of CTIS operation; FIG. 5d shows an implementation of logic flow for customized repair and/or decoding of obscure or ambiguous scanned codes;

FIG. 6 shows an illustration of one embodiment of the Scan Message data structure;

FIG. 7a shows an illustration of one embodiment of a user profile data structure; FIG. 7b shows an implementation of a user profile user interface in one embodiment of GCSI/CTIS operation;

FIG. 8 shows an illustration of one embodiment of the Information Base (Directions) data structure;

FIG. 9 shows a logic flow diagram of one embodiment of the user profile query heuristic;

FIG. 10 is a flow diagram showing a weighting system may be employed to select among the Directions of a specific Directions provider once it is established that Directions from this provider is to be served to the user;

FIGS. 11a-c show some embodiments of systems for selecting information to serve to users;

FIGS. 12a-b show examples of coupons provided by the CTIS;

FIG. 13 shows a combined logic and data flow block diagram for an embodiment of the CTIS wherein contextual Directions are replaced by Directions based on ambient conditions;

FIG. 14 shows a combined logic and data flow block diagram for a particular exemplary embodiment of the CTIS in which directions to pharmacies selling allergy medication are served in response to a high pollen count;

FIG. 15 shows a combined logic and data flow block diagram for a particular exemplary embodiment of the CTIS in which Directions to retailers selling sunscreen are served in response to heat and high UV levels;

FIG. 16 shows a combined logic and data flow block diagram for an embodiment of the CTIS wherein the selection of contextual Directions is influenced by ambient conditions;

FIG. 17 shows a combined logic and data flow block diagram for a particular exemplary embodiment of the CTIS in which Directions to a car dealership selling luxury convertibles are served based on warm weather conditions, a scanned code, and the user profile;

FIG. 18 shows a combined logic and data flow block diagram for a particular exemplary embodiment of the CTIS in which Directions to a travel agent organizing Florida travel area served based on cold/rainy weather conditions, a scanned code, and the user profile;

FIG. 19 shows a combined logic and data flow block diagram for a particular exemplary embodiment of the CTIS in which Directions to an ice cream shop are served based on warm weather conditions, a scanned code, and the user profile;

FIG. 20 shows a combined logic and data flow block diagram for a particular exemplary embodiment of the CTIS in which Directions to a merchant carrying ponchos and umbrellas are served based on rainy weather conditions, a scanned code, and the user profile;

FIG. 21 shows an implementation of a user interface manifesting GCSI/CTIS functionality on a portable electronic device in one embodiment of GCSI/CTIS operation;

FIG. 22 shows an implementation of a user interface manifesting GCSI/CTIS functionality on digital paper in one embodiment of GCSI/CTIS operation;

FIG. 23 shows an implementation of a user interface manifesting GCSI/CTIS functionality on a digital billboard in one embodiment of GCSI/CTIS operation;

FIG. 24 shows an implementation of a user interface manifesting GCSI functionality for serving a short messaging service text message prompt in one embodiment of GCSI/CTIS operation;

FIG. 25 shows an implementation of a user interface manifesting GCSI/CTIS functionality on a mobile phone in one embodiment of GCSI/CTIS operation;

FIG. 26 shows an implementation of a user interface manifesting GCSI/CTIS functionality on a portable communication device in one embodiment of GCSI/CTIS operation;

FIG. 27 shows an implementation of logic flow for media acquisition in one embodiment of GCSI/CTIS operation;

FIG. 28 shows an illustration of media sampling and full media acquisition in one embodiment of GCSI/CTIS operation;

FIGS. 29a-b show an implementation of logic flow for code scan monetization in one embodiment of GCSI/CTIS operation;

FIGS. 30a-e show aspects of implementations of JagTag encoding and codes in some embodiments of GCSI/CTIS operation; and

FIG. 31 shows a computer systemization of the CTIS, shows an implementation of a user interface manifesting GCSI/CTIS functionality on a portable communication device in one embodiment of GCSI/CTIS operation.

### DETAILED DESCRIPTION OF THE INVENTION

### Definitions and Terminology

As used herein, the term “anonymous” encompasses the treatment of data that comes from opted-in consumers wherein consumer personal information is not used, stripped from data records or otherwise is sanitized so that individual consumer identity is not discoverable.

As used herein, the term “engage” encompasses any activity of a consumer whereby a consumer takes an affirmative interaction with a particular product or service that results in a data record of that interaction. An engagement may occur inside a retail facility, outside of a retail facility, or in a virtual environment.

As used herein, the term “planogram” encompasses the physical location of products, promotions, and brands within a floor plan of a retail facility.

As used herein the terms “Ad” or synonymously “advertising” are intended to broadly include any type of information contained within a Reply Message (described hereinafter) that either prompts a user to take an action or for a disposition on information provided or provides information to a user relevant to the artifact or alternatives to the artifact.

As used herein, the term “Directions” is intended to broadly include any type of information contained within a Reply message (described hereinafter) that directs a user from their current position to the location of a product/service of interest to the user, and may include advertising content related to the product/service of interest to the user.

As used herein the term “artifact” is intended to include, without limitation, products, activities, services, print, visual, electronic or audible media, barcodes, brand names, product configurations, including, for example, packaging or container configurations, shapes or color combinations for products (e.g., pharmaceutical capsule color coding or pill shapes), video, body movements or gestures, olfactory scents, haptic or tactile stimuli, sound stimuli, and/or gustatory or taste stimuli.

### Servers, Computers, Clients, Networks, Routers

Typically, users, which may be people and/or other systems, engage information technology systems (e.g., commonly computers) to facilitate information processing. In turn, computers employ processors to process information; such processors are often referred to as central processing units (CPU). A common form of processor is referred to as a microprocessor. CPUs use communicative signals to enable various operations. Such communicative signals may be stored and/or transmitted in batches as program and/or data components facilitate desired operations. These stored instruction code signals may engage the CPU circuit components to perform desired operations. A common type of program is a computer operating system, which, commonly, is executed by CPU on a computer; the operating system enables and facilitates users to access and operate computer information technology and resources. Common resources employed in information technology systems include: input and output mechanisms through which data may pass into and out of a computer; memory storage into which data may be saved; and processors by which information may be processed. Often information technology systems are used to collect data for later retrieval, analysis, and manipulation, commonly, which is facilitated through a database program. Information technology systems provide interfaces that allow users to access and operate various system components.

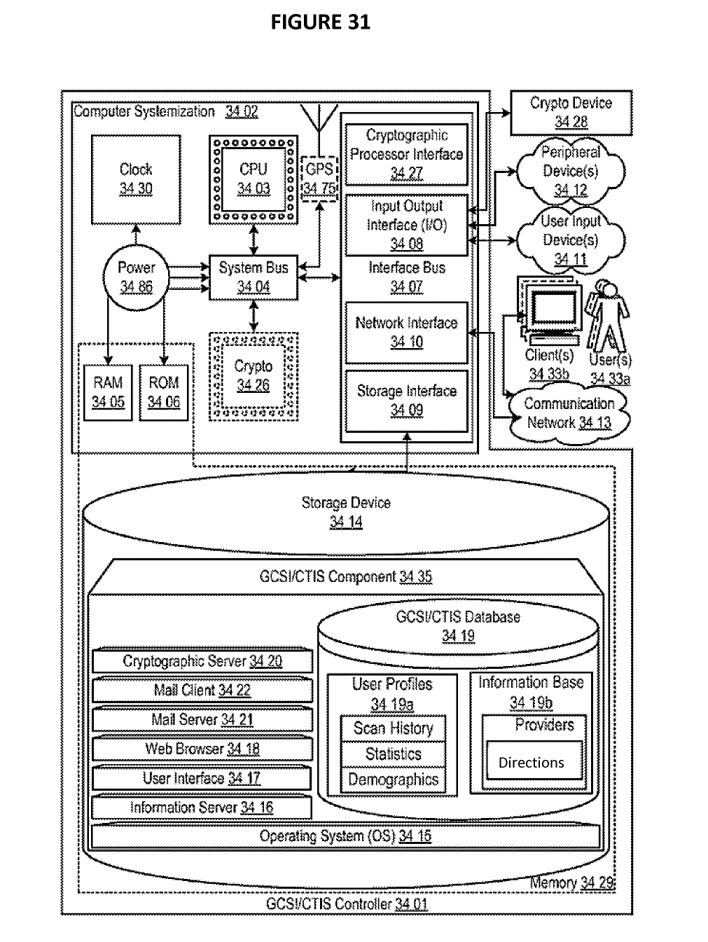

In one embodiment, the code triggered information server controller 3401 may be connected to and/or communicate with entities such as, but not limited to: one or more users from user input devices 3411; peripheral devices 3412; a cryptographic processor device 3428; and/or a communications network 3413, as shown in FIG. 31.

Networks are commonly thought to comprise the interconnection and interoperation of clients, servers, and intermediary nodes in a graph topology. It should be noted that the term “server” as used throughout this disclosure refers generally to a computer, other device, program, or combination thereof that processes and responds to the requests of remote users across a communications network. Servers serve their information to requesting “clients.” The term “client” as used herein refers generally to a computer, other device, program, or combination thereof that is capable of processing and making requests and obtaining and processing any responses from servers across a communications network. A computer, other device, program, or combination thereof that facilitates, processes information and requests, and/or furthers the passage of information from a source user to a destination user is commonly referred to as a “node.” Networks are generally thought to facilitate the transfer of information from source points to destinations. A node specifically tasked with furthering the passage of information from a source to a destination is commonly called a “router.” There are many forms of networks such as Local Area Networks (LANs), Pico networks, Wide Area Networks (WANs), Wireless Networks (WLANs), etc. For example, the Internet is generally accepted as being an interconnection of a multitude of networks whereby remote clients and servers may access and interoperate with one another.

The code triggered information server controller 3401 may be based on common computer systems that may comprise, but are not limited to, components such as: a computer systemization 3402 connected to memory 3429.

### Computer Systemization

A computer systemization 3402 may comprise a clock 3430, central processing unit (CPU) 3403, a read only memory (ROM) 3406, a random access memory (RAM) 3405, and/or an interface bus 3407, and most frequently, although not necessarily, are all interconnected and/or communicating through a system bus 3404, as shown in FIG. 31. Optionally, the computer systemization may be connected to an internal power source 3486. Optionally, a cryptographic processor 3426 may be connected to the system bus. The system clock typically has a crystal oscillator and provides a base signal. The clock is typically coupled to the system bus and various clock multipliers that will increase or decrease the base operating frequency for other components interconnected in the computer systemization. The clock and various components in a computer systemization drive signals embodying information throughout the system. Such transmission and reception of signals embodying information throughout a computer systemization may be commonly referred to as communications. These communicative signals may further be transmitted, received, and the cause of return and/or reply signal communications beyond the instant computer systemization to: communications networks, input devices, other computer systemizations, peripheral devices, and/or the like. Of course, any of the above components may be connected directly to one another, connected to the CPU, and/or organized in numerous variations employed as exemplified by various computer systems.

The CPU comprises at least one high-speed data processor adequate to execute program components for executing user and/or system-generated requests. The CPU may be a microprocessor such as AMD's Athlon, Duron and/or Opteron; IBM and/or Motorola's PowerPC; IBM's and Sony's Cell processor; Intel's Celeron, Itanium, Pentium, Xeon, and/or XScale; and/or the like processor(s). The CPU interacts with memory through signal passing through conductive conduits to execute stored signal program code according to conventional data processing techniques. Such signal passing facilitates communication within the code triggered information server controller and beyond through various interfaces. Should processing requirements dictate a greater amount speed, parallel, mainframe and/or super-computer architectures may similarly be employed. Alternatively, should deployment requirements dictate greater portability, smaller Personal Digital Assistants (PDAs) may be employed.

### Power Source

The power source 3486 may be of any standard form for powering small electronic circuit board devices such as the following power cells: alkaline, lithium hydride, lithium ion, lithium polymer, nickel cadmium, solar cells, and/or the like, as shown in FIG. 31. Other types of AC or DC power sources may be used as well. In the case of solar cells, in one embodiment, the case provides an aperture through which the solar cell may capture photonic energy. The power cell 3486 is connected to at least one of the interconnected subsequent components of the code triggered information server thereby providing an electric current to all subsequent components. In one example, the power source 3486 is connected to the system bus component 3404. In an alternative embodiment, an outside power source 3486 is provided through a connection across the I/O interface 3408. For example, a USB and/or IEEE 1394 connection carries both data and power across the connection and is therefore a suitable source of power.

### Interface Adapters

Interface bus(ses) 3407 may accept, connect, and/or communicate to a number of interface adapters, conventionally although not necessarily in the form of adapter cards, such as but not limited to: input output interfaces (I/O) 3408, storage interfaces 3409, network interfaces 3410, and/or the like, as shown in FIG. 31. Optionally, cryptographic processor interfaces 3427 similarly may be connected to the interface bus. The interface bus provides for the communications of interface adapters with one another as well as with other components of the computer systemization. Interface adapters are adapted for a compatible interface bus. Interface adapters conventionally connect to the interface bus via a slot architecture. Conventional slot architectures may be employed, such as, but not limited to: Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and/or the like.

Storage interfaces 3409 may accept, communicate, and/or connect to a number of storage devices such as, but not limited to: storage devices 3414, removable disc devices, and/or the like. Storage interfaces may employ connection protocols such as, but not limited to: (Ultra) (Serial) Advanced Technology Attachment (Packet Interface) ((Ultra) (Serial) ATA(PI)), (Enhanced) Integrated Drive Electronics ((E)IDE), Institute of Electrical and Electronics Engineers (IEEE) 1394, fiber channel, Small Computer Systems Interface (SCSI), Universal Serial Bus (USB), and/or the like.

Network interfaces 3410 may accept, communicate, and/or connect to a communications network 3413. Through a communications network 3413, the code triggered information server controller is accessible through remote clients 3433b (e.g., computers with web browsers) by users 3433a. Network interfaces may employ connection protocols such as, but not limited to: direct connect, Ethernet (thick, thin, twisted pair 10/100/1000 Base T, and/or the like), Token Ring, wireless connection such as IEEE 802.11a-x, and/or the like. A communications network may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. A network interface may be regarded as a specialized form of an input output interface. Further, multiple network interfaces 3410 may be used to engage with various communications network types 3413. For example, multiple network interfaces may be employed to allow for the communication over broadcast, multicast, and/or unicast networks.

Input Output interfaces (I/O) 3408 may accept, communicate, and/or connect to user input devices 3411, peripheral devices 3412, cryptographic processor devices 3428, and/or the like. I/O may employ connection protocols such as, but not limited to: Apple Desktop Bus (ADB); Apple Desktop Connector (ADC); audio: analog, digital, monaural, RCA, stereo, and/or the like; IEEE 1394a-b; infrared; joystick; keyboard; midi; optical; PC AT; PS/2; parallel; radio; serial; USB; video interface: BNC, coaxial, composite, digital, Digital Visual Interface (DVI), RCA, RF antennae, S-Video, VGA, and/or the like; wireless; and/or the like. A common output device is a television set, which accepts signals from a video interface. Also, a video display, which typically comprises a Cathode Ray Tube (CRT) or Liquid Crystal Display (LCD) based monitor with an interface (e.g., DVI circuitry and cable) that accepts signals from a video interface, may be used. The video interface composites information generated by a computer systemization and generates video signals based on the composited information in a video memory frame. Typically, the video interface provides the composited video information through a video connection interface that accepts a video display interface (e.g., an RCA composite video connector accepting an RCA composite video cable; a DVI connector accepting a DVI display cable, etc.).

User input devices 3411 may be card readers, dongles, finger print readers, gloves, graphics tablets, joysticks, keyboards, mouse (mice), remote controls, retina readers, trackballs, trackpads, and/or the like.

Peripheral devices 3412 may be connected and/or communicate to I/O and/or other facilities of the like such as network interfaces, storage interfaces, and/or the like. Peripheral devices may be audio devices, cameras, dongles (e.g., for copy protection, ensuring secure transactions with a digital signature, and/or the like), external processors (for added functionality), goggles, microphones, monitors, network interfaces, printers, scanners, storage devices, video devices, video sources, visors, and/or the like.

It should be noted that although user input devices and peripheral devices may be employed, the code triggered information server controller may be embodied as an embedded, dedicated, and/or monitor-less (i.e., headless) device, wherein access would be provided over a network interface connection.

Cryptographic units such as, but not limited to, microcontrollers, processors 3426, interfaces 3427, and/or devices 3428 may be attached, and/or communicate with the code triggered information server controller. A MC68HC16 microcontroller, commonly manufactured by Motorola Inc., may be used for and/or within cryptographic units. Equivalent microcontrollers and/or processors may also be used. The MC68HC16 microcontroller utilizes a 16-bit multiply-and-accumulate instruction in the 16 MHz configuration and requires less than one second to perform a 512-bit RSA private key operation. Cryptographic units support the authentication of communications from interacting agents, as well as allowing for anonymous transactions. Cryptographic units may also be configured as part of CPU. Other commercially available specialized cryptographic processors include VLSI Technology's 33 MHz 6868 or Semaphore Communications' 40 MHz Roadrunner 184.

### Memory

Generally, any mechanization and/or embodiment allowing a processor to affect the storage and/or retrieval of information is regarded as memory 3429, as shown in FIG. 31. However, memory is a fungible technology and resource, thus, any number of memory embodiments may be employed in lieu of or in concert with one another. It is to be understood that the code triggered information server controller and/or a computer systemization may employ various forms of memory 3429. For example, a computer systemization may be configured wherein the functionality of on-chip CPU memory (e.g., registers), RAM, ROM, and any other storage devices are provided by a paper punch tape or paper punch card mechanism; of course such an embodiment would result in an extremely slow rate of operation. In a typical configuration, memory 3429 will include ROM 3406, RAM 3405, and a storage device 3414. A storage device 3414 may be any conventional computer system storage. Storage devices may include a drum; a (fixed and/or removable) magnetic disk drive; a magneto-optical drive; an optical drive (i.e., CD ROM/RAM/Recordable (R), ReWritable (RW), DVD R/RW, etc.); an array of devices (e.g., Redundant Array of Independent Disks (RAID)); and/or other devices of the like. Thus, a computer systemization generally requires and makes use of memory.

### Component Collection

The memory 3429 may contain a collection of program and/or database components and/or data such as, but not limited to: operating system component(s) 3415 (operating system); information server component(s) 3416 (information server); user interface component(s) 3417 (user interface); Web browser component(s) 3418 (Web browser); database(s) 3419; mail server component(s) 3421; mail client component(s) 3422; cryptographic server component(s) 3420 (cryptographic server); the code triggered information server component(s) 3435; and/or the like (i.e., collectively a component collection), as shown in FIG. 31. These components may be stored and accessed from the storage devices and/or from storage devices accessible through an interface bus. Although non-conventional program components such as those in the component collection, typically, are stored in a local storage device 3414, they may also be loaded and/or stored in memory such as: peripheral devices, RAM, remote storage facilities through a communications network, ROM, various forms of memory, and/or the like.

### Operating System

The operating system component 3415 is an executable program component facilitating the operation of the code triggered information server controller, as shown in FIG. 31. Typically, the operating system facilitates access of I/O, network interfaces, peripheral devices, storage devices, and/or the like. The operating system may be a highly fault tolerant, scalable, and secure system such as Apple Macintosh OS X (Server), AT&T Plan 9, Be OS, Linux, Unix, and/or the like operating systems. However, more limited and/or less secure operating systems also may be employed such as Apple Macintosh OS, Microsoft DOS, Microsoft Windows 2000/2003/3.1/95/98/CE/Millenium/NT/Vista/XP (Server), Palm OS, and/or the like. An operating system may communicate to and/or with other components in a component collection, including itself, and/or the like. Most frequently, the operating system communicates with other program components, user interfaces, and/or the like. For example, the operating system may contain, communicate, generate, obtain, and/or provide program component, system, user, and/or data communications, requests, and/or responses. The operating system, once executed by the CPU, may enable the interaction with communications networks, data, I/O, peripheral devices, program components, memory, user input devices, and/or the like. The operating system may provide communications protocols that allow the code triggered information server controller to communicate with other entities through a communications network 2413. Various communication protocols may be used by the code triggered information server system controller as a subcarrier transport mechanism for interaction, such as, but not limited to: multicast, TCP/IP, UDP, unicast, and/or the like.

The operating system component 3415 may also be a mobile operating system, mobile OS, such as iOS (Apple), ANDROID, WINDOWS PHONE (Microsoft), WINDOWS PHONE 7 (Microsoft), BLACKBERRY OS (RIM), WebOS (Hewlett-Packard), MEEGO or SYMBIAN, for example. The mobile OS may be a manufacture-built proprietary operating system, a third party proprietary, or an open source operating system. Mobile OS's are employed on a wide variety of mobile devices useful with the present invention, such as smartphones and tablet computers.

### Information Server

An information server component 3416 is a stored program component that is executed by a CPU, as shown in FIG. 31. The information server may be a conventional Internet information server such as, but not limited to Apache Software Foundation's Apache, Microsoft's Internet Information Server, and/or the. The information server may allow for the execution of program components through facilities such as Active Server Page (ASP), ActiveX, (ANSI) (Objective-) C (++), C#, Common Gateway Interface (CGI) scripts, Java, JavaScript, Practical Extraction Report Language (PERL), Python, WebObjects, and/or the like. The information server may support secure communications protocols such as, but not limited to, File Transfer Protocol (FTP); HyperText Transfer Protocol (HTTP); Secure Hypertext Transfer Protocol (HTTPS), Secure Socket Layer (SSL), and/or the like. The information server provides results in the form of Web pages to Web browsers, and allows for the manipulated generation of the Web pages through interaction with other program components. After a Domain Name System (DNS) resolution portion of an HTTP request is resolved to a particular information server, the information server resolves requests for information at specified locations on the code triggered information server controller based on the remainder of the HTTP request. For example, a request such as http://123.124.125.126/myInformation.html might have the IP portion of the request “123.124.125.126” resolved by a DNS server to an information server at that IP address; that information server might in turn further parse the http request for the “/myInformation.html” portion of the request and resolve it to a location in memory containing the information “myInformation.html.” Additionally, other information serving protocols may be employed across various ports, e.g., FTP communications across port 21, and/or the like. An information server may communicate to and/or with other components in a component collection, including itself, and/or facilities of the like. Most frequently, the information server communicates with the code triggered information server database 3419, operating systems, other program components, user interfaces, Web browsers, and/or the like.

Access to the code triggered information server database may be achieved through a number of database bridge mechanisms such as through scripting languages as enumerated below (e.g., CGI) and through inter-application communication channels as enumerated below (e.g., CORBA, WebObjects, etc.). Any data requests through a Web browser are parsed through the bridge mechanism into appropriate grammars as required by the code triggered information server. In one embodiment, the information server would provide a Web form accessible by a Web browser. Entries made into supplied fields in the Web form are tagged as having been entered into the particular fields, and parsed as such. The entered terms are then passed along with the field tags, which act to instruct the parser to generate queries directed to appropriate tables and/or fields. In one embodiment, the parser may generate queries in standard SQL by instantiating a search string with the proper join/select commands based on the tagged text entries, wherein the resulting command is provided over the bridge mechanism to the code triggered information server as a query. Upon generating query results from the query, the results are passed over the bridge mechanism, and may be parsed for formatting and generation of a new results Web page by the bridge mechanism. Such a new results Web page is then provided to the information server, which may supply it to the requesting Web browser.

Also, an information server may contain, communicate, generate, obtain, and/or provide program component, system, user, and/or data communications, requests, and/or responses.

### User Interface

The function of computer interfaces in some respects is similar to automobile operation interfaces. Automobile operation interface elements such as steering wheels, gearshifts, and speedometers facilitate the access, operation, and display of automobile resources, functionality, and status. Computer interaction interface elements such as check boxes, cursors, menus, scrollers, and windows (collectively and commonly referred to as widgets) similarly facilitate the access, operation, and display of data and computer hardware and operating system resources, functionality, and status. Operation interfaces are commonly called user interfaces. Graphical user interfaces (GUIs) such as the Apple Macintosh Operating System's Aqua or Lion, Microsoft's Windows XP, Windows 7 or Unix's X-Windows provide a baseline and means of accessing and displaying information graphically to users. Mobile OS's, discussed above, also typically employ GUIs, but may also be text-based, and provide user interfaces to mobile devices.

A user interface component 3417, whether on a desktop or laptop computing device or a mobile device, is a stored program component that is executed by a CPU, as shown in FIG. 31. The user interface may be a conventional graphic user interface as provided by, with, and/or atop operating systems and/or operating environments such as those operating systems discussed above, and/or the like. The user interface may allow for the display, execution, interaction, manipulation, and/or operation of program components and/or system facilities through textual and/or graphical facilities. The user interface provides a facility through which users may affect, interact, and/or operate a computer system. A user interface may communicate to and/or with other components in a component collection, including itself, and/or facilities of the like. Most frequently, the user interface communicates with operating systems, other program components, and/or the like. The user interface may contain, communicate, generate, obtain, and/or provide program component, system, user, and/or data communications, requests, and/or responses.

### Web Browser

A Web browser component 3418 is a stored program component that is executed by a CPU, as shown in FIG. 31. The Web browser may be a conventional hypertext viewing application such as Microsoft Internet Explorer or Netscape Navigator. Secure Web browsing may be supplied with 128 bit (or greater) encryption by way of HTTPS, SSL, and/or the like. Some Web browsers allow for the execution of program components through facilities such as Java, JavaScript, ActiveX, and/or the like. Web browsers and like information access tools may be integrated into PDAs, cellular telephones, and/or other mobile devices. A Web browser may communicate to and/or with other components in a component collection, including itself, and/or facilities of the like. Most frequently, the Web browser communicates with information servers, operating systems, integrated program components (e.g., plug-ins), and/or the like; e.g., it may contain, communicate, generate, obtain, and/or provide program component, system, user, and/or data communications, requests, and/or responses. Of course, in place of a Web browser and information server, a combined application may be developed to perform similar functions of both. The combined application would similarly affect the obtaining and the provision of information to users, user agents, and/or the like from the code triggered information server enabled nodes. The combined application may be nugatory on systems employing standard Web browsers.

### Mail Server

A mail server component 3421 is a stored program component that is executed by a CPU 3403, as shown in FIG. 31. The mail server may be a conventional Internet mail server such as, but not limited to sendmail, Microsoft Exchange, and/or the like. The mail server may allow for the execution of program components through facilities such as ASP, ActiveX, (ANSI) (Objective-) C (++), CGI scripts, Java, JavaScript, PERL, pipes, Python, WebObjects, and/or the like. The mail server may support communications protocols such as, but not limited to: Internet message access protocol (IMAP), Microsoft Exchange, post office protocol (POP3), simple mail transfer protocol (SMTP), and/or the like. The mail server can route, forward, and process incoming and outgoing mail messages that have been sent, relayed and/or otherwise traversing through and/or to the code triggered information server.

Access to the code triggered information server mail may be achieved through a number of APIs offered by the individual Web server components and/or the operating system.

Also, a mail server may contain, communicate, generate, obtain, and/or provide program component, system, user, and/or data communications, requests, information, and/or responses.

### Mail Client

A mail client component 3422 is a stored program component that is executed by a CPU 4403, as shown in FIG. 31. The mail client may be a conventional mail viewing application such as Apple Mail, Microsoft Entourage, Microsoft Outlook, Microsoft Outlook Express, Mozilla Thunderbird, and/or the like. Mail clients may support a number of transfer protocols, such as: IMAP, Microsoft Exchange, POP3, SMTP, and/or the like. A mail client may communicate to and/or with other components in a component collection, including itself, and/or facilities of the like. Most frequently, the mail client communicates with mail servers, operating systems, other mail clients, and/or the like; e.g., it may contain, communicate, generate, obtain, and/or provide program component, system, user, and/or data communications, requests, information, and/or responses. Generally, the mail client provides a facility to compose and transmit electronic mail messages.

### Cryptographic Server

A cryptographic server component 3420 is a stored program component that is executed by a CPU 3403, cryptographic processor 3426, cryptographic processor interface 3427, cryptographic processor device 3428, and/or the like, as shown in FIG. 31. Cryptographic processor interfaces will allow for expedition of encryption and/or decryption requests by the cryptographic component; however, the cryptographic component, alternatively, may run on a conventional CPU. The cryptographic component allows for the encryption and/or decryption of provided data. The cryptographic component allows for both symmetric and asymmetric (e.g., Pretty Good Protection (PGP)) encryption and/or decryption. The cryptographic component may employ cryptographic techniques such as, but not limited to: digital certificates (e.g., X.509 authentication framework), digital signatures, dual signatures, enveloping, password access protection, public key management, and/or the like. The cryptographic component will facilitate numerous (encryption and/or decryption) security protocols such as, but not limited to: checksum, Data Encryption Standard (DES), Elliptical Curve Encryption (ECC), International Data Encryption Algorithm (IDEA), Message Digest 5 (MD5, which is a one way hash function), passwords, Rivest Cipher (RC5), Rijndael, RSA (which is an Internet encryption and authentication system that uses an algorithm developed in 1977 by Ron Rivest, Adi Shamir, and Leonard Adleman), Secure Hash Algorithm (SHA), Secure Socket Layer (SSL), Secure Hypertext Transfer Protocol (HTTPS), and/or the like. Employing such encryption security protocols, the code triggered information server may encrypt all incoming and/or outgoing communications and may serve as node within a virtual private network (VPN) with a wider communications network. The cryptographic component facilitates the process of “security authorization” whereby access to a resource is inhibited by a security protocol wherein the cryptographic component effects authorized access to the secured resource. In addition, the cryptographic component may provide unique identifiers of content, e.g., employing an MD5 hash to obtain a unique signature for a digital audio file. A cryptographic component may communicate to and/or with other components in a component collection, including itself, and/or facilities of the like. The cryptographic component supports encryption schemes allowing for the secure transmission of information across a communications network to enable the code triggered information server component to engage in secure transactions if so desired. The cryptographic component facilitates the secure accessing of resources on the code triggered information server and facilitates the access of secured resources on remote systems; i.e., it may act as a client and/or server of secured resources. Most frequently, the cryptographic component communicates with information servers, operating systems, other program components, and/or the like. The cryptographic component may contain, communicate, generate, obtain, and/or provide program component, system, user, and/or data communications, requests, and/or responses.

### The Code Triggered Information Server Database

The code triggered information server database component 3419 may be embodied in a database and its stored data, as shown in FIG. 31. The database is a stored program component, which is executed by the CPU; the stored program component portion configuring the CPU to process the stored data. The database may be a conventional, fault tolerant, relational, scalable, secure database such as Oracle or Sybase. Relational databases are an extension of a flat file. Relational databases consist of a series of related tables. The tables are interconnected via a key field. Use of the key field allows the combination of the tables by indexing against the key field; i.e., the key fields act as dimensional pivot points for combining information from various tables. Relationships generally identify links maintained between tables by matching primary keys. Primary keys represent fields that uniquely identify the rows of a table in a relational database. More precisely, they uniquely identify rows of a table on the “one” side of a one-to-many relationship.

Alternatively, the code triggered information server database may be implemented using various standard data-structures, such as an array, hash, (linked) list, struct, structured text file (e.g., XML), table, and/or the like. Such data-structures may be stored in memory and/or in (structured) files. In another alternative, an object-oriented database may be used, such as Frontier, ObjectStore, Poet, Zope, and/or the like. Object databases can include a number of object collections that are grouped and/or linked together by common attributes; they may be related to other object collections by some common attributes. Object-oriented databases perform similarly to relational databases with the exception that objects are not just pieces of data but may have other types of functionality encapsulated within a given object. If the code triggered information server database is implemented as a data-structure, the use of the code triggered information server database 3419 may be integrated into another component such as the code triggered information server component 3435. Also, the database may be implemented as a mix of data structures, objects, and relational structures. Databases may be consolidated and/or distributed in countless variations through standard data processing techniques. Portions of databases, e.g., tables, may be exported and/or imported and thus decentralized and/or integrated.

In one embodiment, the database component 3419 includes several tables 4419a,b. A user profile table 3419a includes fields such as, but not limited to: a user ID, name, email address, address, demographic profile, hardware ID, scan history record, scan statistics, and/or the like. The user profile table may support and/or track multiple entity accounts on a code triggered information server. An Information Base table 3419b includes fields such as, but not limited to: 3^{rd} party provider ID, 3^{rd} party ID, 3^{rd} party preference content, preference labels, geographic tags, temporal tags, subject tags, preference ratings, preference statistics, and/or the like.

In one embodiment, the code triggered information server database may interact with other database systems. For example, employing a distributed database system, queries and data access by OLBS modules may treat the combination of the code triggered information server database, an integrated data security layer database as a single database entity.

In one embodiment, user programs may contain various user interface primitives, which may serve to update the code triggered information server. Also, various accounts may require custom database tables depending upon the environments and the types of clients the code triggered information server may need to serve. It should be noted that any unique fields may be designated as a key field throughout. In an alternative embodiment, these tables have been decentralized into their own databases and their respective database controllers (i.e., individual database controllers for each of the above tables). Employing standard data processing techniques, one may further distribute the databases over several computer systemizations and/or storage devices. Similarly, configurations of the decentralized database controllers may be varied by consolidating and/or distributing the various database components 3419a,b. The code triggered information server may be configured to keep track of various settings, inputs, and parameters via database controllers.

The code triggered information server database may communicate to and/or with other components in a component collection, including itself, and/or facilities of the like. Most frequently, the code triggered information server database communicates with the code triggered information server component, other program components, and/or the like. The database may contain, retain, and provide information regarding other nodes and data.

### The Code Triggered Information Server

The code triggered information server component 3435 is a stored program component that is executed by a CPU, as shown in FIG. 31. The code triggered information server affects accessing, obtaining and the provision of information, preferences, services, transactions, and/or the like across various communications networks.

The code triggered information server component enables the identification, generation, and aggregation of Scan Messages and Reply Messages.

The code triggered information server component enabling access of information between nodes may be developed by employing standard development tools such as, but not limited to: (ANSI) (Objective-) C (++), Apache components, binary executables, database adapters, Java, JavaScript, mapping tools, procedural and object oriented development tools, PERL, Python, shell scripts, SQL commands, web application server extensions, WebObjects, and/or the like. In one embodiment, the code triggered information server employs a cryptographic server to encrypt and decrypt communications. The code triggered information server component may communicate to and/or with other components in a component collection, including itself, and/or facilities of the like. Most frequently, the code triggered information server component communicates with the code triggered information server database, operating systems, other program components, and/or the like. The code triggered information server may contain, communicate, generate, obtain, and/or provide program component, system, user, and/or data communications, requests, preferences, and/or responses.

### Distributed Code Triggered Information Server

The structure and/or operation of any of the code triggered information server node controller components may be combined, consolidated, and/or distributed in any number of ways to facilitate development and/or deployment. Similarly, the component collection may be combined in any number of ways to facilitate deployment and/or development. To accomplish this, one may integrate the components into a common code base or in a facility that can dynamically load the components on demand in an integrated fashion.

The component collection may be consolidated and/or distributed in countless variations through standard data processing and/or development techniques. Multiple instances of any one of the program components in the program component collection may be instantiated on a single node, and/or across numerous nodes to improve performance through load-balancing and/or data-processing techniques. Furthermore, single instances may also be distributed across multiple controllers and/or storage devices; e.g., databases. All program component instances and controllers working in concert may do so through standard data processing communication techniques.

The configuration of the code triggered information server controller will depend on the context of system deployment. Factors such as, but not limited to, the budget, capacity, location, and/or use of the underlying hardware resources may affect deployment requirements and configuration. Regardless of if the configuration results in more consolidated and/or integrated program components, results in a more distributed series of program components, and/or results in some combination between a consolidated and distributed configuration, data may be communicated, obtained, and/or provided. Instances of components consolidated into a common code base from the program component collection may communicate, obtain, and/or provide data. This may be accomplished through intra-application data processing communication techniques such as, but not limited to: data referencing (e.g., pointers), internal messaging, object instance variable communication, shared memory space, variable passing, and/or the like.

If component collection components are discrete, separate, and/or external to one another, then communicating, obtaining, and/or providing data with and/or to other component components may be accomplished through inter-application data processing communication techniques such as, but not limited to: Application Program Interfaces (API) information passage; (distributed) Component Object Model ((D)COM), (Distributed) Object Linking and Embedding ((D)OLE), and/or the like), Common Object Request Broker Architecture (CORBA), process pipes, shared files, and/or the like. Messages sent between discrete component components for inter-application communication or within memory spaces of a singular component for intra-application communication may be facilitated through the creation and parsing of a grammar. A grammar may be developed by using standard development tools such as lex, yacc, XML, and/or the like, which allow for grammar generation and parsing functionality, which in turn may form the basis of communication messages within and between components. Again, the configuration will depend upon the context of system deployment.

### Code Triggered Information Server Controller

FIG. 31 of the present disclosure illustrates inventive aspects of a code triggered information server controller 3401 in a block diagram. In this embodiment, the code triggered information server controller 3401 may serve to aggregate, process, store, search, serve, identify, instruct, generate, match, and/or update Scan Messages, Reply Messages, Directions, user profiles, and/or other related data.

### Scan and Reply Messages

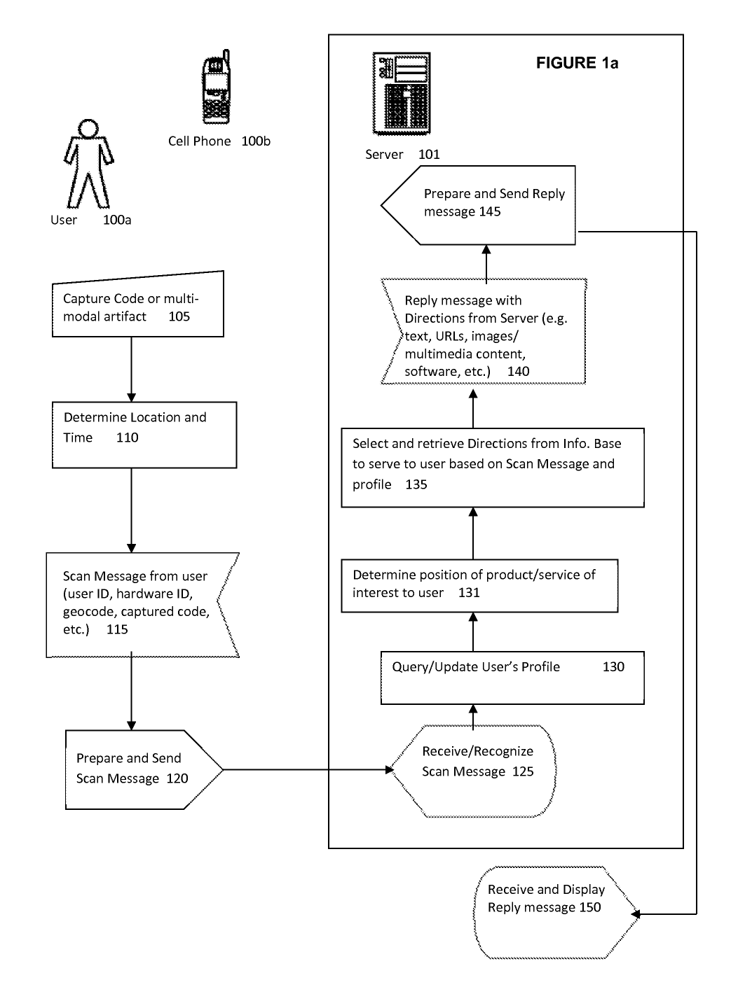

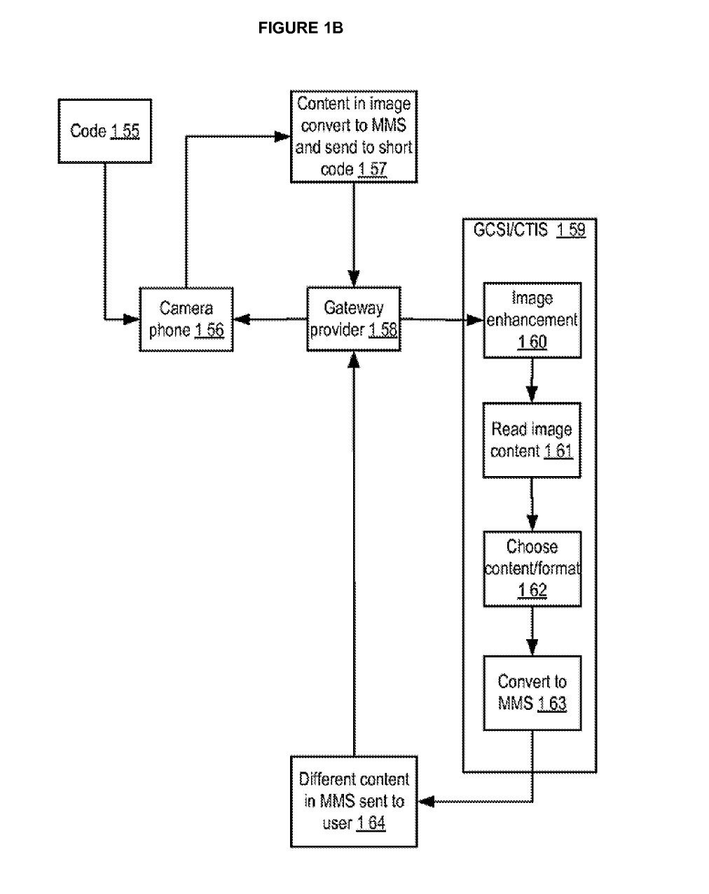

In one embodiment, a code triggered information server (CTIS) employs two basic actors: (i) a user (100a) capable of registering interest in an activity, transmitting and receiving data, and displaying information; and (ii) a server (101) capable of communicating with the user, storing/updating user profiles, and selecting information to serve to the user, as shown in FIG. 1a. In addition to the two basic actors, the CTIS enables the creation of two types of transactional articles: i) Scan Messages (115) and ii) Reply Messages (145). The CTIS provides context-specific Reply Messages in response to Scan Messages, which are prepared in response to the registration of activity interest by the user, in order to supply directions, information, and/or advertising to the user. The CTIS generates Reply Messages by processing Scan Message content with user profile information, containing basic profiling data as well as a history of Scan Messages supplied by a given user. As such, Reply Messages are transactional articles that heighten a provider's opportunity to supply relevant and targeted information and/or advertising to the user that is both context and user specific. Without loss of generality, we will heretofore refer to the directions content, information, and/or advertising content of Reply Messages as “Directions.” The CTIS may also elect to send context and user-specific Reply Messages based solely on the user profile, without the user having recently registered activity interest, if it is determined from the user's profile, particularly the history of Scan Messages, that particular Directions are appropriate.

### “Registering” Interest (Scanning)

In one embodiment, users of the CTIS scan codes to register interest and the CTIS acts as a portal for consumers to access information supplemental to the context in which the codes are found. Users may scan codes found in media publications, on billboards or signs, on consumer products or packages, on websites or television screens, and/or the like. In doing so, the users may identify themselves via an identification code specific to the mobile device and service account with which the scan is made. At the same time, the scanned code can be recorded, as well as the time of day and user location; such information may form the basis of consumer profiles that may be saved by the CTIS. As these scans are indicative of interest in various subjects, goods, and/or services, they may serve as a basis for an individual customer tracking system. As such, advertisers can finely tune and efficiently tailor their efforts towards achieving maximum return on the advertising expenditure.

In another embodiment, the user is able to engage with the CTIS in an anonymous fashion where the individual consumer identity is not discoverable to the CTIS.

### Code Triggered Information Server Basic Overview

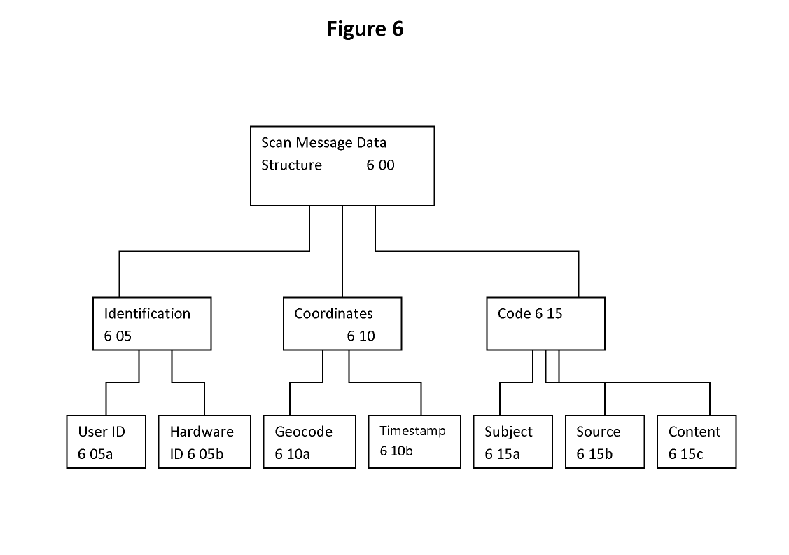

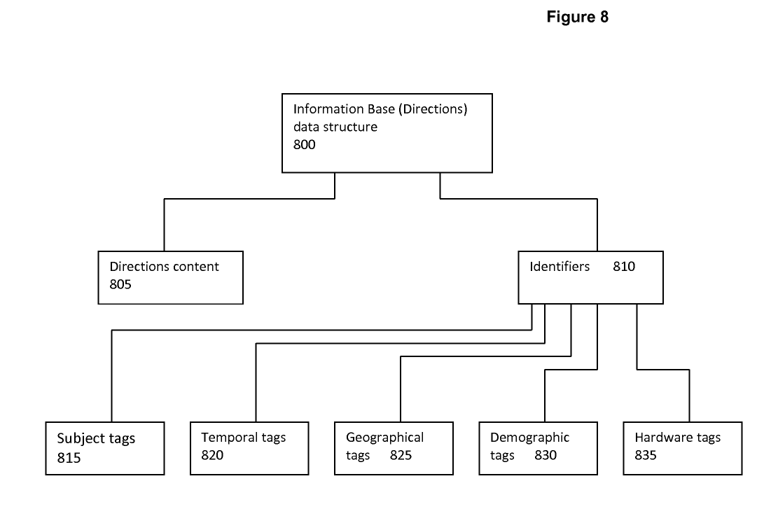

FIG. 1a shows a combined logic and data flow block diagram illustrating a general overview of the CTIS in one embodiment. The CTIS may be configured so that a user (100a) may scan a digital code (105) with a scanning device (100b), as for example by using a cell phone camera to scan and/or take a picture of a barcode, 2d code, matrix code, data matrix, QR code, or other such symbology. An example of a mobile device and software capable of such code capture is the Nokia 6600 cellular telephone equipped with ConnexTo software. Alternatively, the CTIS may be triggered by the user selecting an internet link (such as on an internet enabled mobile device), by making decisions within a virtual world (such as a massively multiplayer online game), and/or the like. Without loss of generality, all such forms of interest-registering CTIS triggering will be referred to as “code scanning” The time and location (as determined by GPS, GPRS, or other such geo-positioning technologies) of the mobile device are determined (110), and a Scan Message (115) is generated containing a user identification (ID), a hardware ID that identifies the type of mobile device being used, a geocode (location of the device), a timestamp, and the scanned code (see FIG. 6 and discussion of Scan Message below). Additional user-input information may also be supplied at this point. The Scan Message is packaged and sent (120) to a server (101) that receives and recognizes it (125). The user's profile, specific to the supplied user ID, is updated with the new Scan Message (i.e., it is added as a transaction to their profile transaction history) and queried (130) for information to use in the preparation of a Reply Message (140) that is also based on the content of the current Scan Message. The server determines the position of the product/service of interest to the user (131), and uses this information in the selection of appropriate Directions content. The server selects (135) the Directions content (see FIG. 8) of the Reply Message (145) from an Information Base and sends it to the user's mobile display device, which displays the pertinent content to the user (150).

### MMS

In one implementation, the Scan Message and/or scanned code may be sent to the server (101) by a Multimedia Messaging Service (MMS) protocol. In other implementations, a wide variety of other communication protocols may be employed, including but not limited to: Short Messaging Service (SMS), instant messaging, web browser based messaging, email, Enhanced Messaging System (EMS), TCP/IP, WAP, and/or the like.

### Short Code

In one implementation, the server (101) may be addressed by a short code, short numbers, Common Short Code (CSC), and/or the like for sending the Scan Message and/or scanned code. For example, a short code may appear alongside a code in a print publication, and a user may be informed that the scanned code should be sent to the indicated short code number in order to retrieve a Reply Message, directions, advertisement, coupon, and/or the like. In other implementations, other addressing means may be employed, such as an ordinary telephone number, an email address, a universal resource locater (URL), and/or the like. In another implementation, the short code and/or other server address may be encoded within part of the code itself. When the user scans the code with his or her mobile device, the code may be partially decoded by the client device to extract the address and automatically send the rest of the code thereto.

### Scanning

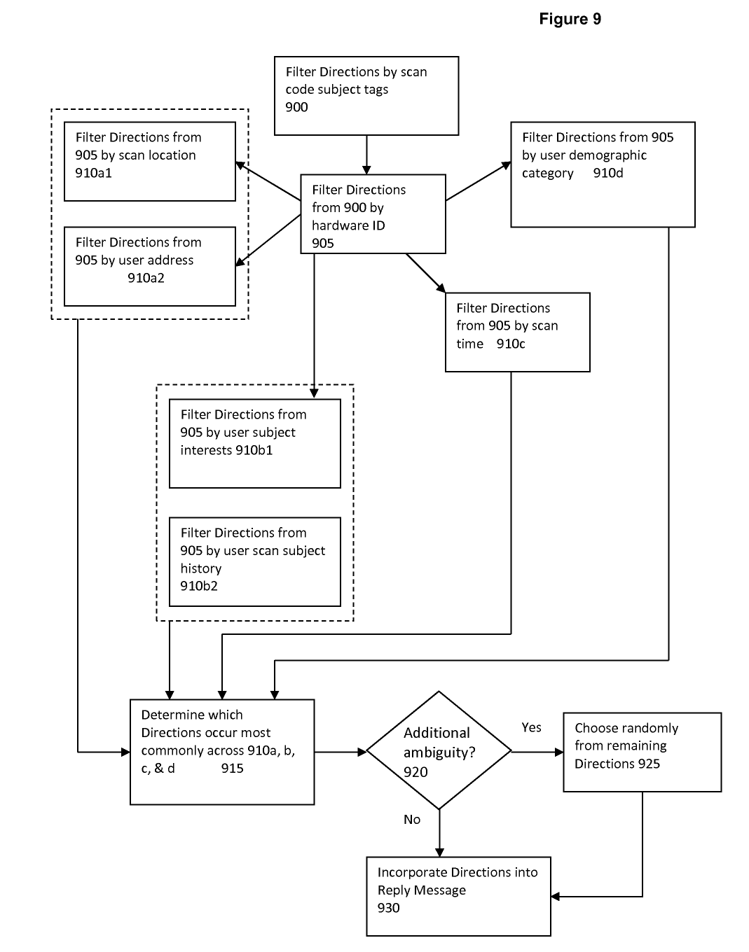

FIG. 1b shows an implementation of combined logic and data flow in another embodiment of CTIS operation. A code (155) is scanned by a camera phone (156), and the resulting image content is converted to an MMS format to be sent via short code (157) through a gateway provider (158) to the CTIS (159) server. At the server, the image information may be enhanced, manipulated, and/or otherwise processed (160) so as to aid in determining the appropriate content to serve in response. After enhancement, the image content is read (161) and the content and format for the appropriate response is determined (162) (see, e.g., FIGS. 9-11). A response message is formed in MMS format (163) and is sent (164) back to a gateway provider (158) to be served to the user's camera phone (156).

In an alternative implementation, the scanned code may be directly decoded on the client mobile device instead of on the server. The decoded content may then be converted to MMS format and sent via short code to the server in order to retrieve the appropriate content associated with the code. That content may be returned from the server to the client mobile device by means of an MMS protocol as well.

### CTIS Server

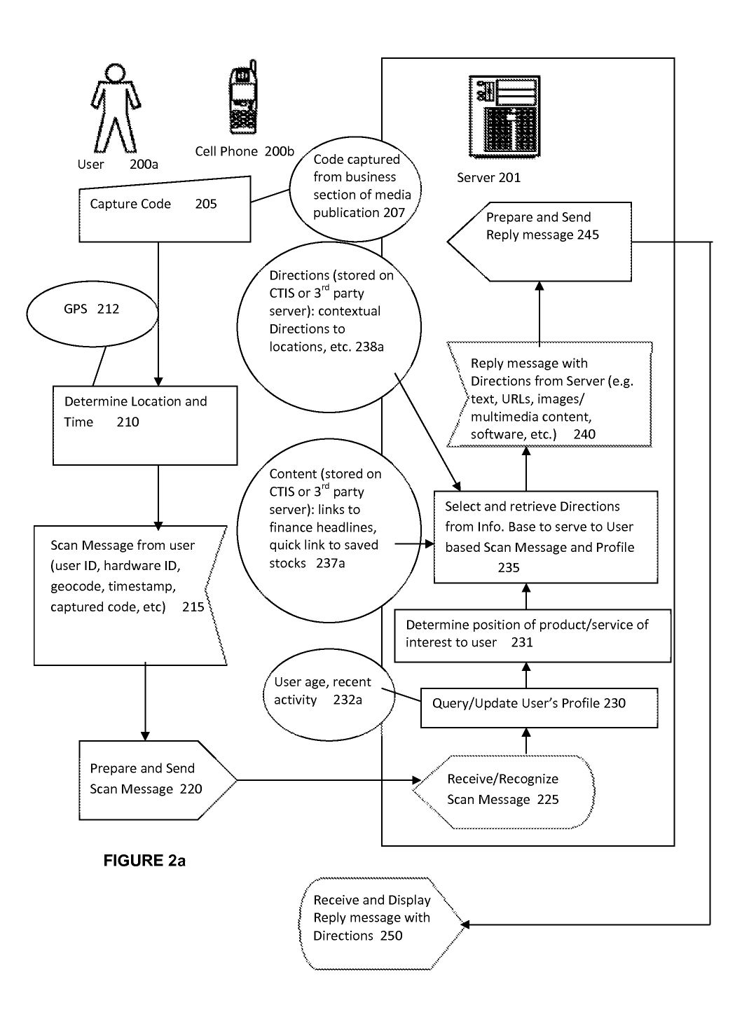

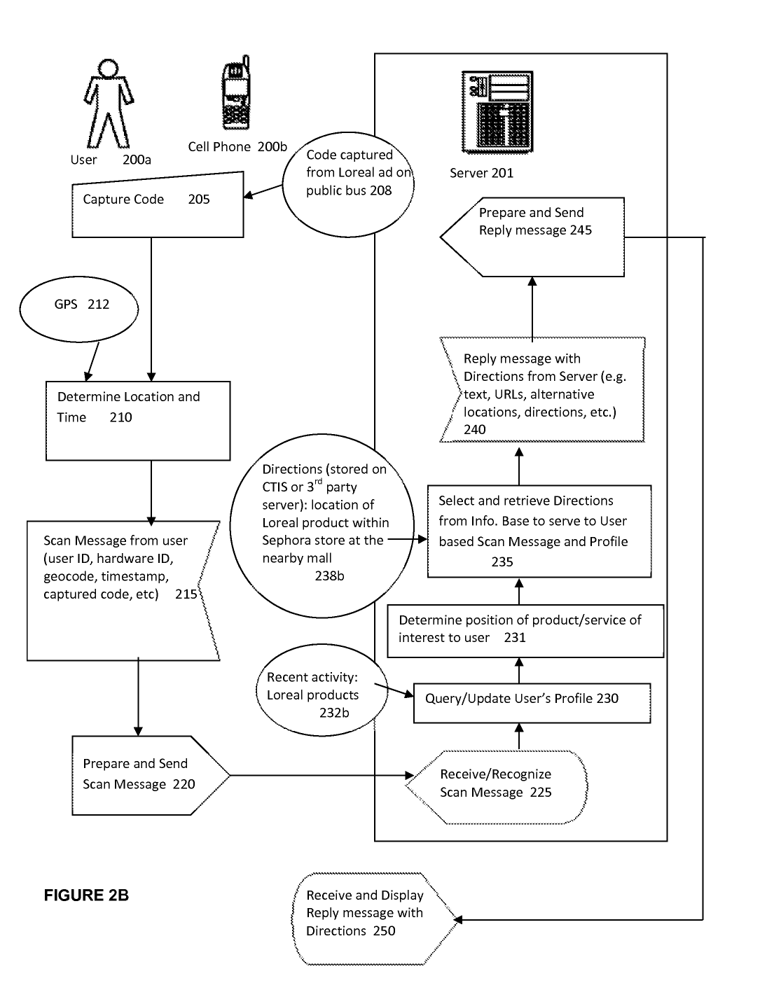

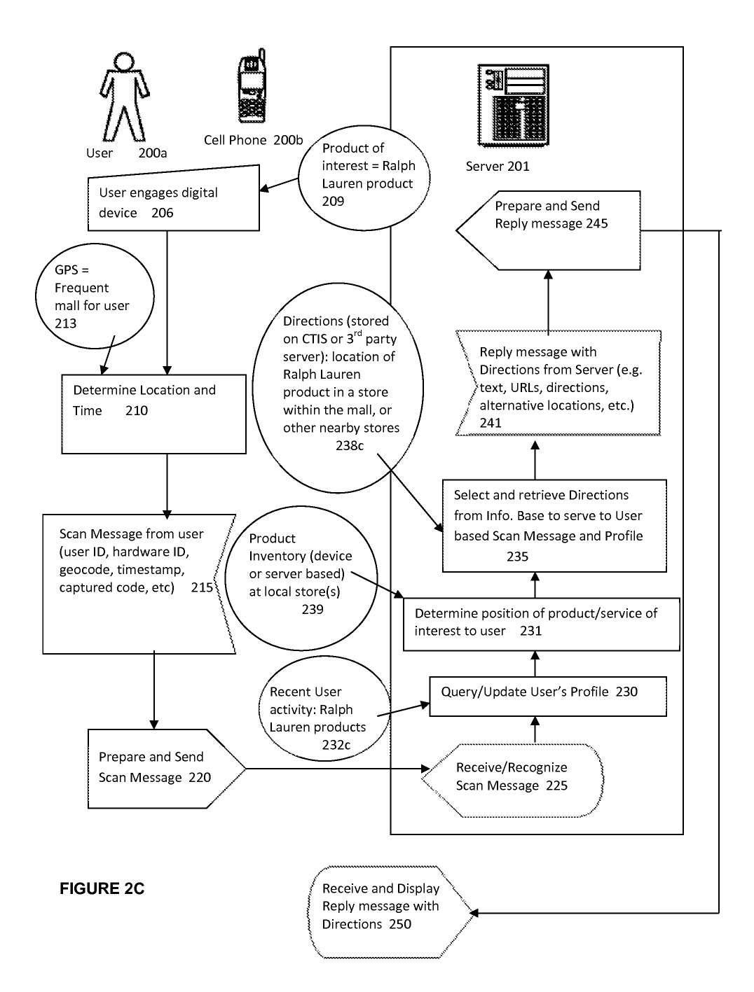

For illustration, the CTIS is shown in FIG. 2a for a particular, exemplary embodiment: providing targeted and contextual directions, information, and advertising to the user related to a news article. Here, a user employs a cell phone to scan a code associated with an article in the Business section of a media publication (207), such as by using the phone's built in camera to photograph a 2D matrix code (e.g., QR code). The location of the scan (San Francisco, Calif.) is determined by the phone's built in GPS receiver (212), and this location is incorporated as a geocode, along with the user ID, the hardware ID of the particular type of device (e.g., cell phone) used, the time, and the code content, into a Scan Message. This is sent to a server via the cell phone's data connection (e.g., wireless internet systems such as 1xEV-DO), and the server queries a database of user profiles based on the supplied user ID in order to update the appropriate user profile with the content of the current Scan Message and to determine what, if any, information in the user profile may be relevant to the preparation of the current Reply Message. Here, the server recognizes that the user is 55 years of age and has recently been scanning articles and/or ads related to investments and retirement planning (232a). In one embodiment, the user can supply a list of interests to be considered in addition to those culled from their scan history. The server also determines the position of the product/service of interest to the user, such as here the location of a branch office of the brokerage firm (231). The server selects the appropriate Directions content to include in the Reply Message, comprised in this case of links to Finance headlines, quick links to saved stock quotes (237a), and a contextual brokerage advertisement (238a), including directions to a branch location of the brokerage in San Francisco (212) near the user. This reply is sent by the server to the user's mobile device which displays the appropriate message content.

FIG. 2b shows another particular, exemplary embodiment providing targeted and contextual directions to the user related to a scanned advertisement for a product. Here, a user is walking by a Starbucks store and notices an ad for Loreal makeup on a passing public bus. The user employs a cell phone to scan a code/artifact associated with the Loreal ad on the passing bus (208), such as by using the phone's built in camera to photograph a 2D matrix code (e.g., QR code). The location of the scan (i.e., the user's current position) is determined by the phone's built in GPS receiver (212), and this location is incorporated as a geocode, along with the user ID, the hardware ID of the particular type of device (e.g., cell phone) used, the time, and the code content, into a Scan Message. This is sent to a server via the cell phone's data connection (e.g., wireless internet systems such as 1xEV-DO), and the server queries a database of user profiles based on the supplied user ID in order to update the appropriate user profile with the content of the current Scan Message and to determine what, if any, information in the user profile may be relevant to the preparation of the current Reply Message. Here, the server recognizes that the user has recently been scanning articles and/or ads related to Loreal makeup products (232b). In one embodiment, the user can supply a list of interests to be considered in addition to those culled from their scan history. The server also determines the position of the product/service of interest to the user, such as here the location of a Loreal makeup product on the shelf of a Sephora store within a nearby mall (231). The server selects the appropriate Directions content to include in the Reply Message, comprised in this case of directions from the user's current location to the position within the Sephora store where the Loreal makeup product is located (238b). This reply is sent by the server to the user's mobile device which displays the appropriate directions content, guiding the user first to the Sephora store within a nearby mall, and further to the location within the Sephora store where the particular Loreal makeup product is located.

In an alternative embodiment, the digital device and/or server could query the user as to a preference towards one of a plurality of nearby locations carrying the Loreal product associated by the server to the Scan Message.

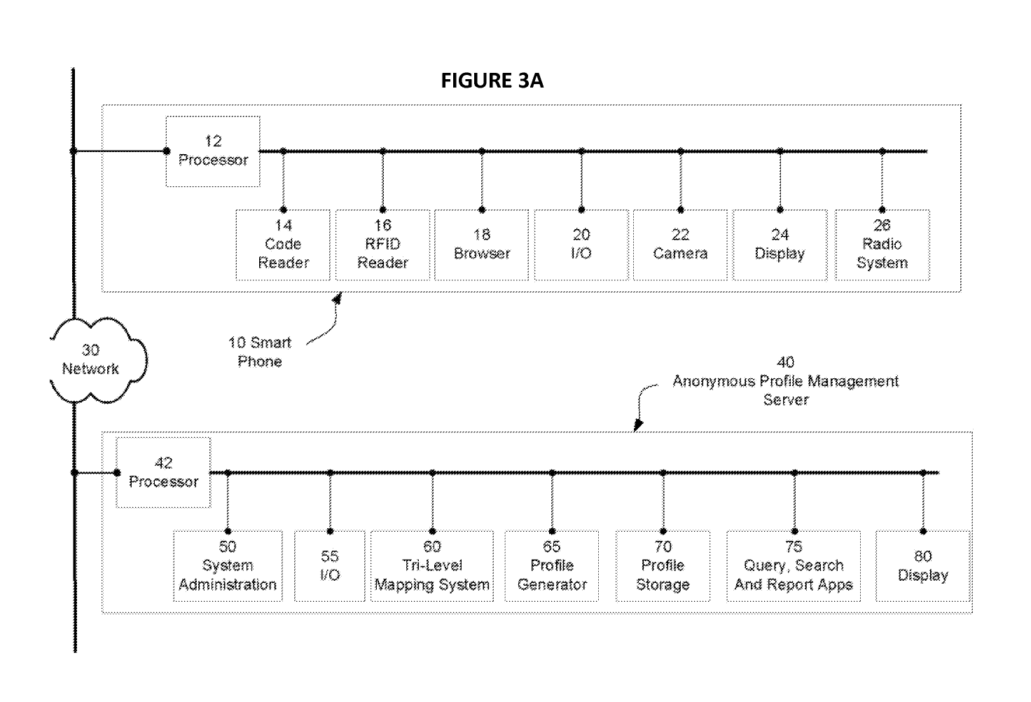

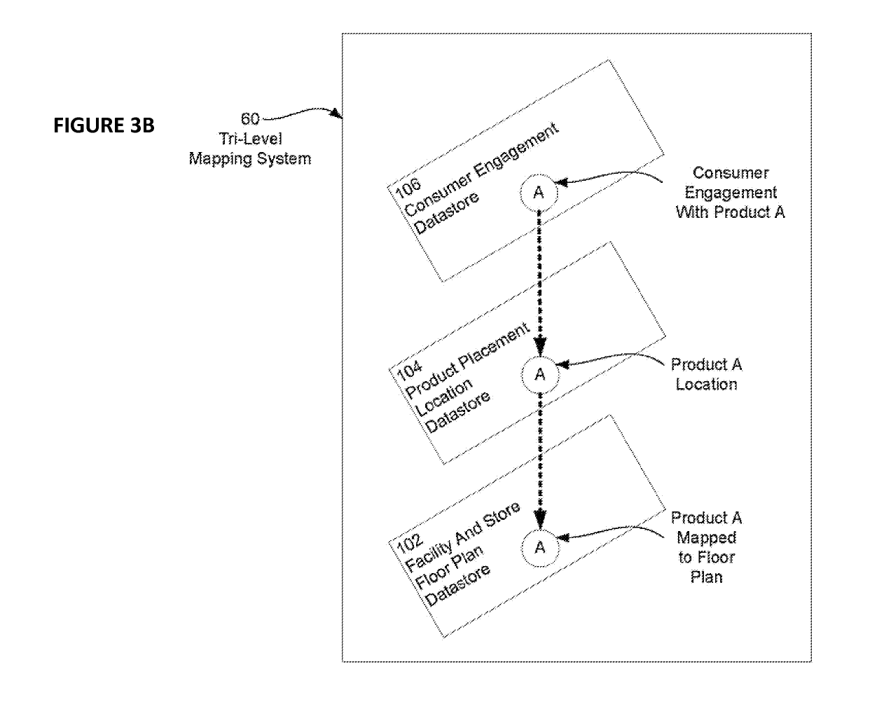

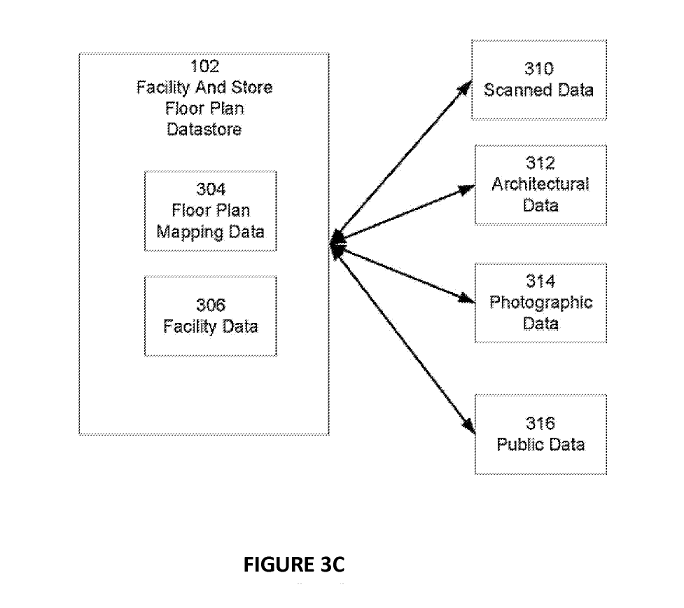

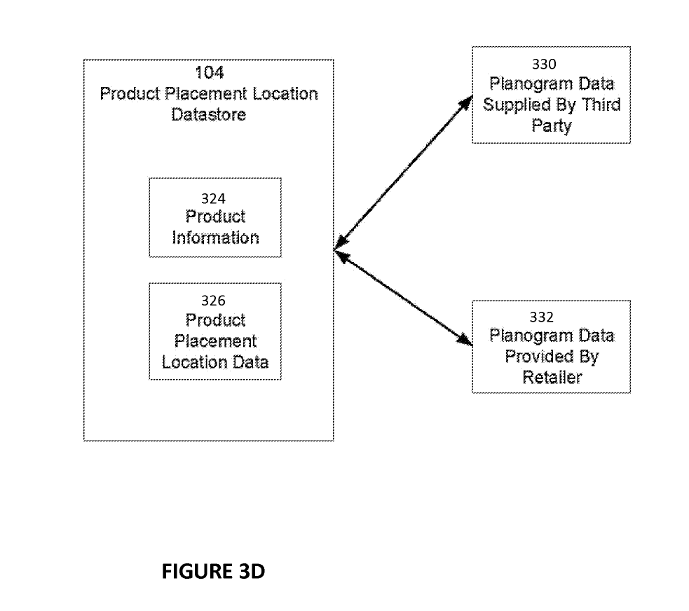

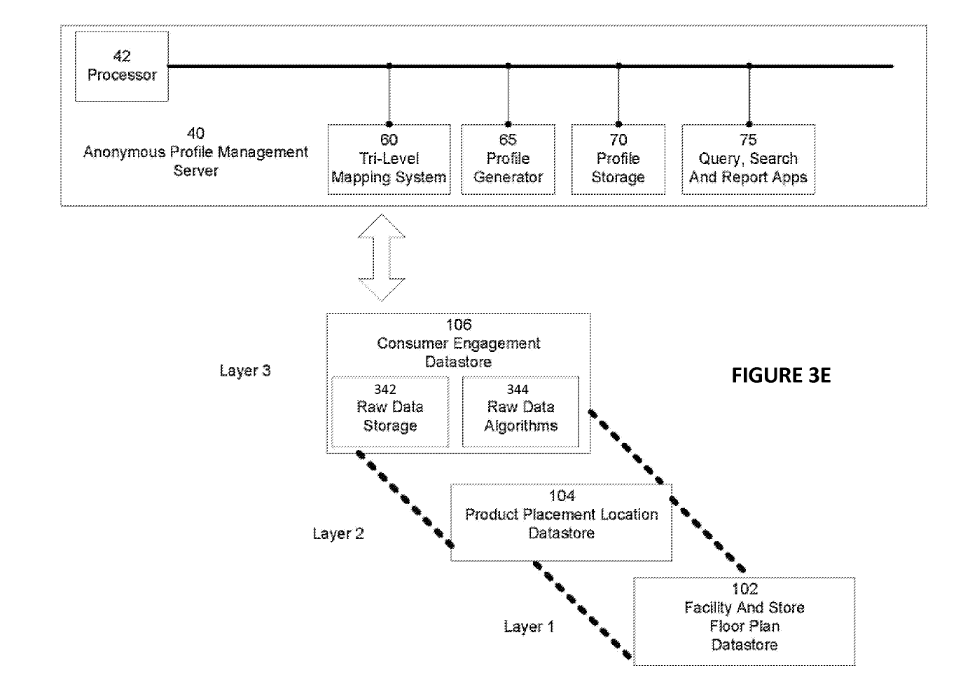

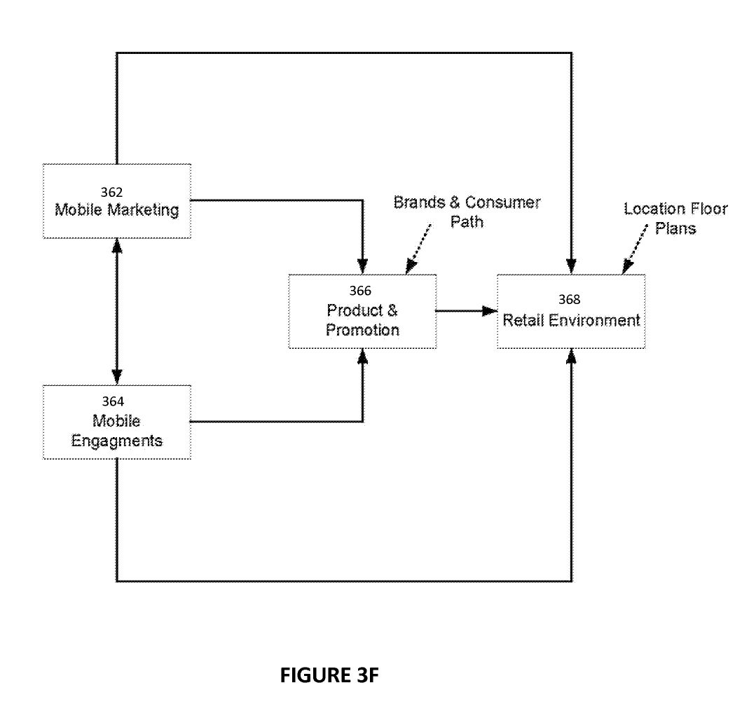

FIG. 2c shows another particular, exemplary embodiment providing targeted and contextual directions to the user related to a store at a shopping mall. Here, a user is a frequent shopper at the particular shopping mall, and is interested in a Ralph Lauren article of clothing (209). The user engages their digital device to direct them to stores or outlets where they have the Ralph Lauren product of interest (206). This engagement could be in a variety of manners, such as code scanning, selection of a digital icon, etc. The digital device will determine the time and location of the engagement by the user (210), here determining that the user is present at a mall frequented by the user (213). A Scan Message is generated by the digital device (215), and, in this embodiment, is then sent to a server (220). The server receives and recognizes the Scan Message (225). The server then queries the user's profile (230), which may be stored on the user's digital device, may be stored on the server system, and/or may utilize the combined data stores consisting of the user's local data store and the data store maintained on a server system. Here, the server accesses recent user activity, which reflects shopping for Ralph Lauren products (232c). This user activity data could also reflect other similar items of interest to the user, particular brands of interest, particular sizes of interest, particular colors of interest, particular prices of interest, etc. The server, after accessing the user's profile (which reflects user preferences, recent shopping history, location history, etc.) determines the location of the product of interest to the user (231), which may be a local (within the shopping mall) store, or a store within a particular range specified by the user. In one embodiment, the location data reflects local store inventory of the item of interest through the use of a planogram, or through other methods. In another embodiment, the location data reflects local store inventory of the item of interest either via direct inventory query to the store or stores carrying inventory, or via communication by the digital device with a server system capable of inventory queries of the stores carrying inventory of the item of interest (239). Based on the Scan Message, user profile, position data, and/or the like, Directions information is retrieved from an information base (235). Here, the Directions content provides the location of the Ralph Lauren product in a store within the mall where the user is present, or alternatively in other nearby stores (238c). Once the server has formulated a Reply Message, which contains the pertinent Directions data (241), it may send the Reply Message to the user's digital device (245). The Reply Message is received by the user's digital device (250), which may display the response in a map form depicting the location or locations of the item of interest, here the Ralph Lauren product, in a tri-level mapping formula (see FIG. 3b), here depicting a shopping mall. The response to the user may also reflect other locations carrying the product of interest (such as if a particular size or color of the item of interest is not available in the shopping mall where the user is presently located). If the user selects one of the other locations, a map may be called up to reflect similar tri-level mapping data.

In alternative embodiments, the user's digital device may retrieve the Directions data independent of a server, with Scan and Reply Messages self-contained within the digital device. In some embodiments, the digital device may optionally access 3^{rd} party databases/servers to retrieve product inventory information, directions data, user profiles, etc.

The tri-level mapping formula could be based on a variety of different algorithms, including, but not limited to, ant colony optimization, bundled savings programs, and/or other selection criteria presented to the user.

Additionally, depending on the embodiments disclosed herein, the server and/or digital device may display any coupons or other store/vendor authorized discounts which are available for the product/service/item of interest, as more fully discussed in commonly owned and co-pending U.S. patent application Ser. No. 13/775,989, filed Feb. 25, 2013, and Ser. No. 13/774,418, filed Feb. 22, 2013, both of which are hereby incorporated by reference in their entirety.

### Providing Directions to Items of Interest

FIG. 3a is a block diagram illustrating a network for collecting and processing consumer engagement data according to an embodiment. A mobile computing device, such as smart phone 10, and an anonymous profile management server 40 are connected to each other via a network 30. In an embodiment, the network 30 is the Internet.

The smart phone 10 comprises a processor 12, a code reader 14, an RFID reader 16, a browser 18, an I/O system 20, a camera 22, a display 24, and a radio system 26. The smart phone 10 may include some or all of features 14, 16, and 22. The smart phone 10 may include additional features that are not illustrated for purposes of clarity, but would be obvious to one skilled in the art.

The anonymous profile management server 40 is also connected to the network 30 and comprises a processor 42, system administration tools 50, an I/O system 55, a tri-level mapping system 60, a profile generator 65, profile storage 70, query, search and reports applications 75, and a display 80. The profile management server 40 may include additional features that are not illustrated for purposes of clarity, but would be obvious to one skilled in the art.

In an embodiment, a user of the smart phone 10 (the user not being illustrated in FIG. 3a), voluntarily agrees to participate in a marketing initiative (“opts-in”) and to provide information relating to the engagement of the user with one or more products or services involved in the initiative or with a facility at which such products or services may be acquired. As will be discussed in detail below, the raw engagement data may be acquired by the smart phone 10 via a code read by the code reader 14, by a code received from an RFID tag read by the RFID tag reader 16, by a link entered by the user in the browser 18, by a picture taken by the user using the camera 22, by a text message created by the user using the I/O system 20, among others, and processed by the processor 12 into readable data.

The engagement data are received by the anonymous profile management server 40 and processed. In an embodiment, the raw engagement data are processed by the processor 42 against the tri-level mapping system (discussed in the detail below), to relate the engagement data to geo-spatial data without the need for any geographic information generated by the smart phone 10. The processed engagement data may be used by the profile generator 65 to create and update a profile for the user of the smart phone 10 that is stored in the profile storage 70. The query, search, and reports applications 75 may be used to search datastores and to analyze profiles and engagement data.

While FIG. 3a illustrates a single server 40 and a single processor 42, multiple servers and processors may be used to receive and process engagement data and to produce and display data, reports and searches performed by query, search, and report applications 75 against profiles stored in profile storage 70.

As illustrated in FIG. 3b, a tri-level mapping system 60 comprises a facility and store floor plan datastore 102, a product placement location datastore 104, and a consumer engagement datastore 106. The tri-level mapping system 60 utilizes data from the facility and store floor plan datastore 102 to map a floor plan of a retail establishment having a known physical address. The tri-level mapping system 60 relates product placement location data from the product placement location datastore 104 to the retail floor plan data from the facility and store floor plan datastore 102. For example, the floor plan data of a “big box store” may define a space within the floor plan using a coordinate-based mapping system. A product A may be assigned to a particular location with that defined space by the product placement location data stored in the product placement location datastore 104. When a consumer chooses to engage with product A (the engagement process is described in detail below), consumer engagement data is produced indicative of the consumer's interaction with product A and stored in the consumer engagement datastore 106. These data may be used to create, enhance, or modify a profile of the subscriber, and may be used to locate the subscriber at the time of the engagement with product A in the big box store at the location where product A has been assigned.

As will be described in detail below, the consumer's engagements with other products in other retail establishments, outside of a retail establishment, or in virtual environment may be used to produce a detailed profile of the consumer that may be used for marketing purposes. It is important to emphasize that the engagement data is only collected when the consumer elects to engage with products and product offerings. A consumer's location is not tracked using GPS or other location systems but by mapping engagement data to product placement location data and floor plan data. As will be further described, the device by which the consumer engages a product may be known by an identifier (e.g., a phone number), but the identifier is not used to obtain personal data of the subscriber. Thus, the systems and methods described herein are both voluntary and anonymous.

### Facility and Floor Plan Datastore (Layer 1)

As illustrated in FIG. 3c, a facility and floor plan datastore 102 occupies a first layer of the tri-level mapping system 60. The facility and floor plan datastore 102 comprises facility and floor plan map data and additional data about a particular facility that are obtained from multiple sources.

Referring to FIG. 3c, the facility and store floor plan datastore 102 is populated using data obtained from multiple sources. For example, scanned data 310 may be obtained by scanning images illustrating a floor plan of a retail store or facility. For example, such data may be obtained from a brochure provided by a mall or a retail establishment and stored as floor plan mapping data 304.

Architectural data 312 may also be obtained from a retail facility, from a third party, or from other sources.

Photographic data 314 may also be obtained from photographs provided by retailers, consumers, or third parties. For example, a data record may be created by simply taking a picture of a mall layout on a map directly from a sign at the mall.

Public data 316 may also be obtained from public sources, such as websites and governmental agencies.

While four sources of data have been illustrated, the sources of the data stored in the facility and store floor plan datastore 102 are not limited. Additionally, these data may be updated through real time user input, editing, and overwriting, or through automated means.

In an embodiment, the data stored in the facility and store floor plan datastore 102 includes information 306 about a retail facility. By way of illustration and not by way of limitation, facility information 306 may include the location, physical address, and physical attributes of the retail facility, information about the area in which the facility is located, the facility brand, the facility's target market, socio-economic data related to the facility and its location, retail infrastructure information, and personnel profiles of the facility's employees. The information characterizing the retail facility at a location may be dynamically updated as rebranding, relocations, renovations, and retail equipment or facility upgrades are made.

The data held in the facility and store floor plan datastore 102 may be compiled both in a three dimensional visual and text based medium and displayed in a virtual environment via display (see FIG. 3a, Block 80).

In an embodiment, the facility and store floor plan datastore Block 102 is configured to enable the upload, from a plurality of sources and network enabled devices, floor plans from scanned images, digital files, mall layouts, architectural drawings, and retail schematics that document physical retail locations and store them as floor plan mapping data 304. In another embodiment, the facility and store floor plan datastore 102 provides for the duplication of floor plans such as those used in franchise operations and multi-unit operations that have similar or identical architecture from location to location.

In another embodiment, query, search and reporting applications (see FIG. 3a, Block 75) allow for system wide data at this layer to be accessed, modified, batched, secured, reported, syndicated, and delivered through automatic data feeds to third parties. In another embodiment, the facility and store floor plan datastore 102 may be hosted in an isolated network or a community of interconnected networks. It can also be hosted on third party systems such as those operated by Content Delivery Networks (CDN's), telecommunications networks, and mobile communication providers.

In another embodiment, access to the facility and store floor plan datastore 102 is tiered. Security protocols may be implemented to provide users with varying levels of access and control over the data through the functions of the administrative system of the anonymous profile management server 40 illustrated in FIG. 3a. The export, import and creation of administrator, customer, user, and third party branded accounts are enabled through this administrative system.

### Product Placement Location Datastore (Layer 2)

As illustrated in FIG. 3b, a product placement location datastore 104 occupies a second layer of the tri-level mapping system 60. The product placement location datastore 104 comprises the location of products relative to the facility and store floor plan data held in facility and store floor plan datastore (FIG. 3b, Block 102).

Referring to FIG. 3d, the product placement location datastore 104 comprises product information 324 and product placement location data 326. The product information 324 and product placement location data 326 may be derived from planogram data 330 supplied by a third party or from planogram data 332 supplied by a retailer. The product placement location data 326 relates the product information to a physical location of the product within a retail facility as floor plan mapping data that is stored in the facility and store floor plan datastore (FIG. 3b, Block 102).

Planograms are used in a variety of retail areas. A planogram defines which product is placed in which area of a shelving unit, and with which quantity it is displayed. The rules and theories for the creation of a planogram are well studied and known by those skilled in the art. For example, a planogram may be used by retailers that want multiple stores and displays within them to have the same look and feel to consumers. Often a manufacturer of consumer packaged goods will release a new suggested planogram with a new product to show how the new product relates to existing products in any given category.

In an embodiment, using the query, search and reports applications (Block 75, FIG. 3a) of the anonymous profile management server (Block 40, FIG. 3a), an authorized user may zoom in and out of the data held in the product placement location datastore 104 through a networked, secure software as a service (SaaS) interface that selects data of retail outlet locations. The user may also navigate from an administrative panel to view retail planograms containing specifics about the product and brand locations within retail environments.

In another embodiment, the product placement location datastore 104 contains multiple planograms that are networked and responsive to user and automatic data input. These planograms may be constantly updated to reflect a near real-time inventory and brand configuration that is present and mapped by this layer onto the retail and facility floor plan mapping data held in the facility and store floor plan datastore (FIG. 3b, Block 102).

In an embodiment, the data held in the product placement location datastore 104 may be responsive to automated inventory monitoring systems such as RFID systems, optical shelving sweep system, and other automated data entry systems. Photographic and retail image mapping technology may also be used in connection with the product placement location datastore 104 to dynamically produce snap shot inventory and video interval analysis to populate planograms.

In another embodiment, text and box based planograms such as those used by high volume consumer goods organizations and supermarkets may be processed into product placement location data 104 and used to map the brands and products within such retail environments.

In another embodiment, pictorial planograms that illustrate “the look” and also identify each product may be imported into the product placement location datastore 104. Referring again to FIG. 3b, the first two layers of the tri-level mapping system 60 comprise a facility and store floor plan datastore 102 and a product placement location datastore 104. Together, these datastores provide at least the following functionality:
1. Creating product planograms that can automatically replicate across a franchise and multi-unit operation.
2. Providing a model of the physical locations of brand presence in the retail environment. Tracking and mapping of products can be achieved through automated means and product SKU's, barcodes, marks, RFID and other product identification methods.
3. Providing administrators a data content node that contains products and brands and can be searched, all or in part, based on the security and access credentials of the user.

In an embodiment, facility and store floor plan datastore 102 utilizes a database architecture on scalable networked computer resources in a server array or in a closed system self contained network that is configured to leverage, query, and store in permanent or temporary memory storage product and brand data from third party resources including but not limited to: Product Price, Product Description, Brand Affiliation, Brand, Brand Planogram, Product Logo, Brand Logo, Product Protection (Trademark, Patent), Product Images, Product Videos, Product Audio Tracks, Demonstrations, Website URLs—Brand—Product, Brand Related Public Filings, Related Stock Data/Display, Barcodes, Product SKUs, QR Codes, 2D Codes, Product Documentation, RFID Data and Transmission, Competing Brands, or Competing Products.

### Consumer Engagement Datastore (Layer 3)

As illustrated in FIG. 3e, the consumer engagement datastore 106 is a third layer of a tri-level mapping system 60. The tri-level mapping system 60 is a component of an anonymous profile management server 40. The consumer engagement datastore 106 comprises raw data storage 342 and raw data algorithms 344.

A consumer may “engage” a product, service or retail environment in a number of ways. By way of illustrations and not by way of limitation, engagement data may be acquired from consumer interactions with: Virtual Reality, Augmented Reality, Scans, Barcodes, QR Codes, Image Recognition, Bio Metric Activations, Audio Recognition, Digital assets (music, video, games, sweepstakes, rebates, or coupons) are uploaded into the system's media library. Content can simply be assigned to various creative and formatted for mobile in “real time” as the campaigns dictates—all from the system portal.

As previously noted, an “engagement” may occur in a store, outdoors, in a virtual reality environment or directly with a product (referred to herein as a “secondary engagement”). For example, a consumer may engage a product outside a retail facility by photographing an object associated with that product. The object may be a store front, a brand mark, or an advertisement displayed on a bus, a billboard, or a bench. A consumer may engage a product at home by photographing the product or by engaging an active or passive code on the product. A consumer may also engage a product on-line or virtually via images sent to a video terminal device such as a set top box or a media terminal connected to a video display device. In these embodiments raw consumer engagement data are received at the consumer engagement datastore 106 from a smart phone 10 (see FIG. 3a), stored in raw data storage 342 and processed by processor 42 using the raw data algorithms 344 against data held in a secondary engagement datastore (not illustrated). In another embodiment, the processed consumer engagement data are further processed by the profile generator 65 and stored in the profile storage 70. In still another embodiment, the secondary engagements are associated with retail facilities known to be frequented by the consumer or other landmarks to acquire a probable location of the consumer when the secondary engagement occurred.

The raw data algorithms may include a tri-layer path equation which can be used to produce mobile marketing analytics and data that associate user profiles with products, brands, and mobile marketing engagements.

As previously described, raw consumer engagement data are received at the consumer engagement datastore 106 from smart phone 10 (see FIG. 3a), stored in raw data storage 342 and processed by processor 42 using the raw data algorithms 344 against data held in the facility and store floor plan datastore 102 and the product placement location datastore 104. In another embodiment, the processed consumer engagement data are further processed by the profile generator 65 and stored in the profile storage 70.

While FIG. 3a and FIG. 3e illustrate a single server 40 and a single processor 42, multiple servers and processors may be used to receive and process engagement data and to produce and display data, reports, and searches performed by query, search, and report applications 75 against profiles stored in profile storage 70.

In an embodiment, search and report applications 75 operate a decision engine that tracks, calculates, and records the engagement of mobile marketing campaigns, offers, promotions, discounts, and other mobile marketing metrics.

In another embodiment, the data held in the consumer engagement datastore 106 can be queried and managed by administrators and users that view data all or in part through a secure software as a service (SaaS) platform based on credentials and data access levels.

### Profile Management

### Brand Identity

In an embodiment, an anonymous consumer record may be associated with brands and products engaged by mobile device associated with that record using the data contained within layers one and two of the tri-level mapping system 60.

### Brand Mapping

In an embodiment, the geographic footprint of products, brands, and mobile engagements may be placed within layers one and two of the tri-level mapping system 60. This results in the ability to create and render visual display of a brand, product, or mobile marketing deployment. Further, as users engage with the system, and are anchored into geographic locations as present in layers one and two, the footsteps of the consumer may be rendered in a visual display.

### Brand Strength

In an embodiment, the strength of a brand within the profile of a consumer or within the profiles of a group of consumer profiles may be represented graphically and/or numerically. The brand strength may be based on the number of engagements the profile has had with a brand and the quality of those engagements in terms of conversion, opt-in, or any other measure of mobile marketing campaign engagement.

### Brand Profile

In an embodiment, the combination of brands in a consumer profile comprises a brand profile. Brand profiles may be quickly queried by system administrators. For example, a query may request brand profiles that are similar as defined by the query or that are exactly alike. Reports may be automated, customized, and refined using the search and report applications 75 components of the anonymous profile management server 40.

### Brand Profile Matching, Grouping, Categorizing

In an embodiment, the search and report applications 75 components may be used to create reports and data displaying the relationships, groupings, and categorizations of brand profiles in a mobile marketing context. The anonymous nature of data and associated user profiles over the three layers of the tri-level mapping system 60 allows for users to engage and opt-in to mobile marketing engagements securely. In an embodiment, reports created using brand profiles can aid customers of the software as a service platform to switch users from brand to brand or to market to opted-in mobile users that share common brand profiles.

### TRI-Layer Mobile Marketing Mapping

In economics, the sub-discipline of econometrics has been defined as broadly as the discipline concerned with the development of economic science in concert with mathematics and statistics. It has also been defined more narrowly as the application of mathematics and especially of statistical methods to economics. Theoretical econometrics studies the statistical properties of econometric procedures. Such properties include power of hypothesis tests and the efficiency of survey-sampling methods, of experimental designs, and of estimators. Applied econometrics includes the application of econometric methods to assess economic theories and the development and use of econometric models, for use in economic history, and in economic forecasting.

Many econometric methods represent applications of standard statistical models to study economic questions. Econometrics is especially concerned both with observational studies and with systems of equations. First, economic studies are most often observational, rather than controlled experiments. Therefore, the design of observational studies in econometrics is similar to the design of studies in other observational disciplines, such as astronomy, epidemiology, and political science; similarly, the statistical analysis of data from an observational study is guided by the study protocol, although exploratory analysis of data sets is useful for generating new hypotheses.

### Path Modeling

As illustrated in FIG. 3f, two exogenous variables, mobile marketing (Block 362) and mobile marketing engagements (Block 364), are modeled as being correlated and as having both direct and indirect effects through two dependent variables, retail and real estate (Block 368) and product and brand placement (Block 366). The statistical models and the variables may also be affected by factors outside the model.

Using the same variables, alternative models are conceivable. For example, it may be hypothesized that product placement in a planogram has only an indirect effect on mobile marketing engagement, thus the arrow between the two would be deleted, and the likelihood or “fit” of these two models can be compared statistically and reports produced that leverage data collected throughout all three tiers of the data management structure.

In order to validly calculate the relationship between any two boxes in the diagram, Wright (1934) proposed a simple set of path tracing rules for calculating the correlation between two variables. The correlation is equal to the sum of the contribution of all the pathways through which the two variables are connected. The strength of each of these contributing pathways is calculated as the product of the path-coefficients along that pathway. In an embodiment, the path equations and relationship correlations are performed by a processor so as to equate, display, and deliver data to software such as a service (SaaS) platform accessed by administrators over authenticated network devices, or by consumers in mobile marketing engagements over any Internet connected device.

Using statistical models, all relationships that exist between the layers may be calculated. The algorithms used to determine these relationships may be managed and revised. The algorithms may be used to create actionable and useful mobile marketing data including a visual database component that displays brands affiliated with a user profile managed over scalable computer network resources in an array or within a self contained network.

### Statistical Modeling

In an embodiment, an anonymous statistical model is produced that is based on tracking opted-in consumer engagements within the overlapping three data layers that make up a data super structure that employs any number of networked and or Internet accessible resources. The anonymous consumer record is primarily focused on transforming data used to associate user profiles with products, brands, and retail real estate into actionable and valuable mobile marketing analytics.

In another embodiment, visually integrated data may be delivered as a three-dimensional rendering or multi-dimensional rendering. Text, graphical, animated, and image based data reports may also be produced. Consumer foot traffic through a facility may be mapped and anonymous brand affiliation profiles created from the tracking of consumer engagements within the mapped mobile marketing landscape.

The foregoing method descriptions and the process flow diagrams are provided merely as illustrative examples and are not intended to require or imply that the blocks of the various embodiments must be performed in the order presented. As will be appreciated by one of skill in the art, the order of blocks in the foregoing embodiments may be performed in any order. Words such as “thereafter,” “then,” “next,” etc., are not intended to limit the order of the blocks; these words are simply used to guide the reader through the description of the methods. Further, any reference to claim elements in the singular, for example, using the articles “a,” “an,” or “the,” is not to be construed as limiting the element to the singular.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the embodiments disclosed herein.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some blocks or methods may be performed by circuitry that is specific to a given function.

In one or more exemplary aspects, the functions described may be implemented in hardware, software, firmware, or any combination thereof. If implemented in software, the functions may be stored on or transmitted over as one or more instructions or code on a computer-readable medium. The blocks of a method or algorithm disclosed herein may be embodied in a processor-executable software module, which may reside on a computer-readable medium. Computer-readable media includes both computer storage media and communication media including any medium that facilitates transfer of a computer program from one place to another. A storage media may be any available media that may be accessed by a computer. By way of example, and not limitation, such computer-readable media may comprise RAM, ROM, EEPROM, CD-ROM or other optical disk storage, magnetic disk storage or other magnetic storage devices, or any other medium that may be used to carry or store desired program code in the form of instructions or data structures and that may be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray disc, where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a machine readable medium and/or computer-readable medium, which may be incorporated into a computer program product.

### Code Triggered Information Server (CTIS) Detailed Overview

### User and Directions Provider Participation

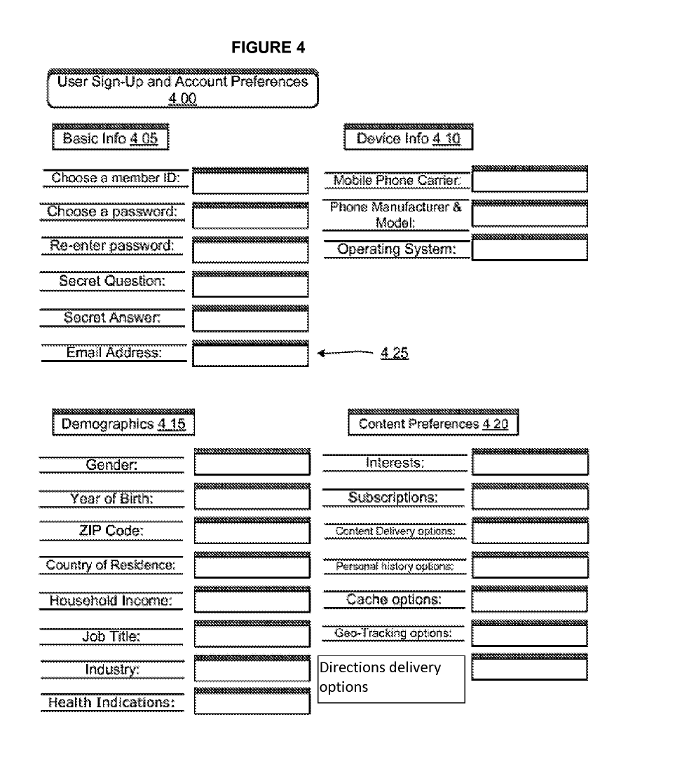

The CTIS may be enabled by the participation of Directions providers and users. In one embodiment, Directions providers supply Directions for storage on the CTIS server. In an alternative embodiment, the Directions are stored on third party servers that are referenced by the CTIS server. The user experience may be enhanced by the incorporation of personal preferences and demographic information to optimize the targeting of Directions content. Consequently, one embodiment would incorporate a user registration procedure. Users may register for the CTIS via the internet, telephone, postal mail, and/or the like. If a particular embodiment of the CTIS requires client software for the user to install, this could be supplied upon successful user registration. FIG. 4 shows an exemplary embodiment of a user registration interface 400, wherein a user can input Basic Info 405 (e.g., member ID, password, secret question/answer, e-mail address, etc.), Device Info 410 (e.g., mobile phone carrier, phone manufacturer & model, operating system, etc.), Demographics 415 (e.g., gender, year of birth, zip code, country of residence, household income, job title, industry, etc.), and Content Preferences 420 (e.g., interests, subscriptions, content delivery options, personal history options, cache options, geo-tracking options, Directions delivery options, “local” range, etc.) in a plurality of fields 425. In one embodiment, the Content Preferences may include a “local” range element, by which the user is able to determine the range within which he or she would be interested in locating the item/product/service of interest. This would be similar to the eBay shopping experience, where the user is able to select a range of “local” (i.e., within the current shopping location [mall, retail store, etc.]), within 1 mile, 5 miles, 10 miles, etc. In an alternative embodiment, a basic user identification packet (e.g., a “cookie”) is sent with a user's first code scan, thus establishing a basic user profile that can be filled in with greater detail at a later time.

In another embodiment, a cookie is stored on the user's digital device for future use by an online website that shows products/services of interest to a user. The cookie may be used to indicate particular user preferences by brand, style, color, size, etc. The preferences reflected by the cookie can be utilized by this invention to build the user map for directing the user to the location or locations of a product/service/item of interest, in the same manner as a user profile would be accessed/queried (see FIGS. 1a and 2a-c).

### Code Capture (105)

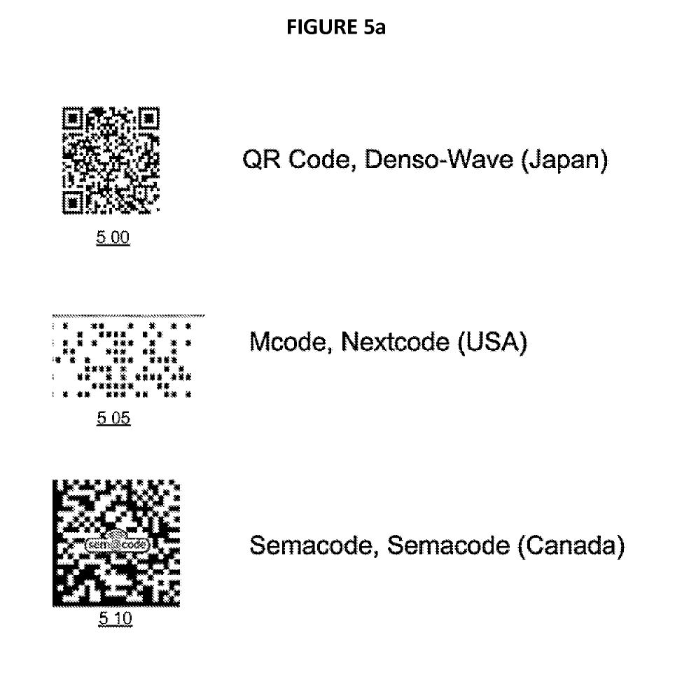

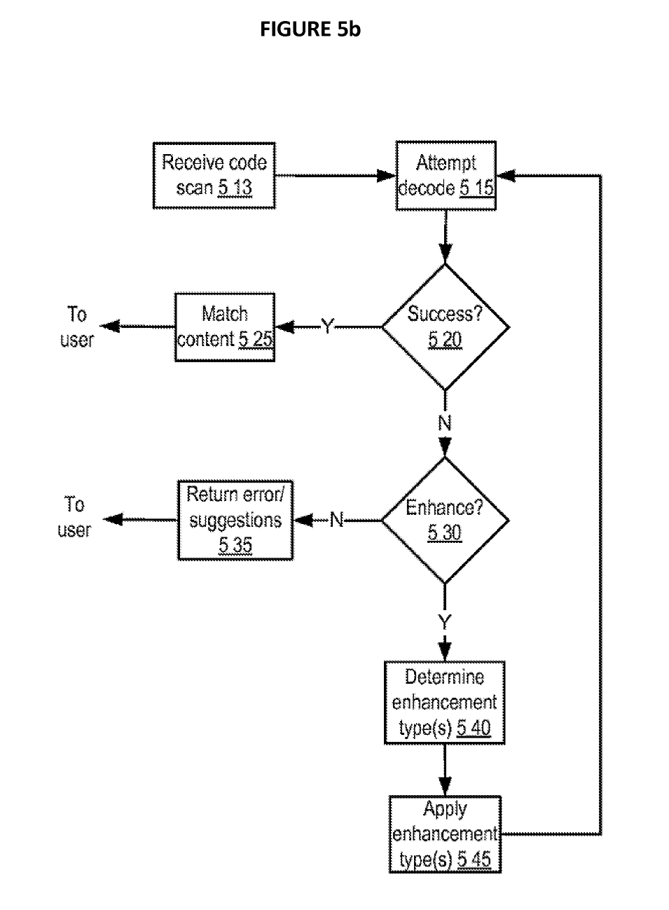

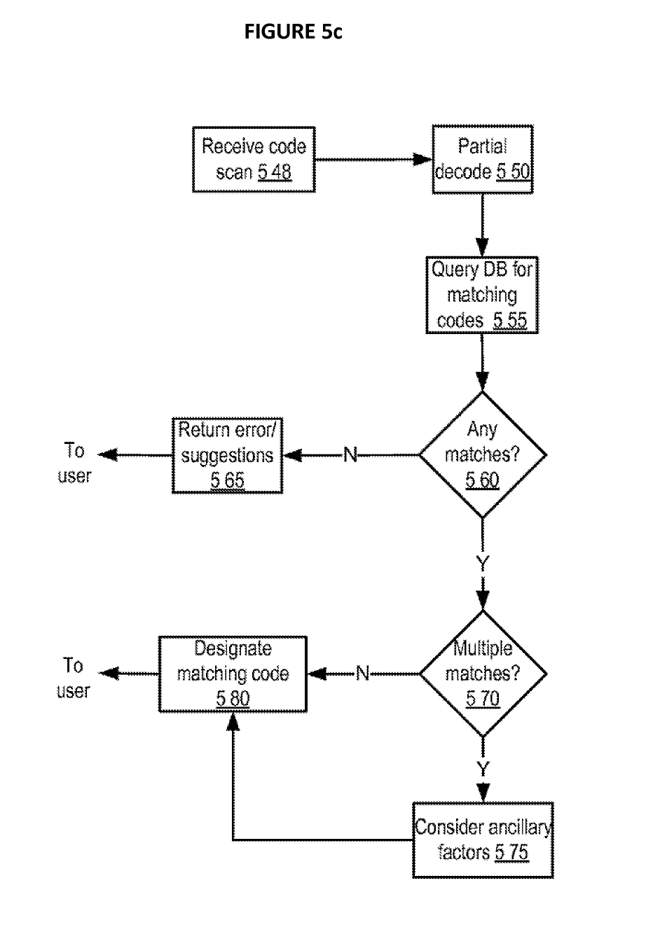

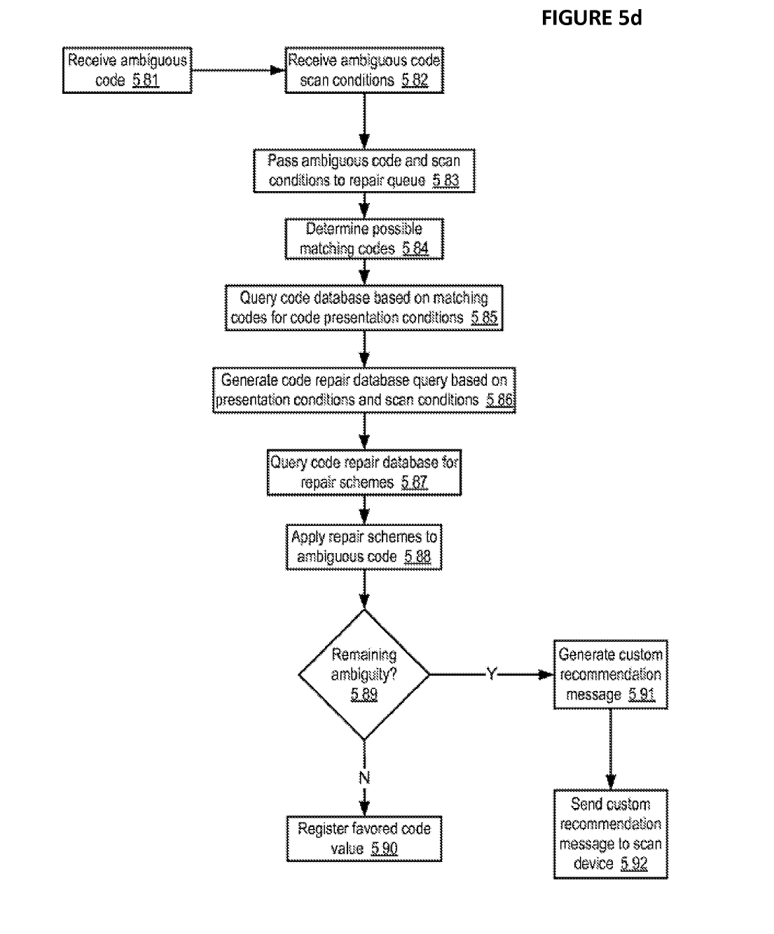

Scannable codes may be found in a variety of locations, including but not limited to newspaper and magazine articles, signs and billboards, flyers, store locations and kiosks, consumer products, packages, clothing, stickers, websites, software displays, television broadcasts, virtual worlds, and/or the like. The nature of the code and associated method with which the code can be scanned will depend to some extent on where the code is found, but among the possible types of codes are standard barcodes (e.g., UPC, EAN, Code 128, etc.), 2D matrix codes (e.g., QR code, Semacode, Data Glyphs, mCodes, etc.), user-input codes (e.g., text messages), RFID tags, NFC tags, pure images (e.g., an image of a sign to be analyzed by optical character recognition), website links, software inputs, and/or the like. These codes may be located on any medium (e.g., on newspapers, magazines, books, video content, computer screens, embedded in objects (e.g., RFID tags on clothes, etc.), and/or the like). One embodiment employs 2D matrix codes, examples of which are provided in FIG. 5a, due to their large data capacity, ease of scanning, and resilience to damage or error. These examples include QR codes 500, Mcodes 505, Semacodes 510, and/or the like.

### Code Enhancement

In scanning a code, the code image may not always be recorded faithfully and/or in an ideal and/or suitable condition for decoding and/or matching to associated content. Consequently, the CTIS may be configured to enhance and/or otherwise process a code image in order to better recognize the code. FIGS. 5b-c show implementations of logic flow for processing and/or managing non-ideal code scans in embodiments of CTIS operation. In FIG. 5b, a scanned code is received at the CTIS server (513) and a first attempt is made to decode a received code scan (515). In one implementation, a received code scan may take the form of a bitmap image and/or a compressed bitmap image. If the decoding is successful (520), then the code is matched to associated content (525) that is ultimately destined to be served to a user. Otherwise, a determination is made as to whether enhancement should be applied to the scanned code (530). If not, then an error message and/or suggestions on how to improve the quality of the scanned code may be returned to the user (535). The CTIS may decide not to apply enhancement, for example, if enhancement has already been applied unsuccessfully to the same image before or if the quality of the image is so poor as to be clearly beyond improvement. If enhancement is to be applied, then the CTIS determines the appropriate enhancement type (540) based, for example, on the quality and character of the scanned code image and subsequently applies the enhancement (545), after which a new attempt is made to decode the scanned code.

In some implementations, multiple enhancement processes may be applied against a scanned code and the results compared in order to determine the encoded content. Prior to enhancement, the image may be downsized if necessary for speed of processing in applying multiple enhancements against the image. Image quality may also be increased if necessary in order to more successfully apply enhancements. For code images having extraneous information and/or noise, an enhancement process may be applied to remove all extraneous information, despeckle, and/or the like. For code images having shades of gray and/or shadows obscuring the encoded content, an enhancement process may be applied to manipulate the contrast and/or brightness of the image in order to create a pure black and white image for cleaner decoding. For code images that are tilted and/or not taken flat in a plane, an enhancement process may be applied to tilt the plane of the code to create a flat plane to aid in successful decoding. For code images that are rotated or skewed, an enhancement process may be applied to de-rotate, deskew, and/or otherwise recreate proper rectangular pixel groupings that can be decoded. For code images that are taken out of focus, an enhancement process may be applied to sharpen the image into recognizable pixel groupings. Additionally, the CTIS may apply edge recognition processes to the code image to create a set of potential code images that can be processed and compared to records in a code database.

### Partial Decoding

In some cases in which full decoding of a scanned code image is impossible, a partial decoding may be accomplished and serving of content achieved on that basis. A partial decoding may, for example, result in a probabilistic code match without ever successfully decoding the complete code. FIG. 5c shows an implementation of logic flow for partial decoding in one embodiment of CTIS operation. A scanned code image is received (548), partially decoded (550), and the partially decoded content used to query a code database to find matching codes (555). A determination is made if any matches exist (560) and, if not, then the CTIS may return an error message to the user and/or make suggestions about how to improve the image of the scanned code (565). If a match is found, however, then a determination is made as to whether there are multiple matches (570). If so, then the CTIS may consider ancillary factors (575) in attempting to isolate a single code as the most likely match to the received code. Such ancillary factors may include, but are not limited to: the incoming phone number, the carrier, the time of day, current code traffic, the source of the code, the context of the code, the user ID, the hardware ID, the user behavioral history, the user location, and/or the like. In considering ancillary factors, the CTIS is thus capable of predicting the true code based on knowledge of the user scanning the code, the context of the code, ambient factors, and/or the like. Once a unique code has been identified, this is designated as the matching code (580) and the CTIS proceeds with determining the appropriate associated content to serve to the user.

In an illustrative example of partial decoding, a given matrix code may encode the string ABC123. In multiple processes, it may be determined that the code contains A_{—}1_{—}3 (where the blanks represent unknown values), _C1_, and AB_. Through these multiple processes, the CTIS system now knows that the code contains ABC1_{—}3 and may check this against codes in a code database to determine how many matches exist. If it finds two matching codes (e.g., ABC123 and ABC143), it may consider ancillary factors. For example, ABC123 may correspond to an advertisement and directions to a theater for a new action movie while ABC143 corresponds to a coupon for women's cosmetics and directions to a nearby pharmacy. If the user supplying the code is determined, based on a supplied user ID, to be a man with a history of scanning movie-related codes, then the CTIS system may infer that ABC123 is the matching code and serve the corresponding content. In one implementation, the CTIS server may further supply a confirmation request for partially matched codes, requesting the user to affirm or deny that the supplied content is, in fact, the content that he or she was seeking

### Scan Message Data Structure (115)

The Scan Message generated by the CTIS is, itself, a novel data structure. In one embodiment that is illustrated in FIG. 6, it contains an identification field (605) comprising a unique user ID (605a) and a hardware ID (605b), both automatically supplied by the device used to scan and transmit the scanned code; a coordinate field (610) comprising the location geocode (610a) (e.g., GPS coordinate, latitude and longitude, city and state, etc.) and timestamp (610b) of the scan; and a code field (615) supplying the specific content of the scanned code, which may include a subject code (615a) for the code context, a source code (615b) indicating where the code was located, and a content code (615c) indicating the specific information, if any, to be supplied in response to a scan of that code.

In one embodiment, the XML for the Scan Message takes the following form:

<Scan_Message>
<ID>
<User ID> 012345 </User ID>
<Hardware ID> Nokia 660 </Hardware ID>
</ID>
<Coordinates>
<Geocode> GPS 40 46.516 -73 57.98 </Geocode>
<Timestamp> 08/21/2006 13:45:28 </Timestamp>
</Coordinates>
<Code>
<Subject> entertainment; movies; comedy </Subject>
<Source> New York Times </Source>
<Content> Showtimes for latest popular comedy movie </Content>
</Code>
</Scan_Message>

### Data Transmission (120, 125, 145, 150)

In one embodiment, sending and receiving the Scan Message and Reply Message will employ standard data transmission techniques to ensure successful transmission and to preserve data integrity (e.g., TCP/IP, 1xEV-DO, etc.). This is relevant for the Scan Message, which will contain the coded information scanned by the user. Such techniques may include but are not limited to the use of standard transmission protocols, “handshaking,” data compression, data encryption, and error correction.

### User Profile Structure (130)

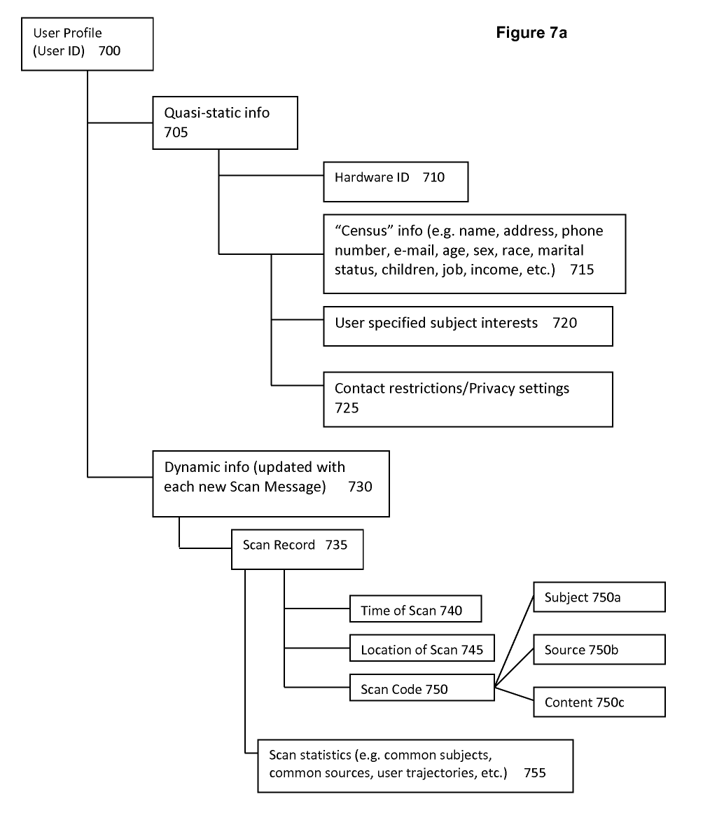

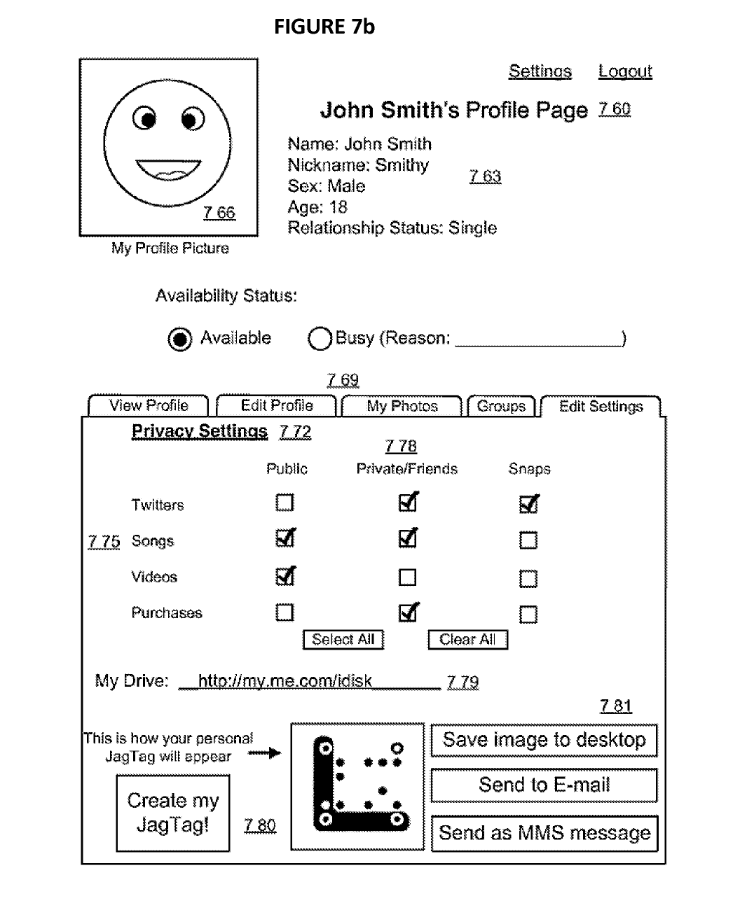

The content of the user profile generated by the CTIS is itself a novel data structure. In one embodiment illustrated in FIG. 7a, the profile (700), which is uniquely specified by the user ID, will contain a category of quasi-static user information (705) that is generally fixed over time and one of dynamic user information (730) that is updated with each successive Scan Message that the user submits. The quasi-static info (the “quasi” qualifier indicates that this information may be updated, for example if a user changes their mobile device, however it does not change with each successive code scan) may include a hardware ID (710); “census” info (715) such as name, address, phone number, e-mail address, age, sex, race, marital status, number and age of children, job title, annual income, etc.; subjects of interest specified by the user (720); and information regarding allowed methods to contact the user (725). In one embodiment, this information could be supplied by the user when registering for the CTIS service as, for example, on a website. The dynamic info in the profile may include a scan record (735), comprising the time (740), location (745), and scan code (750) (including subject (750a), source (750b) and content (750c)); and statistics related to the scan history (755). Such statistics may include but are not limited to the most popular scan subjects, most popular scan sources, user space-time trajectories, etc. In one embodiment, the profile contains a series of identifying codes distilled from the profile content (e.g., demographic category code based on census info, subject codes, source codes, etc.) that can be compared with similar codes in the Scan Message to determine the appropriate Directions content to include in the Reply Message. In an alternative embodiment, the profile contains identifying keywords or “tags” based on the profile content that can be compared with similar tags in the Scan Message to determine the appropriate content to include in the Reply Message. In both cases, the identifying labels for the user profiles may be input by CTIS administrators or automatically generated by an appropriate computer algorithm such as stripping header labels from Directions descriptions (e.g., for example, stripping the header tags from an HTML format of Directions).

In one embodiment, the XML for the User Profile may take the following form:

<User>
<Quasi-static info>
<User_ID>123-45-6789</User_ID>
<Hardware ID> Nokia 660 </Hardware ID>
<Census info> John Smith; 123 Maple Dr., Smalltown, CA 92676;
(123)456-7890; jsmith@email.com; 55 years; male; white;
married; 2 children ; etc.
</Census info>
<Interests> camping; fishing; classic cars; movies; etc. </Interests>
<Contact restrictions> Weekdays 8 AM - 7 PM only </Contact
restrictions>
</Quasi-static info>
<Dynamic info>
<Scan record>
<Scan_#1>
<Time> 08/21/2006 13:45:28 </Time>
<Geocode> GPS 40 46.516 -73 57.98 </Geocode>
<Code>
<Subject> entertainment; movies; comedy </Subject>
<Source> New York Times </Source>
<Content> Showtimes for latest popular comedy movie </Content>
</Code>
</Scan_#1>
<Scan_#2>
etc...
</Scan_#2>
etc...
</Scan record>
<Scan statistics>
<Popular subjects> entertainment; cars; travel; etc. </Popular subjects>
<Popular sources> New York Times; Car and Driver; CNN.com;
etc. </Popular sources>
<Trajectories> Data files listing time and geocode coordinates, computed
average trajectories, likely locations, etc. </Trajectories>
etc...
</Scan statistics>
</Dynamic info>
<Code>
<Subject> entertainment; movies; comedy </Subject>
<Source> New York Times </Source>
<Content> Showtimes for latest popular comedy movie </Content>
</Code>
</User>

In one embodiment, data accumulated in a plurality of user profiles may be analyzed to extract information about codes that are scanned. For example, the frequency with which a particular code is scanned may be extracted from user profiles and parsed by geographic, temporal, and/or demographic criteria to yield code profiling information. This information may be stored in a code and/or Directions profile. In an alternative embodiment, the code/Directions profile may be constructed and/or updated by the CTIS immediately upon the receipt of a Scan Message rather than being extracted from user profiles.

### Information Base (135)

### Directions and Labels—Searching

The Information Base contains the content that may be included in the Reply Message sent to the user and may be stored on the CTIS central server or on third party servers accessed by the CTIS. In one embodiment, each Directions is associated with searchable labels. The Directions content together with its labels, collectively referred to here as Directions, forms a novel data structure. In one embodiment illustrated in FIG. 8, the Directions (800) are comprised of the specific Directions content (805) (e.g., text, images, video, etc.) and a set of identifiers (810) including subject tags (815), information characterizing the temporal character of the Directions based on which the Directions may be triggered (820) (e.g., 6 to 10 AM for breakfast Directions), information characterizing the geographic specificity of the Directions based on which the Directions may be triggered (825), demographic specificity of the Directions (830) (e.g., Directions for family vacations), and the hardware requirements of the Directions (835) (e.g., hardware IDs of devices capable of displaying the content of particular Directions). In one embodiment, the Directions would also contain information identifying the source in which the Directions code is to appear. In another embodiment, the Directions would also contain code/Directions profile data, describing the history and/or statistics of scans related to the Directions.

In one embodiment, the XML for Directions may be in the following form:

< Directions>
< Directions_ID>123</ Directions_ID>
< Directions content>
textual movie showtime listings and guidance to theater ( or images, audio,
video, URLs, etc.)
</ Directions content>
<Identifiers>
<Subject> entertainment; movies; comedy </Subject>
<Temporal> 08/21/2006; 12:00:00 to 14:00:00 </Temporal>
<Geographic> Smalltown, CA 92676 </Geographic>
<Demographic> 17 years and older </Demographic>
<Hardware> any (text only) </Hardware>
</Identifiers>
</ Directions>
User Profile Query (130)

### Static Content and Dynamic Content in Reply

The CTIS queries the user profile to determine which Directions to include from the Information Base in the Reply Message in order to tailor those Directions to the user's profile characteristics, interests, and trajectories. In one embodiment, a scanned code will yield two components in the Reply Message content: i) static content that is the same for every user who scans the code, and ii) dynamic content that depends on the context of the user and the user profile. The static content (i) is determined from the scan code, while the dynamic content (ii) is determined by a combination of the scan code and the user profile, requiring a dynamic content generation heuristic to combine their respective influences. While a variety of such heuristic are possible and contemplated as being within the scope of this disclosure, and the specific heuristic employed in a given realization will likely depend on the precise application and intention, we discuss one embodiment of this heuristic here for illustrative purposes with reference to FIG. 9. In one embodiment, the scan code and user profile is labeled with keywords or “tags” that identify the subject content of each. In an alternative embodiment, the scan code, user profile, and Directions are labeled with identifying codes. In either case, the heuristic exhibited in FIG. 9 first filters all Directions in the Information Base by the subject code or tag of the scanned code (900). The Directions from 900 are filtered by the hardware ID (905) to ensure that the Directions content can be successfully acquired and displayed by the user. The Directions from 905 are filtered into separate categories by scan location (910a1), user address (910a2), user specified subject interests (910b1), user scan subject history (910b2), scan time (910c), or user demographic category (910d). Directions in each of these filtered categories are compared to determine which occur most commonly across 910a, b, c, & d (915). The server determines if 915 has yielded a single set of Directions (920), and if so, it incorporates the Directions' content into the Reply Message (930). Otherwise, it chooses one set of Directions at random from the remaining Directions (925) for incorporation. It must be emphasized again that this is but a single, specific embodiment of the user profile query heuristic intended for illustrative purposes. The heuristic is highly flexible and can be finely tuned for the specific application at hand. Some other possible methods may include alternative ordering of filters, addition or removal of filters, weighted filtering, complex conditional trees, and/or the like.

### Heuristics—Filtering—Weighting

As an exemplary implementation of this embodiment of the Directions filtering heuristic, we consider the situation discussed above with reference to FIG. 2a. Here, the user scans a code from an article on finance and investment in the business section of a media publication. Keywords associated with this code may include Business, Finance, Investment, etc. Consequently, only those Directions possessing these identifying keywords are passed at 900. In an alternative embodiment, the keywords may be ranked in order or relevance and the Directions filtered accordingly. The Directions from 900 are filtered by Hardware ID; we presently assume that the user's mobile device is equipped with advanced capabilities (text, image, audio, video, internet, etc.), so that all Directions are passed at 905. In an alternative embodiment, the Directions filter may preferentially choose those Directions that take fullest advantage of the user device's display capabilities. Of the remaining Directions, there is one for a brokerage firm that is tagged with a location code corresponding to the user's address (San Francisco, Calif.), the user's specified subject interests (investing, retirement), and a portion of the user's demographic profile (age 55 or older). The three tag matches (location, subject, and demographic) distinguish this set of Directions from the others in the Information Base, which, in this example, all have two or fewer tag matches; so this unique set of Directions, a brokerage firm located in San Francisco, Calif. with retirement services, is chosen to be served to the user's mobile device.

### Relevance Rating

In one embodiment, the user may respond to the Reply Message with a relevance rating. This rating may then be stored in the user profile and/or employed to refine the criteria for tailoring future Reply Messages to that user.

In one embodiment, the Directions would not be filtered by hardware ID at 905. Rather, when a final set of Directions has been selected for inclusion in the Reply Message following filtration under the other relevant criteria, the server will determine whether that set of Directions is properly formatted for the device specified by the hardware ID. If so, then the Directions will be included in the Reply Message as is. Otherwise, it will be converted into the required format appropriate to the user's mobile device. For example, if the selected Directions contain color images but the server determines that the user's hardware device is an early model BlackBerry that only accommodates monochromatic text, the server will implement a peripheral application to strip the text content from the Directions and incorporate only that in the Reply Message.

### Trajectories in Cyberspace-Time

In another embodiment, the system may be generalized to analyze trajectories in “cyberspace-time.” In this embodiment, a record of trajectories is kept of the user's activity on the world wide web as browsed, for example, on the user's internet enabled mobile device. A generalized concept of “distance” may be incorporated, for example reflecting an average number of links needed to get from one website to another. Provider locations become websites in this embodiment, and a zone breach may be registered when the user is a specified number of links away from the provider's website. Then, just as before, the CTIS can anticipate user cyberspace-time trajectories and supply Directions, coupons, pop-ups, etc. related to websites that the user is approaching. For example, the CTIS may track that a user visits web site A at 9:00 AM and web site B at 9:20 AM every day. The CTIS may then provide ads to website A at 8:50 AM and to website B at 9:10 that are targeted to that user. In an alternative embodiment, the CTIS may provide this targeting information to existing Directions serving systems, which in turn may use the targeting information for timely placement of Directions. The aggregation of such targeting information, in particular, may be useful to advertisers and website owners. For example, reports may be run on user profiles sorted by location (e.g., web sites) and time of visit. This information may be supplied, along with user profile IDs, which may then be used by the advertising servers and/or websites to pre-cache ads that are relevant to the users' interest just prior to their anticipated visits to the website. As such, the CTIS works in conjunction with certain websites to supply user-specific Directions on those sites. As a result, the content of the user profile within the CTIS may be used to select Directions that the user browses using their mobile device. In an alternative embodiment, web-based Directions may be specific to the trajectories of users in geographic space-time, since that information is included in the user profile. For example, if a user is known to be passing by a coffee shop at a specific location and time every day (e.g., a coffee shop on 123 Main Street, NY, N.Y. at 9:00 AM), and is also know to visit a specific website at that time (e.g., at 9:00 AM the user visits website C reading the daily news on their walk to work), then the system may provide the user with Directions directly to their PDA or embedded in website C (because it was pre-loaded as already discussed) for the coffee shop. As such, the CTIS provides a mechanism to provide geographically relevant ads to traditional websites. In yet another embodiment, the total content of the websites browsed by a user on their mobile device may be modified by the content of the user profile within the CTIS. For example, a news website may select articles for a user that are specific to the user profile, including their interests, demographics, current time and location, etc.

### Virtual Space

In another embodiment, the CTIS may analyze the user trajectories in “virtual worlds” or “synthetic realities” and serve ads accordingly. An example of a virtual world is a massively multiplayer online game, such as The Sims Online, EverQuest, World of Warcraft, Second Life, and/or the like. In such a virtual environment, a code scan may be comprised of a particular user action or decision such as initiating or completing a game mission, clicking on an icon, saving a game, etc. In such virtual worlds, geographies and virtual locations may be used in employing trajectories. The history of user activity within the virtual world may then be incorporated into the user profile and used by the CTIS to serve ads within the context of the virtual world or elsewhere. For example, in games like Second Life, virtual televisions, billboards, etc. may be used as advertising delivery mechanisms.

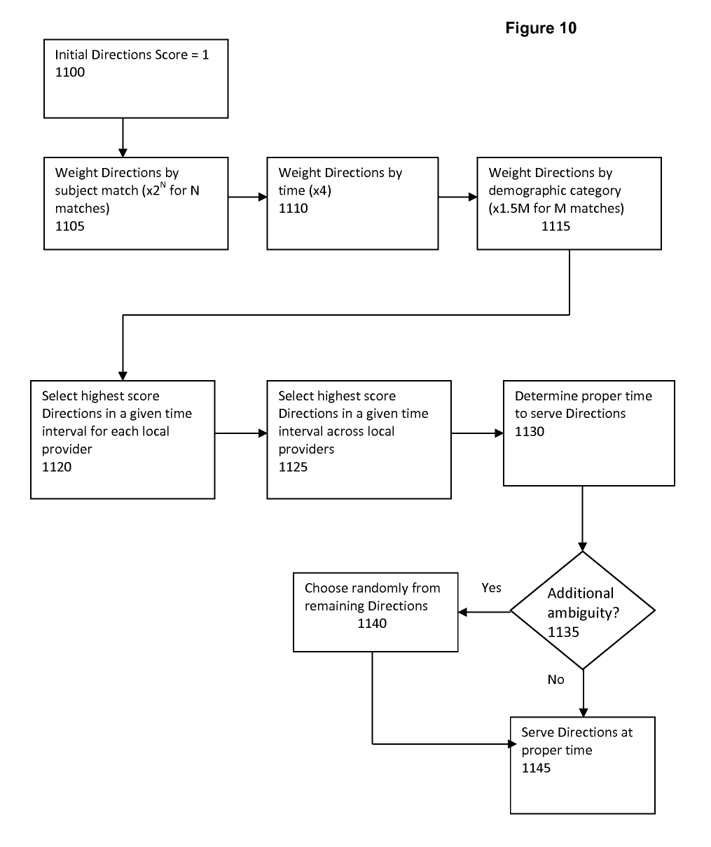

Selecting the proper Directions to serve to the user in the non-triggered Directions serving embodiment of the CTIS may be accomplished using a variety of heuristics that are best tailored to suit the specific use or application. Nevertheless, we present an example of a specific embodiment in FIG. 10 for illustrative purposes. In this embodiment, a weighting system may be employed to select among the Directions of a specific Directions provider once it is established that Directions from this provider is to be served to the user. This weighting system begins by assigning a score of 1 (1100) to all Directions in the Information Base corresponding to the provider. This score is multiplied by a subject coefficient (1105) for every match between the Directions subject and the user specified subject interest or scan subject history. That coefficient is 2 in the present example, so N matches would yield a weighting factor of 2^{N}. The Directions score may also be multiplied by a time coefficient (1110) if the serving time falls within a time range specified for a particular set of Directions. In the present example, the time coefficient is 4, expressing the greater importance of this factor compared to a single subject match. Finally, the Directions score may be multiplied by a demographic coefficient (1115) for every match between the Directions demographic category and that of the user. That coefficient is 1.5 in the present example, reflecting the diminished importance of this factor compared to the time and subject considerations. M demographic category matches will yield a weighting factor of 1.5^{M}. Once all of the Directions provider's Directions are scored in this fashion, those Directions with the highest scores for that provider may be selected over the rest (1120). Similarly, the highest scoring Directions from other providers are selected and the highest scoring Directions over all providers can be selected to serve for a particular time interval (1125). Finally, the proper time to serve the Directions (e.g., 30 minutes prior to the expected average provider zone breach time) is established (1130) and, if there is no further ambiguity (1135), the proper Directions is served at that time (1145). Any residual ambiguity may be resolved by selecting randomly from the remaining Directions.

### Marketing Rules

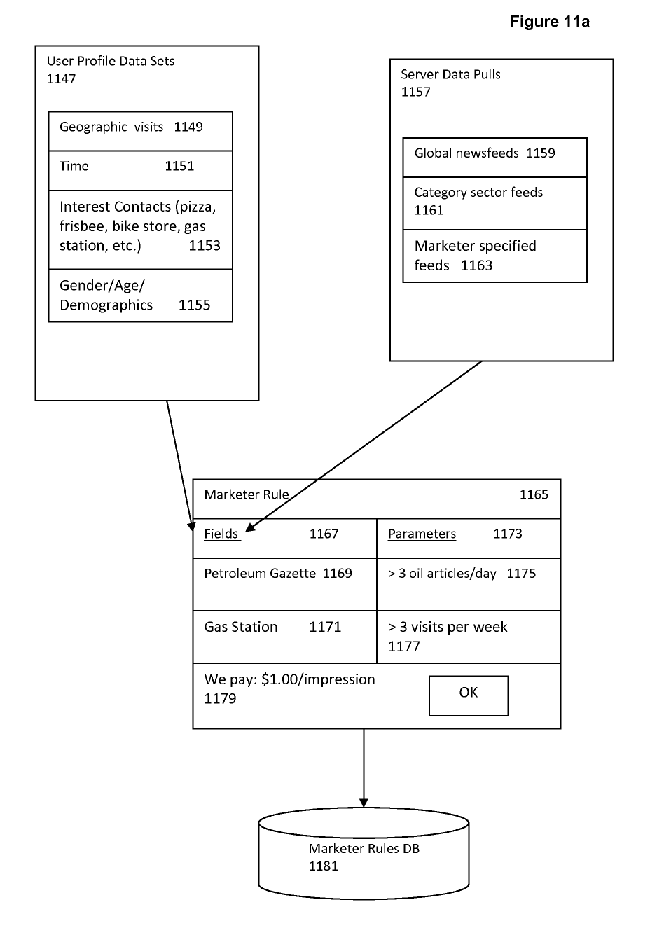

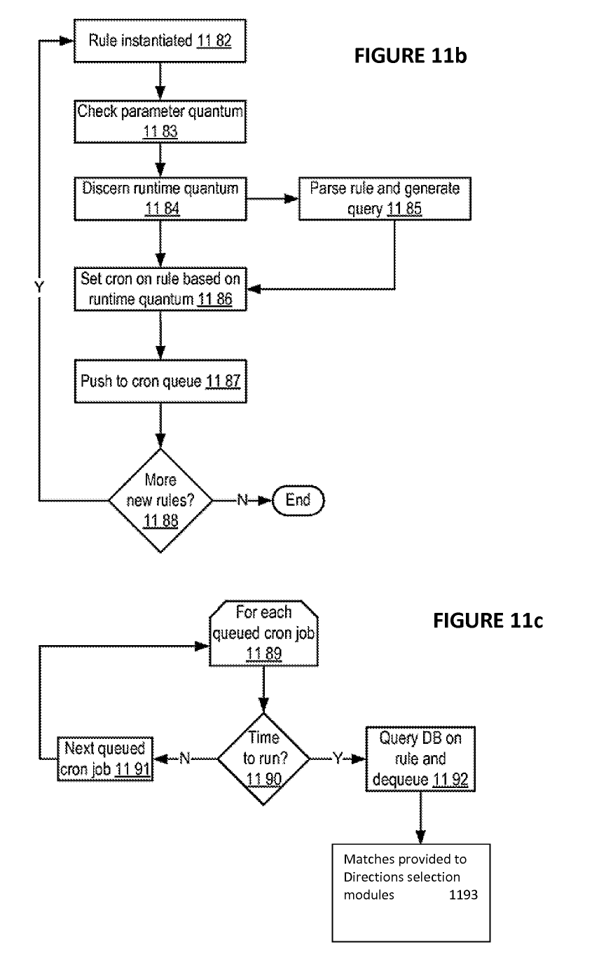

In an alternative embodiment, the CTIS may be configured to receive and implement marketer rules for serving Directions. FIG. 11a shows a schematic illustration of data structures related to establishment of a marketer rule for Directions serving in one embodiment of CTIS operation. A user profile data sets (1147) may include a variety of data fields related to user activities, interests, characteristics, and/or the like, such as but not limited to: geographic visits (1149), as may be recorded by code scans; time (1151) associated with code scans; interest contacts (1153), such as may be reflect the user's interests and may be based on the context and/or associated content of scanned codes; gender, age, demographic, and/or other personal information (1155); and/or the like. Server data pulls (1157) may reference one or more data feeds to which the CTIS server has access in order to draw information that may be pertinent to marketer rules and/or Directions serving procedures. A wide variety of different types of feeds may be accessible, including but not limited to: global newsfeeds (1159), such as associated press wire services, weather information, sports scores, political and social events, financial market data, and/or the like; category sector feeds (1161), such as more specific and/or special interest news feeds; marketer specified feeds (1163); and/or the like. A marketer rule (1165) may be established by selecting one or more fields (1167) from the user profile data sets (1147) and/or the server data pulls (1157) and supplying associated parameters (1165) and/or parameter values associated with those fields. In the illustrated implementation, the rule associates a Petroleum Gazette field (1169) with a parameter specifying more than three oil articles read per day (1175). In addition, the rule associates a gas station visitation field (1171) with a parameter specifying more than three visits per week (1177). If both of these conditions are deemed true for a given CTIS user, then the CTIS may serve one or more Directions selected for and/or associated with the marketer rule. A price-per-impression (1179) may be charged for each time that the Directions are served to a user under the circumstances specified by the rule. In one implementation, a marketer may propose a price-per-impression when he or she creates the rule, which is then submitted to the CTIS and/or a CTIS administrator for approval. In another implementation, the CTIS may automatically generate a price-per-impression based on the rule and/or the marketer. For example, a fixed charge may be applied for each additional field and associated parameter added to the rule, as this refines the specificity with which the associated Directions will be served and increases the likelihood of transactional consummation. Once a rule is complete, it may be entered for storage and subsequent use in a marketer rules database (1181). It should be understood that the functionality described for this embodiment of the CTIS may be integrated or employed within any of the other CTIS embodiments described herein.

In one embodiment, the XML for the above marketer rule may take a form similar to the following:

<Rule>
<Rule_ID>123</Rule_ID>
<Rule_name> Oil Rule </Rule_name>
<Rule_owner> Directions R Us </Rule_owner>
<Condition1>
<Field1> Petroleum Gazette </Field1>
<Parameter1> 4 or more oil articles/day </Parameter1>
</Condition1>
<Condition2>
<Field2> Gas Station </Field2>
<Parameter2> 4 or more visits per week </Parameter2>
</Condition2>
< Directions_database> Hybrid car Dealership
Directions </ Directions_database>
<Price>
<Amount> $1.00 </Amount>
<Contingency> Impression </Contingency>
</Price>
</Rule>

In one implementation, the elements of FIG. 11a may form the basis of a user interface for marketer rule generation. A marketer and/or other CTIS user may be presented with lists of user profile data sets (1147) and server data pulls (1157) that may be dragged and dropped to the marketer rule box (1165) to generate a marketer rule. When the parameter values have been specified and the rule is complete, the user may click OK to submit the rule and/or drag and drop the rule to a marketer rules database icon (1181).

FIG. 11b shows an implementation of logic flow for generating a rule queue in one embodiment of CTIS operation. A rule is instantiated (1182), and the CTIS server checks parameter quanta associated with the rule (1183). A runtime quantum is discerned for the rule (1184) to determine the timing for applying the rule. The rule is subsequently parsed to generate the appropriate query structure (1185), and the cron schedule for the rule is established based on the runtime quantum (1186). The rule may then be pushed to the cron schedule queue (1187), and a determination made as to whether there are any additional new rules to process (1188).

FIG. 11c shows an implementation of logic flow for cron job queue management in one embodiment of CTIS operation. The CTIS may monitor the cron job queue and, for each queued cron job associated with a rule that is next in the queue (1189), the CTIS may determine whether or not it is time for that particular cron job to run (1190). If not, then the CTIS passes to the next cron job in the queue (1191). On the other hand, if it is time to run, then the appropriate databases specified in the rule are queried, and the particular cron job is dequeued (1192). If the results of the database query match the rule criteria so as to require serving a Directions impression to a user, then that match indication may be passed to Directions selection modules in order to choose a set of Directions to supply to the user. In one implementation, the marketer rule itself may uniquely determine a set of Directions to serve. In another implementation, the marketer rule may determine a set or class of Directions to serve, from which a unique set of Directions may then be randomly selected. In yet another implementation, as Directions may be selected from the marketer rule determined set or class of Directions based on a user profile.

It must be emphasized again that this is but a single, specific embodiment of the non-triggered Directions serving procedure intended for illustrative purposes. The procedure is highly flexible and can be finely tuned for the specific application at hand. Some other possible methods may include different relative weighting factors, alternative weighting considerations, categorical filtering, consideration of the number of provider zone breaches above the threshold level, graduated consideration of the distance from the provider location, modified provider zone shapes, pattern recognition algorithms, artificial intelligence facilitation, and/or the like.

### Virtual World Embodiments

In embodiments, a user profile is used to provide information querying and serving in a virtual world. Such virtual worlds may include, for example, massively multiplayer online games like The Sims Online, Everquest, World of Warcraft, Second Life, and/or the like. Information and/or advertisement providers may use a code triggered information server to serve context, demographic, and behavior targeted information to users in a virtual world. Users, in turn, trigger the provision of information by scanning or observing codes or information, or by making decisions within a virtual world such as attempting a mission within a game. The triggers, together with virtual world geographic, temporal, and user-specific information, are obtained by the server that receives, processes, and records the message. Based on these messages and a user profile—which may include continuously updated user-specific behavior information, situational and ambient information, an accumulated history of triggers, and integration with outside database information—the server selects information to serve to the user in a virtual world from an information base. For example, a user in Second Life who likes modern clothing for his/her avatar may be presented with ads on virtual billboards from advertisers of virtual in-game clothing stores that are near his/her virtual position. In another example, an advertisement tailored to a user's particular interests or behavioral patterns may be placed at a location within a virtual world that the user is known to routinely pass.

In one embodiment, the CTIS allows advertisers to supply product information in a virtual world to the consumers who would be most interested in such ads; this may be achieved by the CTIS selecting advertising content based on a combination of the context of the code that the consumer scanned, the consumer's stated interests as recorded in his or her user profile, the consumer's demographic profile, a decision made within a virtual world, situational information, and a record of scanned codes and/or virtual world decisions; these factors can be analyzed and employed by the CTIS for both user tracking and behavioral profiling/targeting. For example, a player in The Sims Online who frequently acquires new furniture for his/her virtual apartment and has a stated interest in modern art may be served advertisements for an actual furniture store that sells modern furniture and is near the user's geographic location following one such virtual furniture acquisition. In another example, a user in Second Life that likes modern clothing for his/her character may be presented with ads on virtual billboards from advertisers of virtual in-game clothing stores that are nearby the user's virtual position (or offer a virtual transportation link that will instantly move the user's avatar to the virtual in-game store).

The CTIS delivers targeted Directions to users in a virtual world while simultaneously providing detailed customer tracking information to Directions providers. The CTIS supplies Directions providers with greater precision and focus to provide consumers with the information that is most relevant to their interests, behavioral patterns, and space-time and/or virtual world trajectories to maximize the possibility of consummating a transaction. In one embodiment, the CTIS is designed to allow advertisers to place ads at virtual world locations at specific times of the day such as to increase the likelihood of garnering the attention of prospective customers. In another embodiment, the CTIS yields time and virtual world location resolved records of scans for the determination of coded advertisement visibility. In another embodiment, the CTIS provides rapid and evolving virtual world geographic and historical statistical profiling of user interest and coded advertisement quality. In another embodiment, the CTIS provides an expanded platform to supply large quantities of information and content with a minimal amount of publication space.

From the user point of view, the CTIS provides a mechanism by which, in exchange for officially registering interest and providing basic information, he/she can receive the most targeted solicitations, enhanced content, sales offers/coupons, and/or the like within a virtual world. User benefits include: relevant and targeted advertising; mobile context specific information; contiguous location and/or immediate event information; coupons and/or offers for many types of goods and services; and/or the like.

At the same time, the system grants the advertiser a powerful tracking tool, to monitor behavioral patterns of consumers on individual, demographic, temporal, and virtual world geographic scales. This allows, among other things, the deployment of anticipatory advertising: serving advertisements to users in anticipation of their locations and/or potential interests based on an accumulated history of user tracking data. Other Directions provider benefits include: compilation of highly specific customer tracking information, including customer virtual world trajectories; virtual world location and/or time specific advertising; highly flexible coded advertising placement; quick and updated determination of coded advertisement visibility; and/or the like.

Of benefit to both users and Directions providers is the fact that users improve the specificity of their Reply Messages with each successive scan, since each scan further refines the contents of the user profile. Users thus have a motivation to scan as many codes as possible related to subjects of interest and will thereby be exposed to more advertisements than in more traditional, passive advertising and marketing schemes.

Directions providers participate by contributing content to an Information Base that categorizes and labels that content under a number of considerations, such as subject matter, virtual world geographic and temporal identity, demographic specificity, and/or the like. Elements of the Information Base can then be compared via these labels with comparable labels found in a database of user profiles in order to match content with users via subject, virtual world location, time, demographic category, and/or the like. As such, the CTIS efficiently facilitates commerce by providing advertising to consumers with highly tailored specificity.

### Querying and Serving Information on the Internet

In an embodiment, the CITS delivers information on the internet based on user activities, such as may be registered by codes scanned by mobile devices or website links selected on a computer, as well as user characteristics and an accumulated history of user activities. For example, directions, information, and/or advertisement providers may use CTIS to serve context, demographic, and behavior targeted information to users on the internet. In particular, information and/or advertisements are served on the internet that is targeted to the individual based on the individual's characteristic profile, behavioral patterns, and present contextual surroundings, either in real space of cyberspace. For example, a web-based advertisement may be provided on an internet enabled mobile device for goods and services located near a mobile user, which advertisement is selected based on the user's behavioral patterns and stated interests.

In one embodiment, the CTIS allows advertisers to supply product information on websites to the consumers who would be most interested in such ads; this may be achieved by the CTIS selecting advertising content based on a combination of the context of the code that the consumer scanned or the web link that the user selected, the consumer's stated interests as recorded in his or her user profile, the consumer's demographic profile, situational information, and a record of scanned codes or web links; these factors can be analyzed and employed by the CTIS for both user tracking and behavioral profiling/targeting. For example, a user with a stated interest in running and a recent pattern of scanning codes related to shoes may be served a web-based advertisement on his/her internet-enabled mobile device for a new running shoe being sold at a nearby shoe store. In another example, a user profiled to be a teenager and having a pattern of browsing websites related to comic books may be served a web-based ad for the newest comic book themed movie when he/she visits a movie-listings website

Users, in turn, trigger the provision of information by scanning or observing codes or information, or by selecting web links. The triggers, together with geographic, temporal, and user-specific information, are obtained by the server that receives, processes, and records the message. Based on these messages and a user profile—which may include continuously updated user-specific behavior information, situational and ambient information, an accumulated history of trigger messages, and integration with outside database information—the server selects information to serve to a user on the internet from an information base.

For example, a user with a recorded history of interest in coffee products may be served an advertisement for a nearby coffee shop while browsing the web on his/her PDA. In one embodiment, information may also be served to users on the internet based solely on the user profiles, and without any initiating trigger. This is based on user trajectories or web-surfing habits deduced from the accumulated history of triggers. For example, a user known to routinely visit a music vendor website near the same time each day may be served an advertisement for the latest top-selling CD shortly before that time.

### Ambient Conditions and Impacts

In embodiments, ambient and/or other situational conditions that may be considered in selecting and targeting information include temperature, weather, light levels, UV levels, pollen count, humidity, air quality, prices of commodities and/or consumer goods, stock and/or financial index prices, global and/or local news events, internet activities, sports scores, entertainment news, security warnings, and/or the like. As such, this disclosure details a code triggered information server (CTIS) that delivers information based on user activities, such as may be registered by codes scanned by mobile devices, as well as user characteristics, an accumulated history of user activities (e.g., code scans), and ambient conditions. These ambient conditions may be a means for user product/service selection and subsequent utilization by tri-level mapping formulae or algorithms in directing a user, via their digital device, to a location or locations where products/services of interest can be found. For example, a user in the midst of high ambient temperatures who is profiled as a teenager who enjoys sweets and has a recorded history of scanning codes pertaining to fast food restaurants may be served an advertisement for the newest ice cream sundae product at a fast food restaurant near the user.

The user's code scans, together with geographic, temporal, and user-specific information, are obtained by the server that receives, processes, and records the message. Based on these messages and a user profile—which may include continuously updated user-specific behavior information, situational and ambient information, an accumulated history of scanned code messages, and integration with outside database information—the server selects information to serve to the users' mobile devices from an information base. In one embodiment, the code triggered information server allows advertisers to supply product information to the consumers who would be most interested in such ads; this may be achieved by the CTIS selecting advertising content based on a combination of the context of the code that the consumer scanned, the consumer's stated interests as recorded in his or her user profile, the consumer's demographic profile, situational information, and a record of scanned codes; these factors can be analyzed and employed by the CTIS for both user tracking and behavioral profiling/targeting.

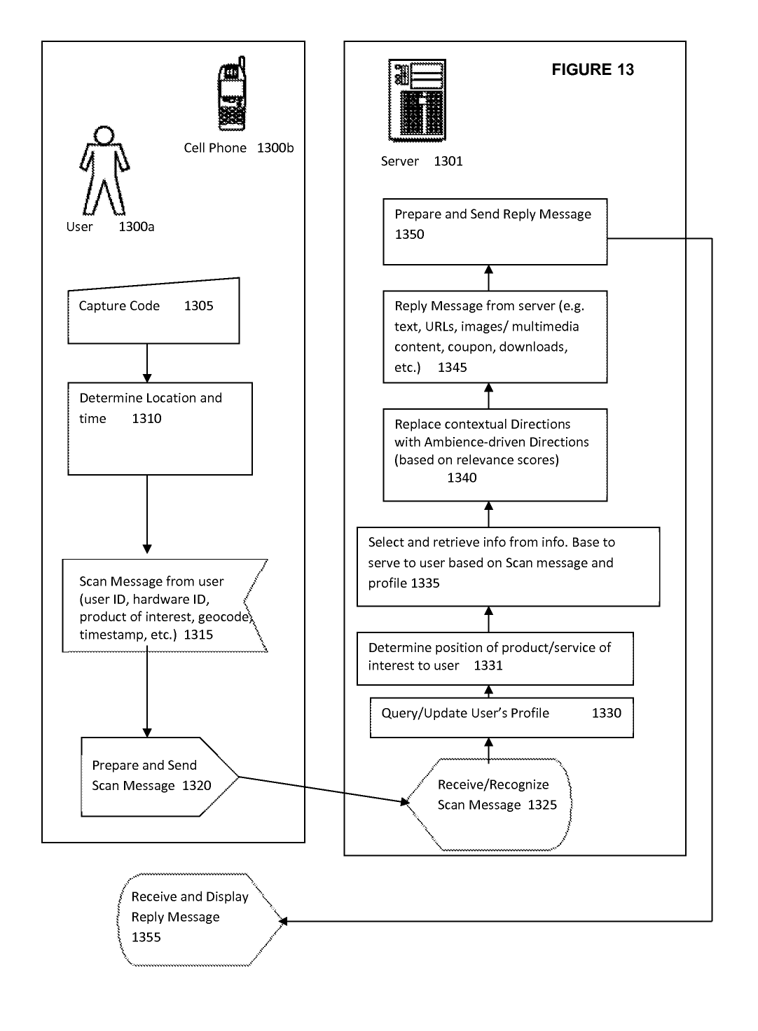

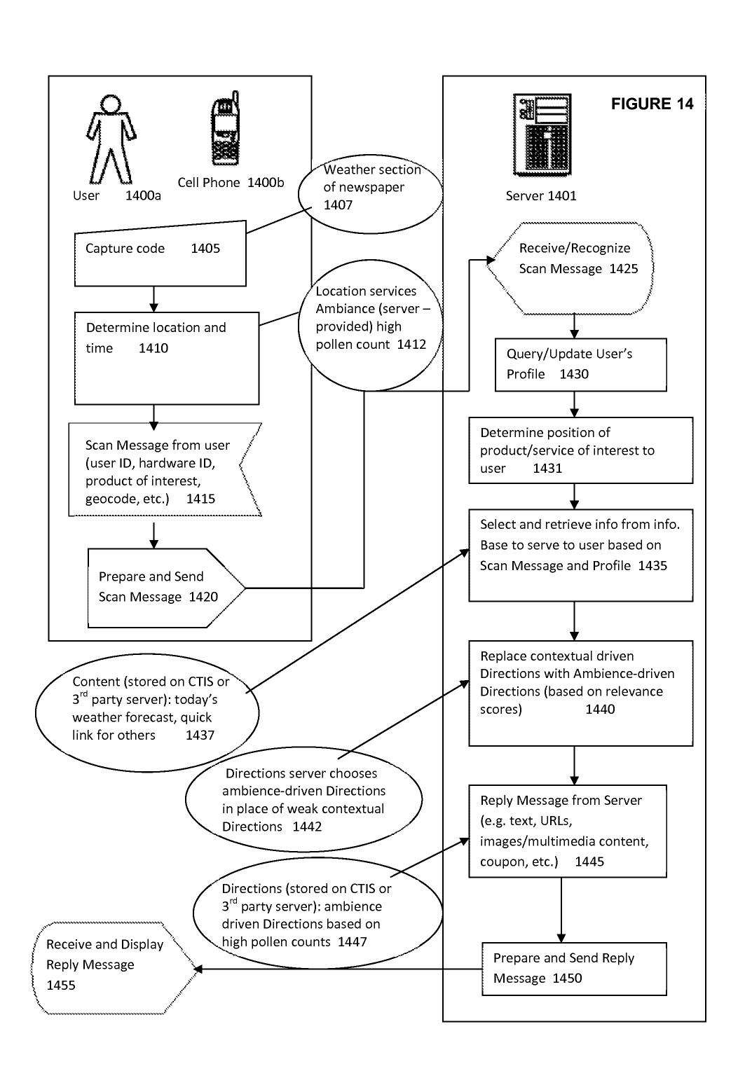

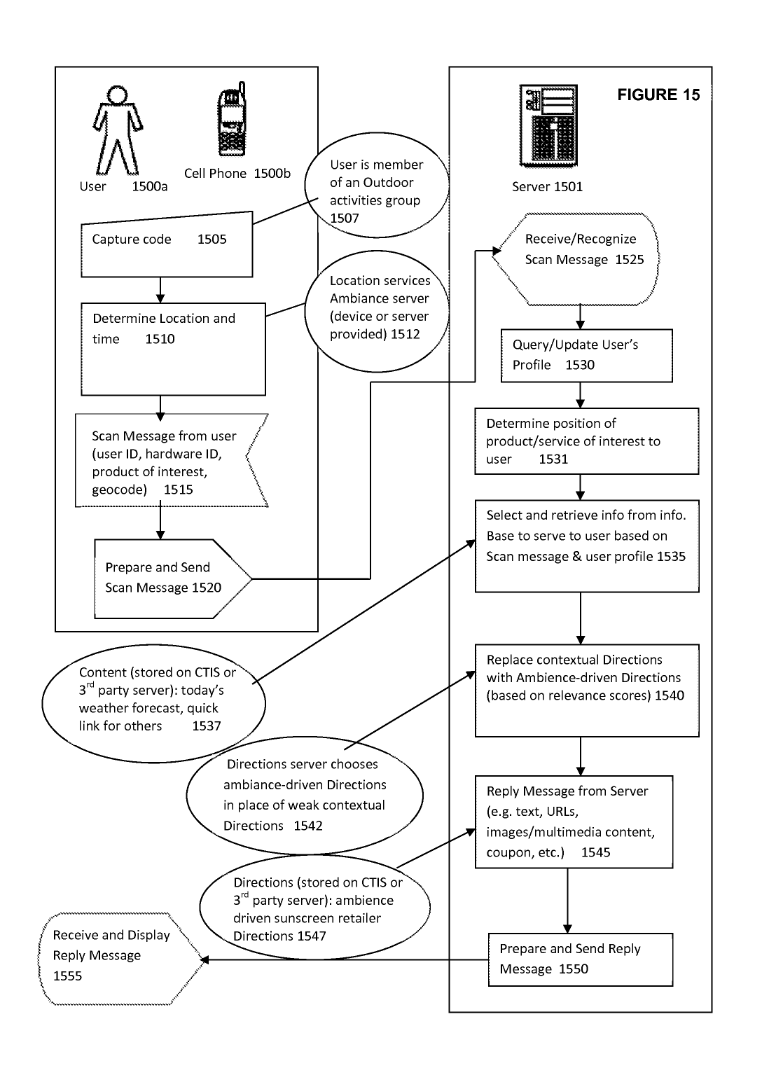

In another embodiment, the CTIS may serve Directions based on prevailing ambient conditions or climate at users' space-time positions. For example, this may occur when the relevance score for contextual Directions is low. An illustration of the logic and data flow in this embodiment is provided in FIG. 13, wherein the contextual Directions selected from the Information Base on the basis of code scan and user profile are supplanted in favor of Directions chosen on the basis of prevailing ambient conditions at 1340. Exemplary embodiments are provided in FIGS. 14-15. In FIG. 14, a set of Directions to a pharmacy selling allergy medication is provided 1447 in lieu of weak contextual Directions options 1442 in response to a code scan from the weather section of a media publication 1407 in conjunction with ambient weather information, including pollen count, queried at the server 1412. In FIG. 15, a set of Directions to a drug store selling sunscreen is provided 1547 in lieu of weak contextual Directions options 1542 in response to a code scan from the front page section of a media publication 1507 in conjunction with ambient weather information, including humidity and UV index, queried directly by the user's mobile device 1512. In various embodiments, certain ambient conditions such as UV levels, humidity, download/upload speeds, and/or the like may be detected by the user's mobile device itself, while in other embodiments, ambient conditions are separately supplied to a database used in conjunction with the CTIS.

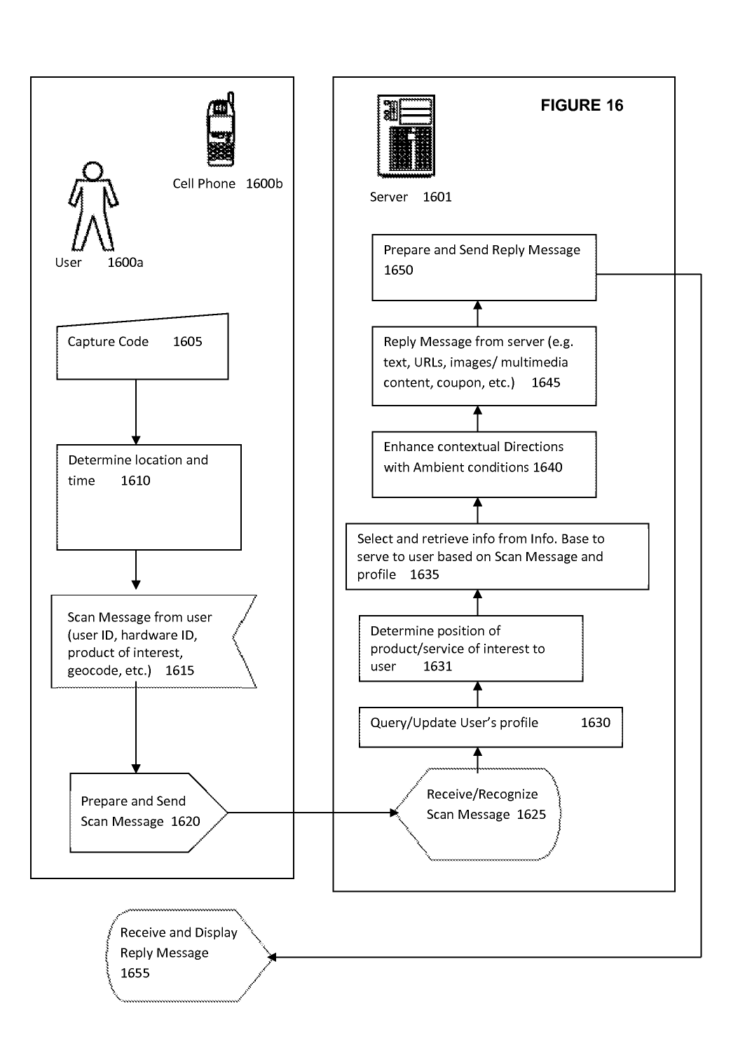

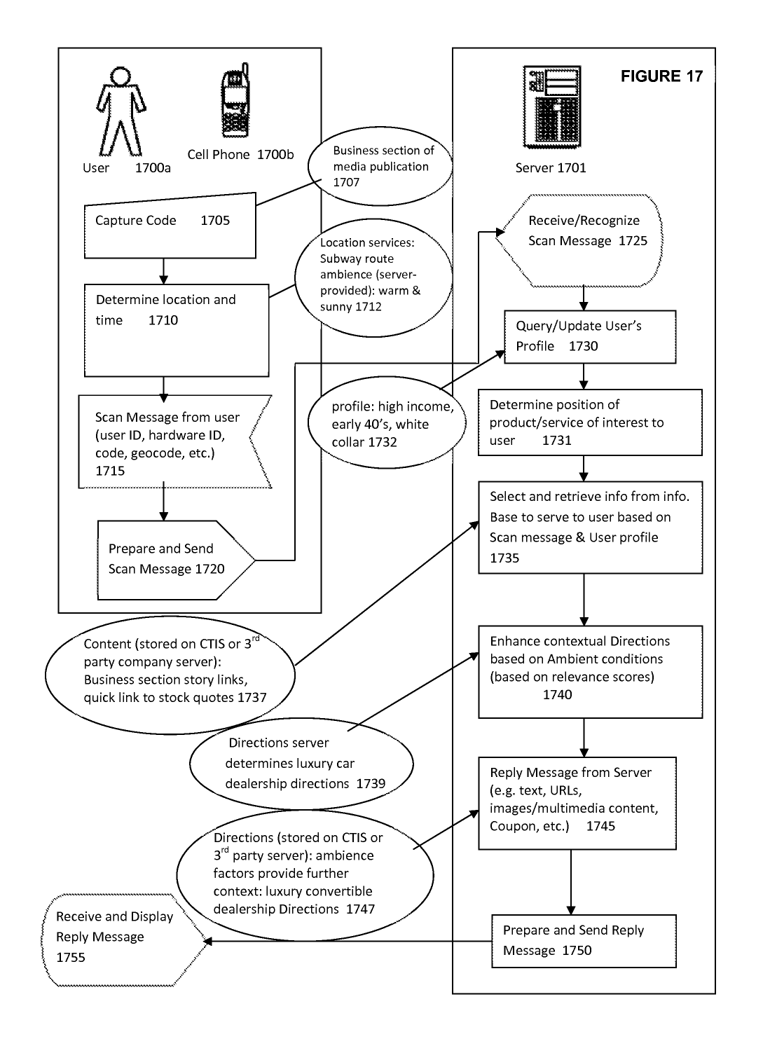

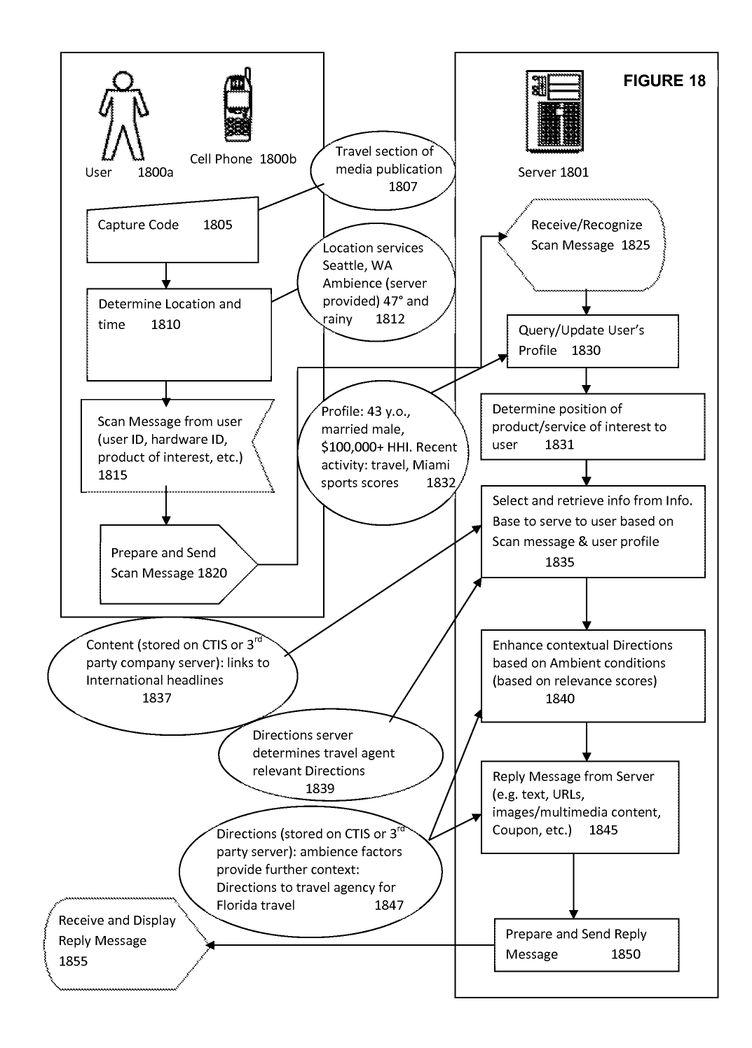

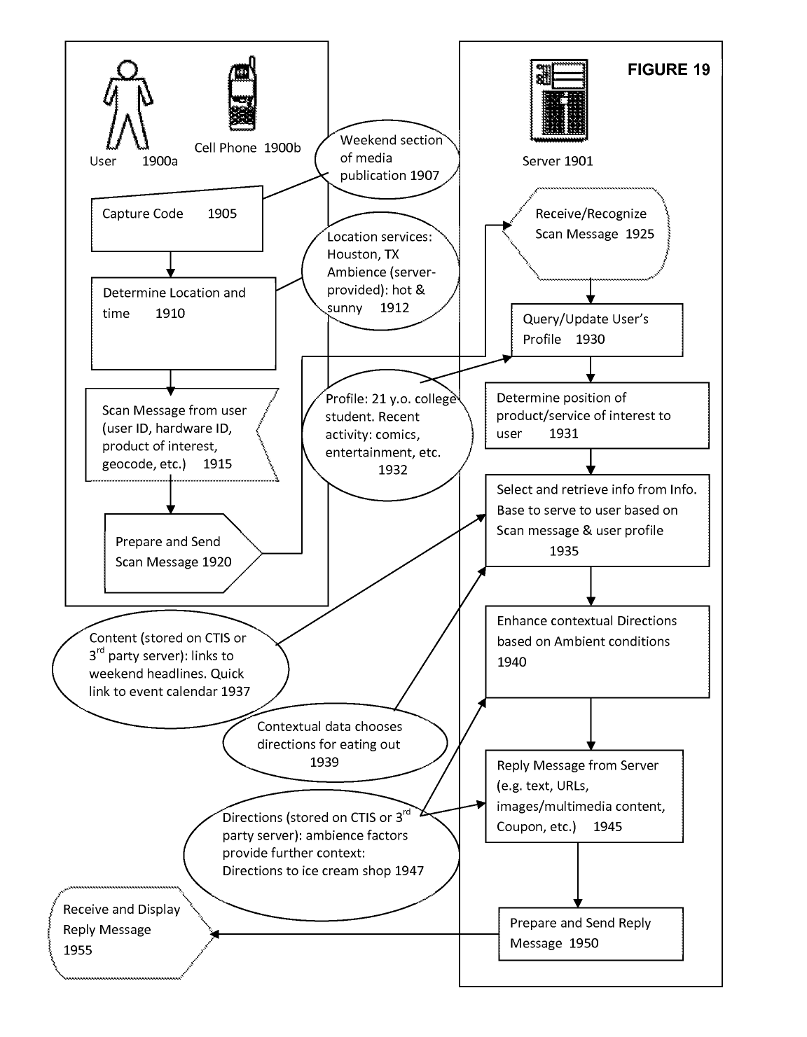

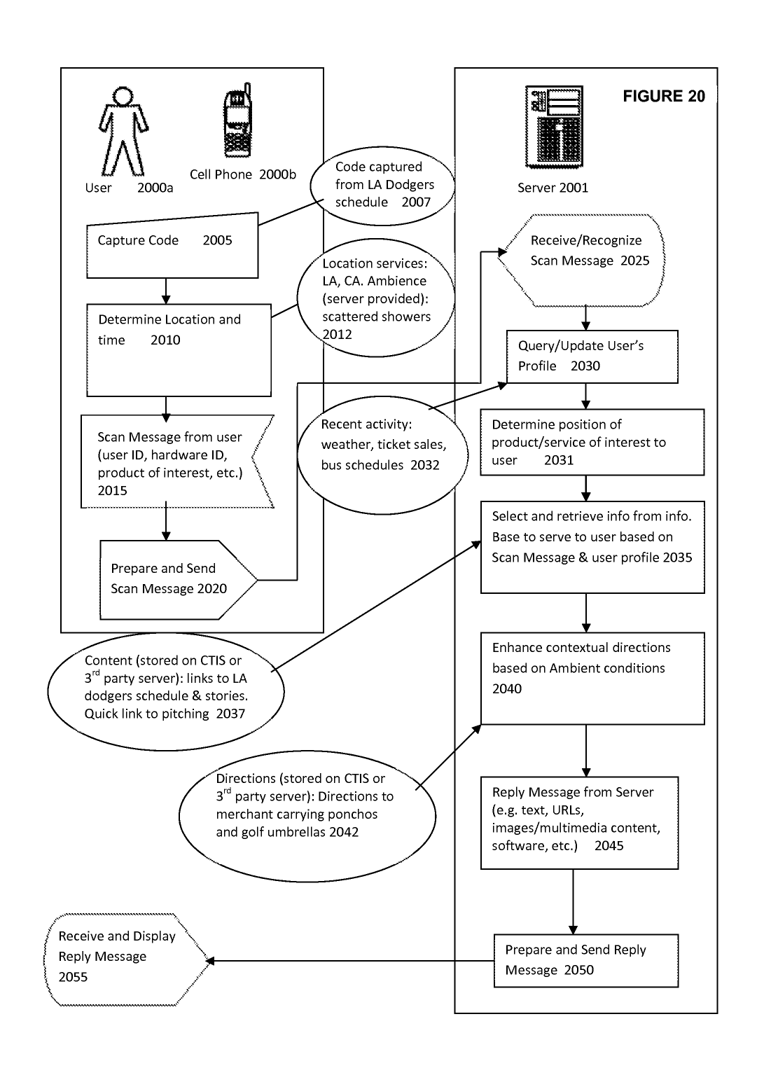

In another embodiment, the CTIS may serve contextual Directions with content enhanced by reference to prevailing ambient conditions. An illustration of the logic and data flow in this embodiment is provided in FIG. 16 wherein the contextual Directions selected from the information base at 1635 are further refined by the ambient condition information at 1640. Exemplary embodiments are provided in FIGS. 17-20. In FIG. 17, a code is scanned from the Business section of a media publication 1707 and the CTIS selects luxury car dealership Directions for display 1739 based on the scanned code, user location, and user profile 1732, and these Directions are further refined based on the ambient weather conditions provided to the server at 1712. In this case, warm and sunny weather provides further context to cause the CTIS to serve a set of Directions for a car dealership selling luxury convertibles 1747. In FIG. 18, a code is scanned from the Travel section of a media publication 1807 and the CTIS selects travel Directions for display 1839 based on the scanned code and user profile 1832, which includes recent scan code transactions pertaining to travel and Miami sports scores. The CTIS consequently queries the prevailing ambient weather conditions, comprised of cold and rainy weather, and supplies a set of Directions for travel agents providing Miami travel opportunities. In FIG. 19, a code is scanned from the Weekend section of a media publication 1907 and the CTIS selects a contextual set of Directions for eating out 1939 from the Information Base 1935 to serve based on the scanned code and the prevailing ambient weather conditions, which are hot and sunny 1912. This set of Directions is further refined by the user profile contents 1932 indicating a college student interested in comics and entertainment, and a set of Directions to an ice cream shop is finally supplied 1947. In FIG. 20, a code is scanned from a baseball team schedule within a media publication 2007. Based on the prevailing ambient weather conditions, including scattered showers 2012, the scanned code, and the recent activity in the user profile 2032, a set of Directions is supplied to a store carrying ponchos and golf umbrellas 2042.

In various embodiments, the CTIS may serve Directions based on a wide variety of different ambient and/or situational conditions that may be detected by the client mobile device, provided by internal or third party databases or information feeds, and/or the like. Some non-limiting examples of potential ambient and/or situational conditions that may be considered and/or employed in selecting information to serve are temperature, weather, light levels, UV levels, pollen count, humidity, air quality, prices of commodities and/or consumer goods, stock and/or financial index prices, global and/or local news events, internet activities, sports scores, entertainment news, security warnings, and/or the like. Consideration of such factors, by themselves or in conjunction with knowledge of a user such as may be gleaned from a user profile, may form the basis of information serving rules that have great specificity of targeting. For example, a marketer rule within the CTIS may specify that a set of Directions for participating bars that includes a coupon for a particular brand of beer be served to all male users between the ages of 21 and 40 with a history of scanning baseball-related codes within three hours of any time that the local baseball team wins a game. In another example, a marketer rule within the CTIS may specify that a set of Directions for dealerships selling hybrid vehicles be served to all mothers with young children who have a history of scanning codes in Time magazine whenever the local price of gasoline is greater than $2.50/gallon and they scan a code in an issue of Time that contains articles on both global warming and the Iraq War. Such hyper-targeted information serving, enabled by the CTIS, may prove very valuable to marketers and, in fact, to a wide variety of information dissemination applications. Advertisers may be able to purchase Directions time and/or impressions that are conditional on events, people, time, place, ambient conditions, and/or combinations thereof, and/or the like. Consequently, a premium may be charged to advertisers for each set of Directions served, and that premium may increase with the number of factors considered in serving the Directions (i.e., the degree to which the Directions serving is targeted). In another implementation, a different price may be charged per impression depending on the characteristics of the individual to which the Directions are served. For example, the hybrid car dealership Directions described above may cost an advertiser $0.75 for an impression to a mom with adult children but $1.00 for an impression to a mom with young children. Such graded pricing schemes may be specified within a marketing rule data structure.

### Information Querying and Serving on Mobile Devices Based on Profiles

In an embodiment, information querying and serving are triggered by codes that are scanned by a user. The information is selected based on the profile of the user. In an illustrative example, a user who is profiled as a teenager with a stated interest in comic books and a record of scanning codes related to movies may be served Directions for the latest comic book themed movie playing in the next hour near his/her present geographic position the next time he/she scans a code from the entertainment section of the newspaper.

### Anticipatory Information Querying and Serving on Mobile Devices Based on Profiles

In one embodiment, information may also be served to users based solely on the user profiles, and without any initiating code scan. This may be based on predicted space-time trajectories derived from the accumulated history of scanned codes.

The CTIS delivers information based on user activities, such as may be registered by codes scanned by mobile devices, as well as user characteristics and an accumulated history of user activities (e.g., code scans). The scans, together with geographic, temporal, and user-specific information, are obtained by the server that receives, processes, and records the message. Based on these messages and a user profile—which may include continuously updated user-specific behavior information, situational and ambient information, an accumulated history of scanned code messages, and integration with outside database information—the server selects information to serve to the users' mobile devices from an information base. In one embodiment, the code triggered information server allows advertisers to supply product information to the consumers who would be most interested in such ads; this may be achieved by the CTIS selecting advertising content based on a combination of the context of the code that the consumer scanned, the consumer's stated interests as recorded in his or her user profile, the consumer's demographic profile, situational information, and a record of scanned codes. These factors may be analyzed and employed by the CTIS for both user tracking and behavioral profiling/targeting. This information can then be supplied to a user based on anticipated user trajectories and/or interests, as may be determined from the record of scanned codes.

For example, the space-time trajectories of a user who has scanned barcodes in magazines using his/her cell phone over a period of time may be determined, and future likely trajectories determined. Then, advertisements could be served to the user based on where the user is expected to be at a given time, his/her demographic profile, his/her stated interests, and the types of advertisements or articles from which he/she has scanned codes in the past. As an illustrative example, a user may have a history of scanning codes related to fast food, a stated interest in sweets, and a project path passing near a particular fast food restaurant at a particular time. This user may be served an advertisement for the latest dessert product at that restaurant on his/her cell phone shortly before he/she is expected to pass the restaurant.

### Determining and Announcing Proximity Between Trajectories

The present disclosure is directed to apparatuses, methods and systems for determining and announcing proximity between trajectories. Existing schemes fail to take full advantage of the tracking and context targeting possibilities enabled by the present disclosure. In particular, they do not allow tracking and proximity notification that is targeted to the individual consumer's characteristic profile, behavioral patterns, and present contextual surroundings. As such, this disclosure details a code triggered information server (CTIS) that tracks users and notifies them of proximity with other users based on user activities, such as may be registered by codes scanned by mobile devices, web links selected on a computer, or decisions made in a virtual world. For example, a recorded history of scanned barcodes, as well as the time and location of each scan, may be analyzed to determine where a user has been and what they were interested in scanning at the time. Based on such a record, a prediction of a user's likely location may be made. Then, intersections or near-misses for such predicted trajectories between different users may be determined and reported. The CTIS may also incorporate user characteristics and interests.

As the first proximity notification system with geographic, context, and behavioral specificity based on user profiles, the CTIS is designed to analyze user behavioral patterns in order to statistically derive user trajectories and tracking information. In one embodiment, the CTIS is designed to compare expected user space-time trajectories to determine when two or more users are likely to be within a specified distance of each other at a given time. In another embodiment, the CTIS is designed to compare expected user web-surfing habits to determine when two or more users are likely to be on the same website, or within a specified number of links from each other, at a given time. In another embodiment, the CTIS is designed to compare expected user trajectories within a virtual world to determine when two or more users are likely to be within a specified virtual distance from each other within the virtual world. In another embodiment, the CTIS provides rapid and evolving geographic and historical statistical profiling of user activity.

### A Graphical Code-Serving Interface

In an embodiment, information is displayed in an electronic system by displaying a first visual token and animating the first visual token to reveal a second visual token comprising a coded symbol. The animation of the first visual token may be in response to a user action. In an embodiment, the user action is a selection response that uses a user pointer. The animation may include, for example rotating the first visual token to reveal a coding symbol on a proximate side of the first visual token.

The encoding symbologies for example, matrix codes, may be placed proximate to graphical elements in a wide variety of digital display contexts and media, including portable display devices, mp3 players, cell phones, digital paper, animated billboards, websites, internet or television broadcasts, software interfaces, and/or the like. Users may capture images of information encoding symbologies from such displays, for example using a cell phone camera, and decode them with software applets to receive additional information, multimedia content, offers, coupons, notifications, and/or the like.

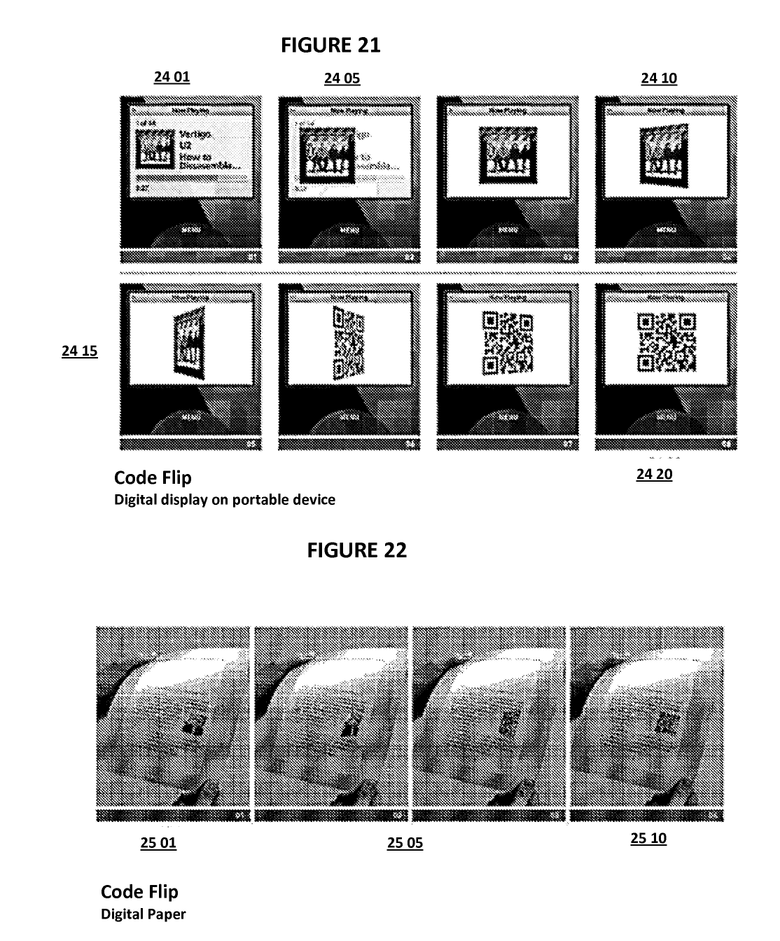

Serving codes to users may be accomplished by a variety of different means and in a variety of different contexts. FIGS. 21-23 illustrate some implementations of graphical code serving interfaces (GCSIs) in embodiments of the GCSI/CTIS system. In these implementations, a graphical display and/or interface initially presents a first visual token for display. This first visual token may comprise virtually any image, picture, drawing, emblem, icon, logo, animation, and/or the like. This first visual token may then be animated to reveal a second visual token comprising encoded information, such as a QR code, matrix code, bar code, and/or the like. Animation of the first visual token may, for example, comprise rotation of the first visual token to reveal the second visual token on a proximate side of the first visual token. For example, a two-dimensional picture in the graphical display may rotate in the third dimension to reveal a matrix code on the back of the picture. Other forms of animation may also be employed within different implementations. For example, the first visual token may dissolve, morph, disassemble and reassemble, and/or the like to reveal the second visual token. In some implementations, the animation of the first visual token to reveal the second visual token may occur only in response to some user interaction with the first visual token. For example, a computer screen may display a first visual token persistently until a user clicks on the first visual token with a mouse pointer, at which time the first visual token may rotate to reveal the second visual token on its back. In another example, an electronic billboard may persistently show an advertisement until a motion sensor detects someone walking by, at which time the advertisement dissolves to reveal a matrix code underneath. In still another example, an electronic sign may display a particular image until a detector coupled to the sign detects a signal and/or an authorization code from a compatible, portable electronic device near the detector, at which time the image may morph into a barcode. In still another example, the first visual token displayed on a touch-sensitive display may flip over to reveal a code when a user touches it with a finger or runs a finger over it to simulate a flipping motion.

FIG. 21 shows an implementation of a user interface manifesting GCSI/CTIS functionality on a portable electronic device in one embodiment of GCSI/CTIS operation. A wide variety of different portable devices may execute and/or coordinate with GCSI/CTIS functionality, such as but not limited to portable media players, cellular telephones, BlackBerries, PDAs, and/or the like. In the illustrated implementation, a portable media player displays album information, including an image of the album cover, on a graphical display, where the displayed information corresponds to music being played on the player 2401. A user may click on or otherwise select the album cover image, causing it to increase in size 2405 and rotate 2410-2415 to reveal a matrix code on the image 2420.

FIG. 22 shows an implementation of a user interface manifesting GCSI/CTIS functionality on digital paper in one embodiment of GCSI/CTIS operation. Here, an image is included in one area of an article displayed on the paper 2501. Either by itself or in response to some user action, the image flips 2505 to reveal the code on its other side 2510.

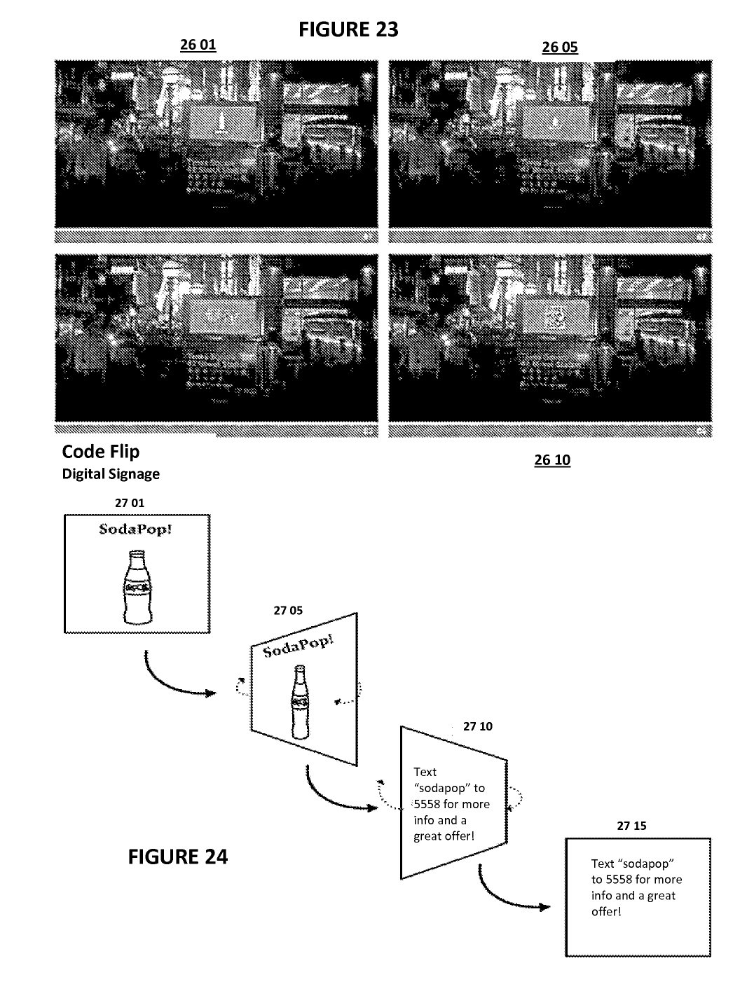

FIG. 23 shows an implementation of a user interface manifesting GCSI functionality on a digital billboard in one embodiment of GCSI/CTIS operation. A public, electronic billboard display shows an advertisement comprising a product logo 2601. The product logo rotates 2605 to reveal a matrix code on its opposite side 2610. Flipping of the logo may occur periodically or aperiodically, upon detection of a nearby viewer, upon detection of a portable device capable of decoding the matrix code, and/or the like.

### Code-Mediated Content Delivery Platform

Embodiments are directed to apparatuses, methods, and systems for a code-mediated content delivery platform comprising a Graphical Code-Serving Interface and a Code Triggered Information Server (“GCSI/CTIS”). The GCSI/CTIS connects information encoding symbologies, and by proxy the underlying information content, to graphical display elements and facilitates generation of encoding symbologies, error-correction, media sampling and purchasing, social networking, and sales promotion programs.

In an embodiment, active display elements provide access to information, particularly information that is targeted to an individual's profile, interests, and/or contextual surroundings and that is portable and/or made available in unexpected physical locations. The active display elements facilitate the serving of such information via placement of information encoding symbologies, such as matrix codes, proximate to graphical elements in a wide variety of digital display contexts and media, including portable display devices, mp3 players, cell phones, digital paper, animated billboards, websites, internet or television broadcasts, software interfaces, and/or the like. Users may capture images of information encoding symbologies from such displays, for example using a cell phone camera, and decode them with software applets to receive additional directions, information, multimedia content, offers, coupons, notifications, and/or the like.

In one embodiment, a code sent via a communications network from a mobile communications device from a user is received. The code is based on a scan of an optically-readable coding symbol. A code database is queried to discern a multimedia content data identifier corresponding to the received code. Multimedia content data is retrieved from a multimedia database based on the multimedia content data identifier. A sample of the multimedia content data is sent to the mobile communications device via a communications network. A sample acceptability message is received from the user. The multimedia content data is sent to a data repository associated with the user provided that the sample acceptability message indicates that the user wishes to receive the multimedia content data.

In another embodiment, an alphanumeric string comprising a plurality of characters and representing a location of multimedia content data is received from a first data source. Each of the plurality of characters of the alphanumeric string is converted into a corresponding binary number to yield a plurality of binary numbers based on a character correspondence table. The plurality of binary numbers are concatenated to yield a bitwise array. An optically-readable encoding symbol comprising a plurality of disconnected solid shapes is drawn in which the presence of a solid shape at a position in the symbol indicates presence of a 1 in a corresponding position of the bitwise array.

In another embodiment, an incomplete code associated with an optically-readable encoding symbol is received. A code database is queried based on the incomplete code to determine a plurality of possible matching codes. The code records associated with the plurality of possible matching codes are queried to retrieve code presentation conditions associated with each of the plurality of possible matching codes. A plurality of code repair schemes are retrieved from a code repair database based on code presentation conditions. Each of the plurality of code repair schemes are applied to the incomplete code to yield a plurality of repaired codes. A repaired code is selected from the plurality of repaired codes based on at least one pre-designated code fidelity rule. The repaired code is designated as a correct code corresponding to the optically-readable encoding symbol.

In another embodiment, a scan indicator comprising an indication that a user has scanned an optically-readable encoding symbol with a mobile scanning device is received. The optically-readable encoding symbol is associated with a good or service. A retailer at which the user scanned the optically-readable encoding symbol is identified. A retailer record is queried to determine whether the retailer is subscribed to a sales promotion program. The retailer is charged a first retailer fee based on the received scan indicator if the retailer is subscribed.

In another embodiment, an online social network is provided. A user identifier is received and stored. User profile information is received and stored in association with the user identifier. A plurality of user scan indicators indicating that a user has scanned a plurality of optically-readable encoding symbols are received. The plurality of user scan indicators are stored in association with the user identifier. At least one friend designation indicating an association with at least one other user is received and stored in association with the user profile.

Users may scan codes found in media publications, on billboards or signs, on consumer products or packages, on websites or television screens, on movie screens, on clothing or accessories, on mobile device displays, and/or the like.

In an alternative implementation, content associated with a captured code or other user interest registration may be sent to a data repository other than a user's mobile device. For example, a user may scan a code corresponding to media content. Rather than triggering the GCSI/CTIS to send the media content to the mobile device with which the code was scanned, the code scan may trigger the GCSI/CTIS to send the media content to a user's computer, an online data repository, and/or the like for storage and later retrieval by the user. For example, the GCSI/CTIS may discern a user identity from the Scan Message (115), query user access and/or authorization information, and use that access and/or authorization information to access an online data repository corresponding to the user to store requested media content thereon for later retrieval and/or use by the user.

FIG. 5d shows an implementation of logic flow for customized repair and/or decoding of obscure or ambiguous scanned codes. An ambiguous code may be received at a GCSI/CTIS system at 581, such as may be sent via a communications network from a user's mobile scanning device. In one implementation, a scanned code may be qualified as an ambiguous code if an attempt to decode the code does not yield a single result. In one implementation, the system may also receive code scanning conditions 582 describing any of a variety of circumstances of the code scan which may affect the quality and/or fidelity of the scanned code. For example, some relevant circumstances may include the time of day, light levels, use of flash, mobile scanning device type and/or characteristics, code size, contrast, brightness, sharpness, skew, rotation, and/or the like. The ambiguous code and scan conditions may then be passed to a repair queue 583, whereby the system may analyze the ambiguous code and attempt to discern the correct decoded content. A plurality of possible matching codes are determined at 584, and a code database is queried at 585 to extract code presentation conditions corresponding to each of the plurality of matching codes. Code presentation conditions may describe how and where the code was displayed and may comprise a wide variety of factors, such as but not limited to medium (e.g., newspaper, glossy paper, product packaging, television display, website, billboard, and/or the like), likely obscuring factors (e.g., glass covering, tears, distance, and/or the like), and/or the like. The GCSI/CTIS system may then generate a code repair database query based on the presentation conditions and/or scan conditions 586 and query the repair database to extract repair schemes corresponding to the particular presentation and/or scan conditions. For example, a particular code repair scheme may be tailored for and/or correspond to codes displayed on billboards that are scanned after dark by Nokia mobile phones. Extracted repair schemes corresponding to each of the possible matching codes are applied to the ambiguous code at 588, and a determination is made at 589 as to whether any one of the possible matches is now more likely to be correct than the others. This determination may be made, for example, by measuring the fidelity of codes with various repair schemes applied and selecting as the correct code that which has the highest resulting fidelity. If no remaining ambiguity exists as to the correct code, then the favored code is registered with the GCSI/CTIS system at 592. Otherwise, the GCSI/CTIS may generate a custom recommendation message 590 and send the message to a user and/or a user's mobile device 591. The custom message may, for example, provide tailored recommendations on how the user may improve the fidelity of the code scan based on the possible matching codes and the associated presentation conditions and/or scan conditions. Tailored recommendations, as well as the repair schemes themselves, may be adjusted based on feedback received from users about which codes they were actually trying to scan. In one implementation, the GCSI/CTIS may provide a query message to a user presenting a summary of content associated with alternative matching codes in order to determine which content the user was actually trying to access. It should be noted that code analysis and/or repair may be undertaken on a code image level, alphanumeric string level, binary string level, and/or the like basis. Combinations of such bases may also be undertaken, such as by first analyzing the ambiguous code in its alphanumeric string form and then, if ambiguity remains, analyzing the code in its binary form. Further discussion on such an analysis is provided below.

In an illustrative example of partial decoding, a given matrix code may encode the string ABC123. In multiple processes, it may be determined that the code contains A_{—}1_{—}3 (where the blanks represent unknown values), _C1_, and AB_.

Through these multiple processes, the GCSI/CTIS system now knows that the code contains ABC1_{—}3 and may check this against codes in a code database to determine how many matches exist. If it finds two matching codes (e.g., ABC123 and ABC143), it may consider ancillary factors, including code presentation and/or code scan conditions, user profile information, and/or the like. For example, ABC123 may correspond to an advertisement for a new action movie while ABC143 corresponds to a coupon for women's cosmetics. If the user supplying the code is determined, based on a supplied user ID, to be a man with a history of scanning movie-related codes, then the GCSI/CTIS system may infer that ABC123 is the matching code and serve the corresponding content. In one implementation, the GCSI/CTIS server may further supply a confirmation request for partially matched codes, requesting the user to affirm or deny that the supplied content is, in fact, the content that he or she was seeking.

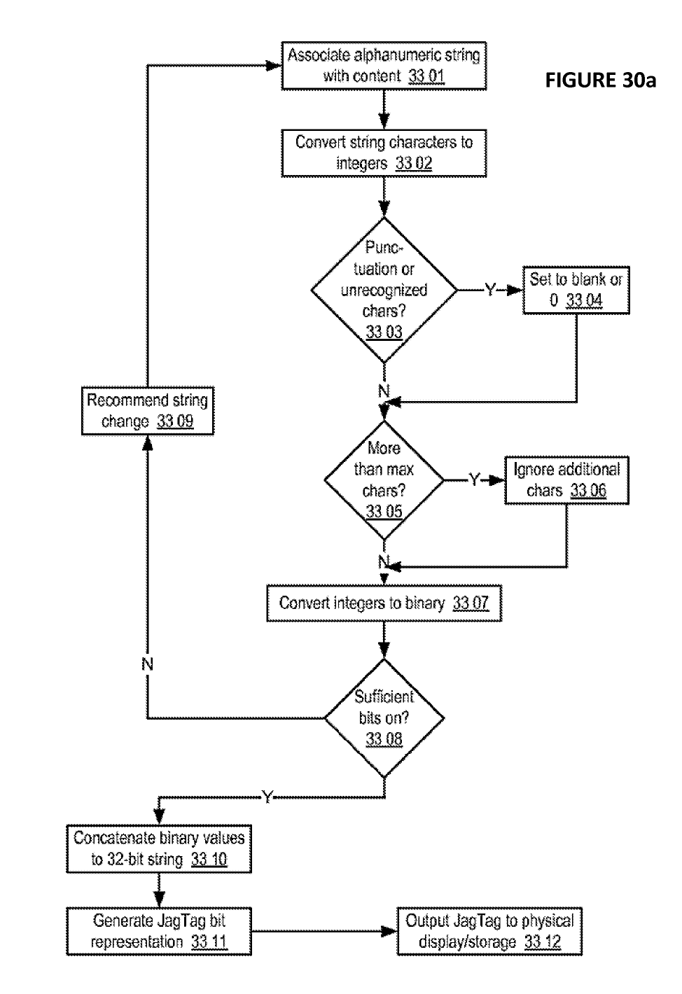

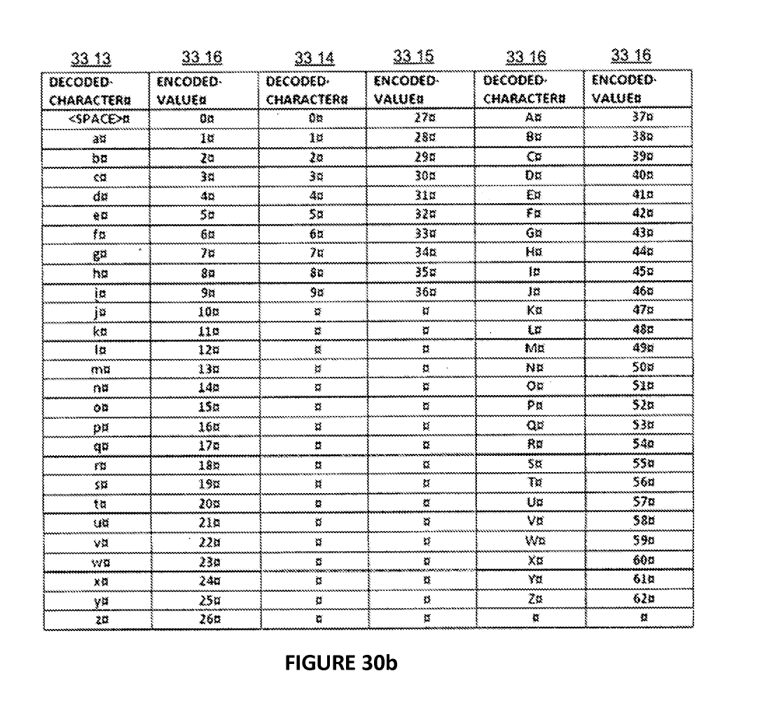

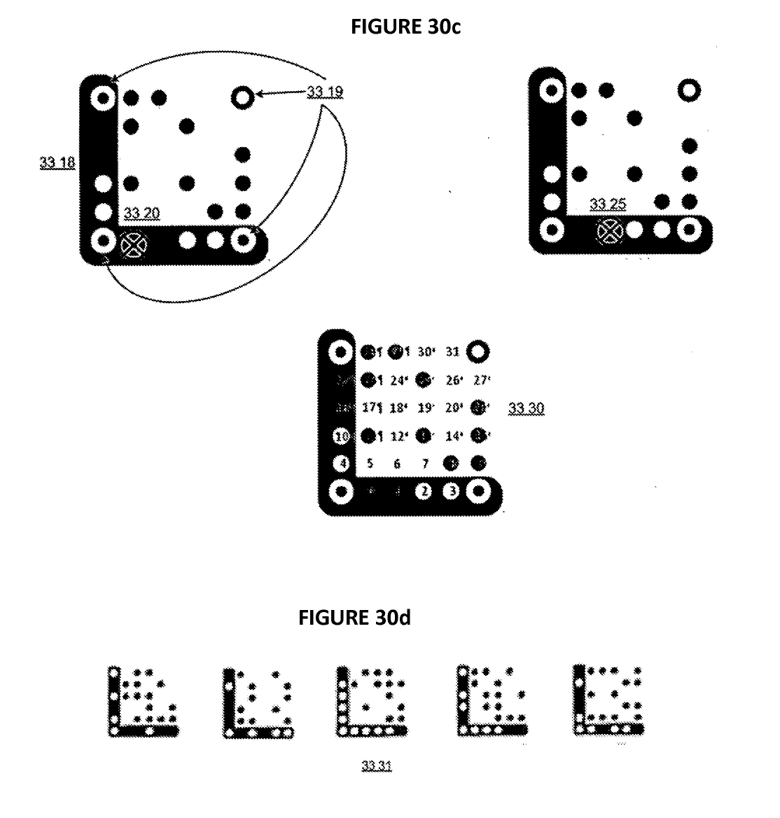

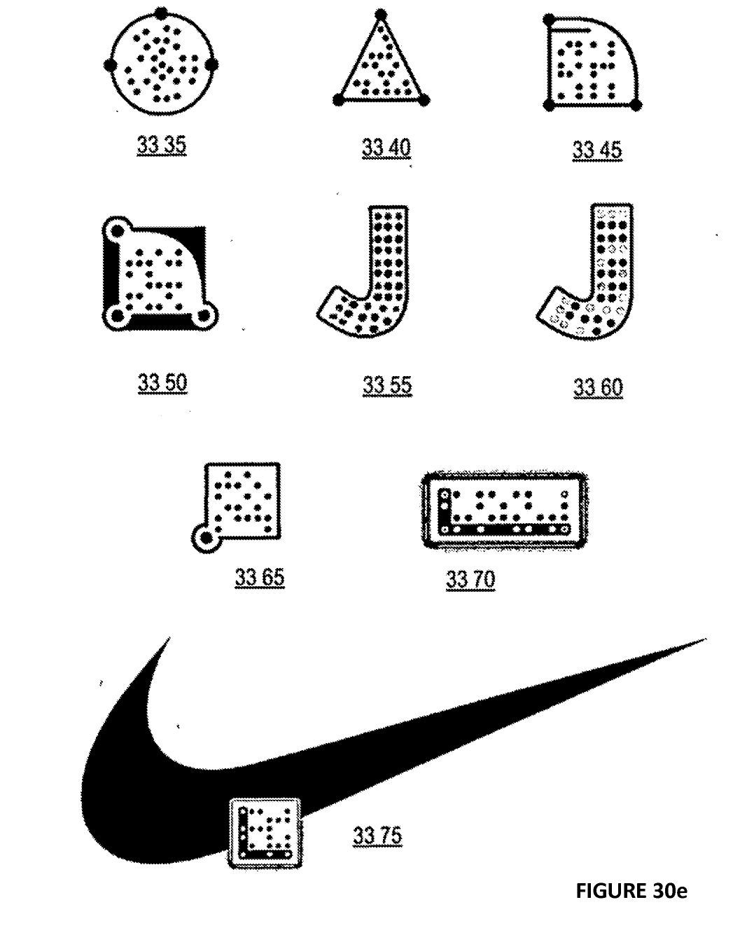

In one implementation, analysis of ambiguous codes may comprise a two-stage process. In a first stage, an encoded string comprising a number of alphanumeric characters, one or more of which may be unclear, may be compared to a database of alphanumeric strings to determine which, if any, match. In one implementation, a Levenshtein distance metric may be employed to determine the similarity of an input string to strings existing in the database. In one implementation, the input string may only be compared against “live” strings in the database (i.e., strings that are currently engaged in active use and/or tied to actual content). If ambiguity remains about which code has been scanned after this character-based analysis, a GCSI/CTIS system may apply a second stage of analysis, whereby the input alphanumeric string is converted into a corresponding binary bitset array (see, e.g., FIGS. 30a-b and associated discussion below) and a comparison is performed between binary values of the input string and the strings stored in the code database. The most significant bits come first in the bitset array while the least significant bits come last, so priority weighting may be applied against potential value matches based on which bits match between the input and stored strings.

### User Interface

FIG. 7b shows an implementation of a user profile user interface in one embodiment of GCSI/CTIS operation. The profile page 760 may include a display of basic user information 763 and/or a user picture 766, and may provide a wide variety of other user information, including demographic information, interests, media libraries, friend lists, code scanning activities, and/or the like. The displayed implementation further includes a plurality of tabs 769 allowing the user to view profile information, edit his or her profile, view photos, groups to which the user may belong, and/or edit settings, including sharing and/or privacy settings 772. Privacy settings may, for example, control access of other individuals to a user's personal information, code scanning activity, and/or the like. In some implementations, certain information about a user, in particular regarding codes that a user has scanned and/or the content associated with those scans, may be shared with other users. For example, a user may be able to inquire, via a GCSI/CTIS affiliated system, as to what codes have been recently scanned by other users that are within a particular geographic radius of the user. In another example, a user scanning a code to receive a song may also be provided with information about the code scanning activities of other users whose codes also corresponded to songs.

In one implementation, a user may be allowed to restrict which information of theirs is sent to other users and/or to restrict which information of other users is sent to them. For example, a user may have a “friends” list that has a different level of access than the general public.

In one implementation, a user may have a personal code that is associated with the user and/or a user profile. In one implementation, other users can scan the personal code to automatically join the first user's friend list. In another implementation, a personal code my comprise a short-link to the user's profile 760, and/or to other profile pages or webpages associated with the user, such as a Facebook page, Myspace page, and/or the like. In one implementation, the user can set a forwarding instruction on his or her GCSI/CTIS page to forward inquiries corresponding to scans of the user's personal code to another page. In another implementation, the user may provide the personal code on other pages as a link back to the user's GCSI/CTIS profile page.

In one implementation, a user may be provided recommendations in response to a code scan. For example, the user may scan a code corresponding to a particular song by a particular musical artist. The user may then be provided a listing of other songs, artists, and/or the like having codes recently scanned by the members of the user's friends list and/or that may be further related to the song and/or artist whose code the user scanned.

In one implementation, a user's code scans may be integrated with an instant messaging, blogging, micro-blogging, and/or the like service, whereby the user's code scans are automatically rendered as descriptive summaries and displayed to other users, such as on a webpage, via SMS text messages, emails, and/or the like. For example, each code scan may have a pre-set text description associated therewith that, upon scanning of the code, is displayed on a user's Twitter.com page. In one implementation, a user may receive an incentive payment for particular types of content that are provided to the user's friends, associates, blog subscribers, and/or the like as a result of the user's code scans. For example, a reward may be provided to the user every time the user scans a code corresponding to a particular brand of products and a message associated with those products is supplied to subscribers to the user's profile and/or blog. A further reward may be provided to the user if it can be determined that one of the user's associates made a purchase based on the provided message.

The privacy settings in the displayed implementation include permissions for displaying “tweets,” songs, videos, and purchases 775 associated with the user's code scans to various security levels for other people 778, including the general public, private/friends, and “snaps” (i.e., those who may have scanned a user's personal code and/or a code corresponding to the user's profile). Selection of a particular privacy setting may generate a sharing rule that is stored in association with the user and consulted each time a user scans a code corresponding to one of the categories shown at 775 to determine whether or not code-associated information should be provided and/or sent to any of the categories of people shown at 778.

The profile page 760 further includes a field 779 wherein a user may specify the location of a data storage facility to which some or all media and/or other content that the user acquires via code scans are to be sent and/or stored. For example, the user may specify an online storage facility (e.g., Apple's iDisk service) in which the user's code scan-acquired content is to be stored.

The profile page 760 further includes interface components configured to generate a personal code, in this case a JagTag 780. Selection of the button at 780 causes the GCSI/CTIS system to associate a code with the user and/or the user's profile and generate a corresponding code, which is displayed for the user. The user may then elect to save an image of the code to his or her computer desktop, send the code in an email, send the code in an MMS message, and/or the like via the interface elements at 781.

In one implementation, coupons may be supplied to a user's mobile device with digital rights management (DRM) software included to prevent or discourage coupon copying, sharing, and/or the like. In another implementation, no DRM software is included with the coupon.

In one implementation, a GCSI/CTIS server may query, store, and/or consider data pertaining to media demographics associated with a particular medium in which a code is published; the subject content associated with a code; the type of information requested by scanning a code; and/or the like. For example, a user scanning a code associated with a product review for a hybrid sports utility vehicle (SUV) in a men's magazine may trigger a GCSI/CTIS system to draw and/or analyze data pertaining to media demographics associated with the men's magazine, subject content associated with hybrid vehicles (i.e., environmentally conscious consumers), subject content associated with SUVs (i.e., outdoor activity or families), and product reviews. Thus, the GCSI/CTIS may be configured to consider both the subject of a user's inquiry, the source of the inquiry, the type of inquiry, and/or the like.

In another embodiment, the GCSI/CTIS may allow users to instantly subscribe to and/or enroll in services, loyalty programs, discount programs, and/or the like by scanning codes associated therewith. For example, a user may subscribe to receive weather updates by scanning a weather-linked code. In another example, a user may enroll in a brand-affiliated coupon program by scanning a code associated with that program. Selection of a subscription and/or enrollment code may cause the GCSI/CTIS to submit a user's personal information to an integrated subsystem and/or third-party system for subscription registration. In some implementations, the GCSI/CTIS may require verification from the user, separate from the code scan itself that the user wishes to enroll and/or subscribe to the associated service. In some implementations, a user may submit trigger specifications and/or conditions for enrolled service notifications. For example, a user may specify that he or she only wishes to receive weather updates associated with heavy rain or thunderstorms. In another example, a user may specify that he or she only wishes to receive coupons for products from a particular grocery store and not from other grocery stores. Scanning of a code associated with a subscription program wherein specification of triggers and/or conditions is permitted may cause a GCSI/CTIS system to retrieve and display a user interface screen to the user that is tailored to the particular subscription and/or enrollment service and configured to receive trigger and/or condition specifications.

In another embodiment, the GCSI/CTIS may be configured to track and/or implement a rewards program. For example, in a single-tiered rewards program implementation, a user may scan a code every time he or she purchases a particular item (e.g., a sandwich from the local sandwich shop) in order to register each purchase and store a record thereof in association with the user. The user may then receive a discount, free item, and/or the like after a pre-designated number of purchases and associated scans are registered, after which the record of scans is reset to start anew. In another example, in a multi-tiered rewards program implementation, a user may continue to register additional purchases and associated code scans to receive larger and/or more significant benefits, discounts, and/or the like.

In another embodiment, the GCSI/CTIS may be configured to implement contests and/or prize awards. For example, a user may enroll in a contest by scanning a code associated with the contest, causing personal information, user identifiers, and/or the like to be submitted to a contest subsystem. Such contests may comprise instant-win and/or other types of lotteries, auctions, raffles, and/or the like and/or may enroll the user in a contest program through which they may receive further instructions, possibly including additional codes for scanning, in the future.

In another embodiment, the GCSI/CTIS may be configured as a voting facility. A user may register a vote for a particular candidate, ballot initiative, viewpoint, survey result, and/or anything else for which a vote may be registered by scanning a code associated with the user's choice. In one implementation, a user identifier may be discerned and submitted with the vote in order to prevent repeat voting, to correlate with voter registration, and/or the like. In one implementation, voter identifying information may be stripped from a scan message prior to the message being provided to particular agencies or individuals, in order to preserve a secret-ballot style of voting.

In another embodiment, the GCSI/CTIS may be configured as a facility to effectuate purchases of goods and/or services. By scanning a code associated with a particular good or service, a message may be sent to a GCSI/CTIS system identifying the good or service associated with the code as well as identifying the user, such as based on a mobile device identifier. The GCSI/CTIS system may then automatically generate a bill for the user, charge a specified credit account, deduct a payment from a debit account, and/or the like to effectuate payment for the good or service. In one implementation, the GCSI/CTIS may return a payment confirmation, such as to the user's mobile device and/or a retailer's point-of-sale device to confirm that the user has provided adequate payment.

In another embodiment, the GCSI/CTIS may be configured to facilitate communications. For example, a code may correspond to a particular telephone number, IP address, and/or the like. Scanning of the code by a communications-enabled mobile device may cause the mobile device to automatically establish a connection with the address to which the code corresponds. In one implementation, the connection may be established directly by an on-board applet loaded on the mobile device. In another implementation, the connection may be established by an instruction sent to the mobile device by a GCSI/CTIS subsystem in response to a received code scan.

FIG. 24 shows an implementation of a user interface manifesting GCSI/CTIS functionality for serving an SMS text message prompt in one embodiment of GCSI/CTIS operation. A first visual token 2701 shows an image and text, such as may correspond to an advertisement, logo, and/or the like. The token may appear in a wide variety of contexts, such as on a website, in a virtual world, on a cell phone or other portable communications and/or media device (e.g., Blackberry, iPhone, iPod, and/or the like), on an electronic billboard, on broadcast television or recorded video content, and/or the like. The first visual token may be animated, such as by flipping, rotating, revolving, and/or the like (2705, 2710), to reveal encoded content on a proximate side thereof. In the implementation illustrated in FIG. 24, a message appears along with an SMS code that a user may key in to an SMS enabled communication device to receive associated content. In alternative implementations, other types of codes and/or code communication protocols may be displayed and/or employed for communication with GCSI/CTIS systems, such as but not limited to: MMS, instant messaging, web browser based messaging, email, Enhanced Messaging System (EMS), TCP/IP, WAP, and/or the like. For example, a first visual token may be animated to reveal an email address, website address, instant message nickname, and/or the like on a proximate side to enable a user to connect to and/or communicate with a GCSI/CTIS system and/or affiliated entity for the receipt of information, coupons, offers, advertisements, media, and/or the like.

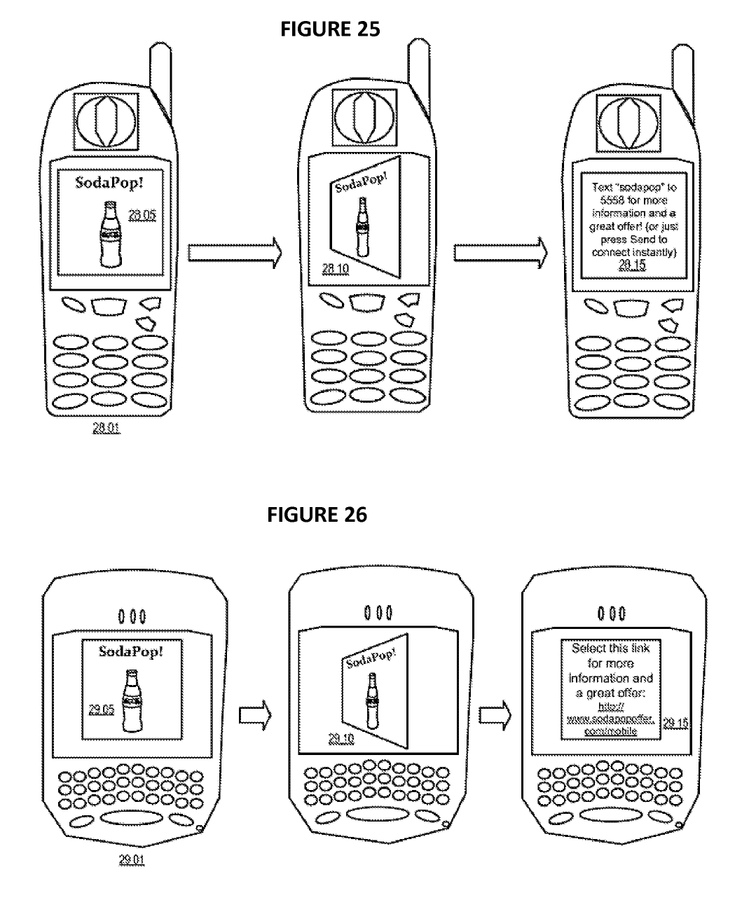

FIG. 25 shows an implementation of a user interface manifesting GCSI/CTIS functionality on a mobile phone 2801 in one embodiment of GCSI/CTIS operation. A first visual token comprising an image, advertisement, logo, and/or the like 2805 is displayed on a mobile phone display screen. The first visual token may be animated 2810, such as in response to a user interaction (e.g., pressing a button on the mobile telephone, clicking on the first visual token with a pointer widget, and/or the like). In an alternative implementation, the first visual token may be automatically animated and/or animate without the need for any user interaction. In the illustrated implementation, the animated first visual token flips to reveal a second visual token comprising a message and an SMS text message prompt on a proximate side 2815. In one implementation, the user may manually key in the text message and/or destination address to receive the associated content. In another implementation, the GCSI/CTIS interface may supply a selectable link that, when selected, will automatically generate an SMS text message to retrieve the associated content. In still another implementation, such as the example illustrated at 2815, the user may be allowed to automatically generate and/or send the SMS text message from the second visual token by pressing a “Send” button on the mobile phone, clicking and/or otherwise interacting with the second visual token, and/or the like.

In one implementation, a user may receive a coupon and/or coupon code in response to an interaction with the second visual token, sending of an SMS text and/or other message in response to the second visual token, and/or the like. For example, in one implementation, a user may receive a numerical coupon code in response to a sent SMS text message, wherein the numerical coupon code may be presented to a retailer, entered into a website, and/or the like to receive discounts, free items, special offers, and/or the like. In another implementation, the user may receive a scannable code, such as a QR code, matrix code, and/or the like in response to a sent SMS text message, wherein the scannable code may be scanned by a retailer in order for the user to receive the associated benefits, discounts, and/or the like. For example, the scannable code may appear on a user's mobile phone display screen and may be scannable therefrom to provide the user with the benefits associated thereto. In another implementation, the user may receive an e-mail message in response to interaction with a graphical code-serving interface, the message containing requested content and/or links thereto, scannable codes, coupon codes, and/or the like.

In another implementation, a first visual token may comprise a “poster” image corresponding to a full-length movie, movie preview, video clip, television show, and/or the like. The second visual token revealed on a proximate side of the first visual token may then enable a user to retrieve the full video content associated with the poster image. For example, a user may scroll through a series of poster images corresponding to a series of full-length movies. When the user finds a movie he or she desires to retrieve, watch, download, and/or the like, he or she may select the corresponding poster image, which may then be animated to reveal a second visual token, such as an SMS instruction, message, delivery address, phone number, and/or the like, whereby the user may interact with a GCSI/CTIS system and/or affiliated entity to retrieve the desired movie content.

In one implementation, a series of first visual tokens may be displayed as scrollable thumbnails, within a cinematic presentation, as an immersive slideshow, and/or the like.

FIG. 26 shows an implementation of a user interface manifesting GCSI/CTIS functionality on a portable communication device in one embodiment of GCSI/CTIS operation. The portable communication device 2901 shown in the illustrated implementation may represent a BlackBerry, iPhone, PDA, and/or the like. A first visual token 2905 is animated 2910 to reveal a message and a selectable hyperlink on a proximate side 2915, in this case a URL connecting to content, information, offers, coupons, and/or the like. In one implementation, a user may be permitted to directly select the hyperlink from the displayed image using interface elements of the device in order to retrieve content, view a webpage, interact with a GCSI/CTIS and/or affiliated system, and/or the like.

A variety of operational models may be employed to provide code-serving interface capabilities to users and content providers alike in accordance with the embodiments and/or implementations described herein. In one implementation, a central GCSI/CTIS server may enable content providers to supply first and/or second visual tokens, associated SMS and/or MMS codes, and/or any other information necessary to connect users to supplied content. The central GCSI/CTIS server may then outfit the supplied tokens and/or other information with HTML markup information allowing the code-serving interface to be embedded in any webpage or other display media. In one implementation, the HTML markup information may further include a link to one or more downloadable applets that may be required to enable a user to view and/or interact with the code-serving interface. Having provided the data corresponding to a first and/or second visual token, SMS and/or MMS code, and/or other information, a content provider may be provided with an embeddable link, URL, and/or the like that may be cut and pasted into a web page HTML to embed the code-serving interface therein.

In another implementation, a content provider may submit just a first visual token and response content and/or a means of addressing said content, and a GCSI/CTIS server may generate a corresponding code-serving interface, a dial-in code and/or SMS and/or MMS address, hyperlink, and/or the like to allow users to interact with the first visual token to receive the response content. In one implementation, the generated code-serving interface may include HTML markup information enabling it to be embeddable on any webpage. A fee may be charged to the content provider, such as on a pay-per-click basis, for user interactions with the generated code-serving interface.

In still another implementation, a webpage or other display area may include a generic placeholder for code-serving interfaces that may be filled by code-serving interfaces and/or associated content supplied from one or more advertisement servers and/or GCSI/CTIS servers. The supplied code-serving interfaces may be selected based on webpage content, contextual cues, and/or the like and/or based on the goals of content providers and/or code-serving interface creators. For example, an advertiser may wish to place a particular code-serving interface associated with a new action movie on any webpage having a generic placeholder that mentions extreme sports. A fee may be charged to an advertiser for such targeted and/or contextual placement, such as on a bid-per-keyword basis. Fees may also be charged on a pay-per-click basis (i.e., levying a charge whenever a user clicks a code-serving interface to reveal the code, communication address, and/or the like on a proximate side).

### GCSI/CTIS Media Acquisition Example

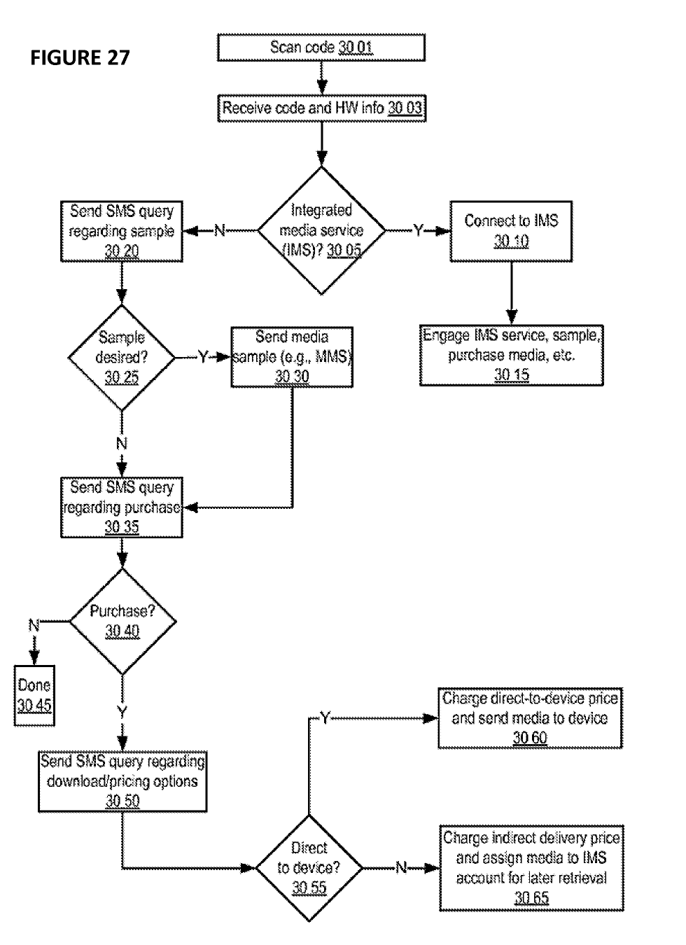

In some embodiments, the GCSI/CTIS may be configured to supply media content, music, images, video, and/or the like to users based on the scanning of codes as described above. Acquisition of full media content may, in some implementations, be preceded by acquisition of media samples that may be reviewed by an acquiring user to determine whether or not to proceed with acquisition of the full content. For example, a billboard may display the Billboard Top 20 songs with a separate code for each song on the list. Consumers, in this example, may scan codes corresponding to each song in the list for which they have interest using a mobile scanning device and receive a sample of each song. In one implementation, a sampling user may further be provided with an opportunity to purchase and/or otherwise acquire the full media content once the sample has been received and/or reviewed. In one implementation, media may be acquired by a user via MMS messaging, while in another implementation, media may be acquired by means of an integrated media service (IMS). The IMS may, in one implementation, comprise an on-demand media service wherein users may maintain accounts, sample and/or purchase media, download and/or upload media, and/or the like. An example of an IMS is Apple's iTunes Store. FIG. 27 shows an implementation of logic flow for media sampling and full media acquisition in one embodiment of GCSI/CTIS operation. A code may be scanned by a user 3001, such as via a mobile device. The scanned code information, as well as hardware information identifying the device, the user, and/or the like may then be received by GCSI/CTIS from the mobile device, such as via a communications network. The GCSI/CTIS may then make a determination, such as may be based on the hardware information, user information, a user profile, and/or the like, as to whether the mobile device is configured with an IMS 3005. If the mobile device is configured with an IMS, the GCSI/CTIS may issue an instruction to the mobile device to connect to the IMS 3010, allowing the user to engage IMS functionality such as the sampling, purchasing, downloading, viewing/playing, and/or the like of media files 3015.

If the user's mobile device is not configured with an IMS, the GCSI/CTIS may send a message to the device, such as an SMS text message 3020, to determine if the user desires to receive a sample of the requested media 3025. In one implementation, the GCSI/CTIS may first interact with a media service to determine if a sample is available before offering the sample to the user. If a sample is desired, the GCSI/CTIS may send a media sample to the user's mobile device, such as in the form of an MMS message. The sample may, in various implementations, comprise a clipped and/or low-quality version of an audio file, image file, video file, publication, and/or the like. In one implementation, the GCSI/CTIS may first acquire the sample from a music service in order to provide it to the user's mobile device. In an alternative implementation, the GCSI/CTIS may itself generate a sample from an original copy of a media file, such as may be acquired from a media service.

The GCSI/CTIS may then generate and send a query, such as via SMS text message 3035, to determine if the user would like to purchase the media associated with the scanned code 3040. If not, the GCSI/CTIS may exit the routine associated with the acquisition of the current media file, present alternative and/or related media files for user consideration, and/or the like 3045. If, on the other hand, the user indicates a desire to purchase the media file in question, the GCSI/CTIS may query the user, such as via an SMS text message, as to which of a selection of pricing and/or download options the user would like to pursue 3050. For example, in various implementations, the user may be provided with options as to the quality and/or format of media files acquired, the method of acquisition, accessibility and/or rental options, and/or the like. In the illustrated implementation, the user may be presented with an option as to the method of media acquisition. Specifically, a determination may be made as to whether or not the media is to be acquired directly by the user's mobile device 3055. In the illustrated implementation, the determination is based on a user preference. However in alternative implementations, the determination may be made, in whole or in part, based on a variety of other factors, such as detected capabilities of the user's mobile device, available network bandwidth, pre-set profile settings, and/or the like. If the user selects for the media to be directly provided to his or her mobile device, then a corresponding fee may be charged and the media may be streamed, downloaded, and/or the like directly to the user's mobile device 3060. Alternatively, if the user does not desire to acquire the media directly to his or her mobile device, then the GCSI/CTIS may charge a price corresponding to an indirect delivery mode and conduct the media file to an intermediary storage facility for later retrieval 3065. For example, the GCSI/CTIS may instruct a media service to allocate the media file to a user account for later retrieval by the user. In another example, the GCSI/CTIS may acquire the media file and/or email the file to a user email account for later retrieval. When the user is ready, he or she may obtain the media file from the intermediary storage facility, transfer the file to a mobile device, and/or the like.

The charging of a fee for acquired media may proceed in a variety of different manners within various embodiments of the GCSI/CTIS. For example, in one implementation, a user may be directly requested to enter payment information (e.g., credit card number, checking account number, etc.) at the time of purchase. The entered information may be verified before the media is made available to the user and/or the user's mobile device. In another implementation, a user may enter payment information into a user profile and have a corresponding account automatically charged when the user directs the GCSI/CTIS to acquire media.

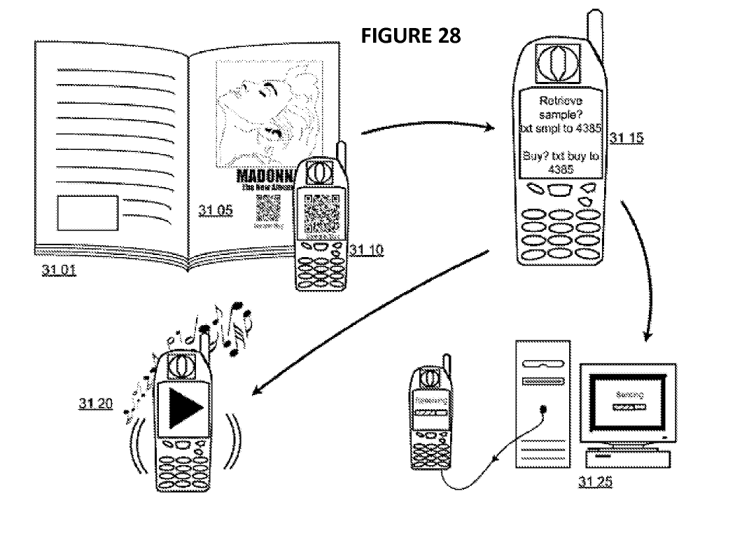

FIG. 28 shows an illustration of media acquisition in one embodiment of GCSI/CTIS operation. In the illustrated implementation, a printed publication 3101 displays an advertisement for a new release by a recording artist 3105, the advertisement including a scannable matrix code that facilitates the acquisition of media associated with the new release by a user. In an alternative implementation, an animated user interface may present a scannable code on a proximate side of a first image, such as on a video billboard, website, television program, and/or the like. The media may, for example, comprise an entire album, a single, a ringtone, a video, an image, and/or the like. In one implementation, the media provided may depend on the scanned code in conjunction with a user profile containing user preferences, a history of user behavior and/or prior scanned codes, and/or the like. The user may engage the media content by scanning the code with his or her mobile device 3110, after which the GCSI/CTIS may query the user, such as via an SMS text message, as to whether or not he or she wishes to sample and/or purchase the requested media 3115. The user may respond, in one implementation, by sending a reply text message to be relayed to the GCSI/CTIS. In one implementation, the GCSI/CTIS may subsequently provide, stream, upload, and/or the like the requested media directly to the user's mobile device for storage and/or playback 3120. In another implementation, the GCSI/CTIS may provide the requested media to an intermediary storage facility, such as a user's media service account, an email server, an ftp server, and/or the like. The user may then subsequently procure the media from the intermediary storage facility, transfer the media to a mobile device, and/or the like 3125 at a later time.

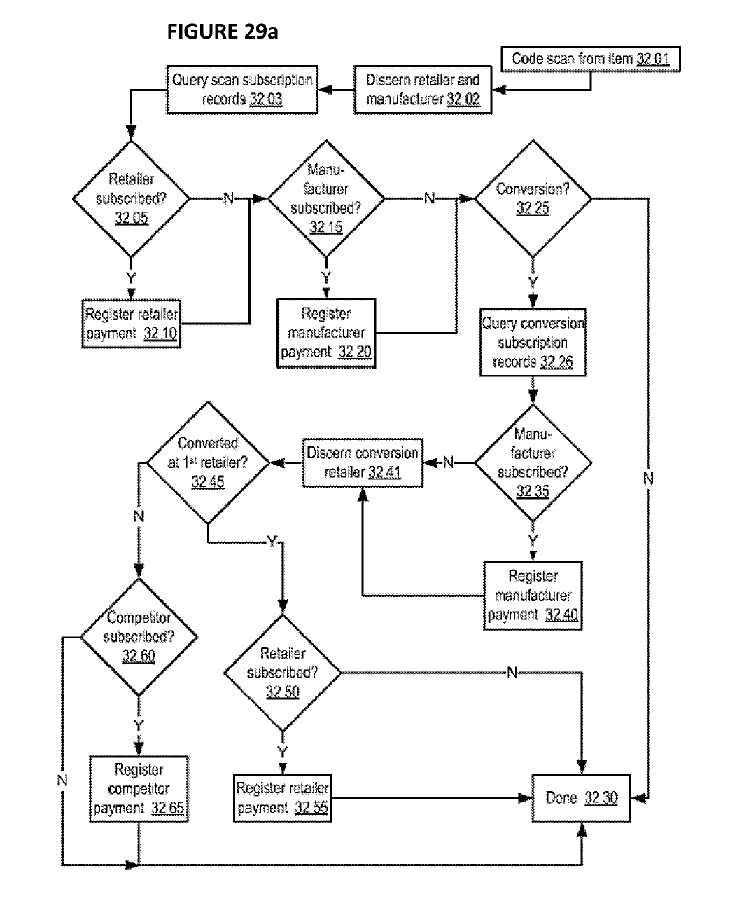

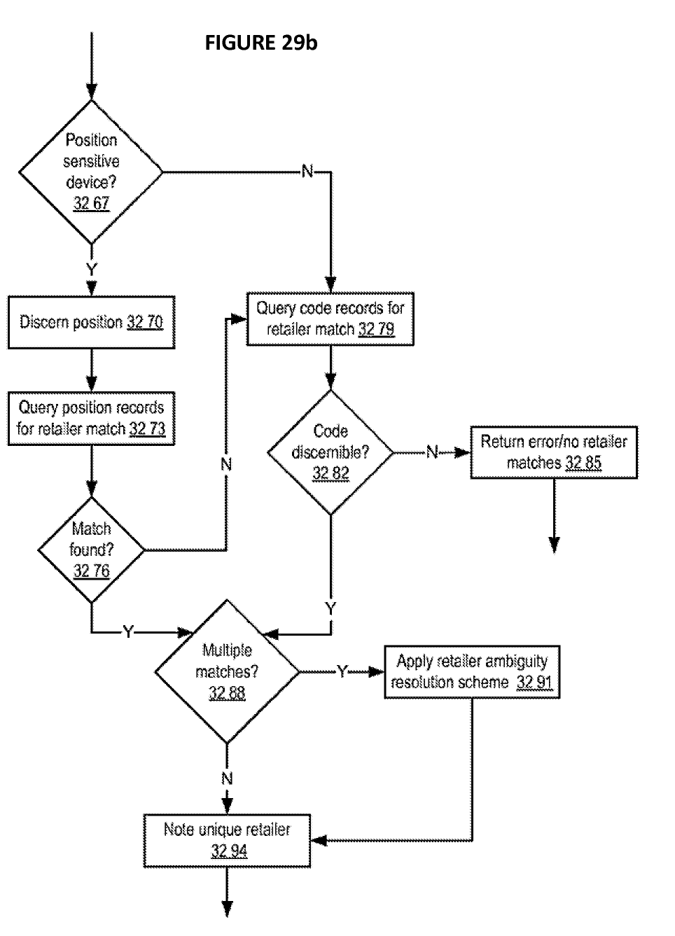

FIGS. 29a-b show an implementation of logic flow for code scan monetization in one embodiment of GCSI/CTIS operation. In FIG. 29a, a code is scanned at 3201. In the illustrated implementation, the code may be found on a physical item that is subject to purchase and may be found in a retail establishment. For example, a compact disc (CD) in a music store may be embellished with a scannable code that, when scanned, may provide a sample of the music stored on the CD, deliver a ringtone to the user's mobile scanning device, provide artist information, images, concert dates, a coupon, and/or the like. In another implementation, the item for purchase may not be physical but rather may be provided online, such as on a website, and an associated code may be provided on the page on which the item is offered for purchase. Once the code is scanned 3201, a determination may be made as to whether the retailer providing the item is subscribed to a GCSI/CTIS service 3205. In one implementation, the retailer may be discerned based on a geographic position provided to the GCSI/CTIS by a code message sent from the user's mobile device that may, for example, be compared to records of retailer locations. The geographic position may be determined, for example, by an on-board GPS unit on the user's mobile device or based on geographic information contained in the scanned code. Subscription to the service may, for example, entail licensing to embellish items with GCSI/CTIS affiliated codes in exchange for a fee, such as a one-time or periodic fee and/or a per-scan fee, such as illustrated in the implementation shown in FIG. 29a. If the retailer is determined at 3205 to be a subscriber, then the GCSI/CTIS may register a retailer payment 3210. For example, in one implementation, registering payment may comprise noting the fee in a fee record. In an alternative implementation, the GCSI/CTIS may automatically deduct the fee from a pre-designated account. A determination may also be made as to whether the manufacturer, publisher, distributor, and/or the like of the item in question is a subscriber 3215. For example, for the case of the CD discussed above, the “manufacturer” may comprise a record label. If the manufacturer is determined to be a subscriber, then a manufacturer payment is registered at 3220.

Discernment of retailer, competitor, and/or manufacturer identities may be accomplished by a variety of different schemes in various implementations and/or embodiments of GCSI/CTIS operation. For example, a unique subset of codes may be reserved for a particular manufacturer, retailer, and/or the like, such that a scan message corresponding to any code of the unique subset may be associated by a GCSI/CTIS system with the particular manufacturer, retailer, and/or the like. In another implementation, retailers associated with a given scanned code may be discerned based on a geoposition of the mobile scanning device at the time of code scanning FIG. 29b provides an illustration of an implementation of logic flow for discerning retailers in one embodiment of GCSI/CTIS operation. A determination is made at 3267 as to whether the mobile scanning device used to scan a code is position sensitive. Position sensitivity of a mobile device may be facilitated, for example, by an on-board GPS unit, mobile device and/or cellular tower triangulation, trilateration, multilateration, and/or the like. If the device includes one or more position sensitive facilities, the GCSI/CTIS may discern the position of the mobile device 3270. Position discernment by the mobile device and/or the GCSI/CTIS may include drawing raw geographic position data from one of the facilities described above using, for example, mobile device software development kit (SDK) tools, an example of which are those associated with the iPhone SDK toolkit. The GCSI/CTIS system may then query position records based on the position discerned at 3270 to seek retailers matching that position 3273. A determination is made at 3276 as to whether any matching retailers are found. If no retailers match the discerned mobile device position, or if the mobile device lacks position sensitivity at 3267, the GCSI/CTIS system may query code records based on the scanned code received from the mobile device to seek retailers matching the scanned code 3279. A determination is made at 3282 if any retailers are code discernible and, if not, then the GCSI/CTIS may return an error message and/or record that no matching retailer was found 3285. If any matches are find either by position or code discernment, then a determination may be made as to whether there exist multiple retailer matches 3288. If not, then the unique matching retailer may be recorded, provided to facilitate subsequent code scan monetization, and/or the like 3294. If multiple retailer matches exist, the GCSI/CTIS system may apply one or more retailer ambiguity resolution schemes 3291 in order to narrow down the results to a unique retailer match. A wide variety of ambiguity resolution schemes may be employed within different implementations and/or embodiments of GCSI/CTIS operation. For example, in one implementation, a GCSI/CTIS system may consult a user profile associated with the user who's mobile device issued the code scan to determine whether the user's code scan history indicates a preference for a particular retailer, retailer type, and/or the like which may assist in further discerning the unique retailer associated with the current code scan. In another implementation, the GCSI/CTIS system may provide a plurality of possible retailer matches in a message (e.g., an SMS message) to a user's mobile device and request feedback as to which retailer is the correct one in whose establishment the code was scanned.

A determination may then be made as to whether a conversion has taken place whereby the user has actually purchased the item associated with the scanned code. In one implementation, the GCSI/CTIS may monitor activity on a credit card associated with a user account once that user has registered a code scan. A subsequent purchase using the associated credit card may then register a conversion with the GCSI/CTIS. If no conversion is detected, such as within a pre-designated period of time, then the code scan monetization is complete for the particular code scan 3230. If, on the other hand, a conversion is registered, the determination may be made as to whether the manufacturer is subscribed to pay further fees upon item conversion 3235. If so, then the additional manufacturer payment for conversion is registered at 3240.

A determination may be made as to whether the conversion, i.e., the purchase of the code-associated item, was made at the retailer at which the code was scanned 3245. If so, then a determination may be made as to whether the retailer is subscribed to pay an additional fee associated with item conversion 3250. If so, that payment is registered at 3255. If the conversion occurs at a competitor retailer different than the original retailer at which the item-associated code was scanned (e.g., another brick-and-mortar retailer, another website, etc.), a determination may be made as to whether the competitor retailer is subscribed to pay a fee for item conversion 3260. If so, then the competitor payment may be registered at 3265. In one implementation, a competitor may be permitted to supply a message (e.g., an SMS text message, and/or the like) to a user's mobile device when the user scans codes associated with particular items at particular retail locations in order to entice the user to purchase the item from the competitor instead of at the particular retail location in which the code was scanned. The competitor message may, for example, include a coupon and/or other discount on the sale price of the code-associated item. In one implementation, the competitor may be charged a separate fee for being allowed to supply such messages, such as a per-message fee, a one-time or periodic fee, and/or the like.

In some implementations, fees charged to manufacturers, retailers, and/or competitors may be substantially the same. In alternative implementations, different fees may be charged to manufacturers, retailers, and/or competitors.

FIGS. 30a-e show aspects of implementations of JagTag encoding and codes in some embodiments of GCSI/CTIS operation. FIG. 30a shows an implementation of logic flow for JagTag encoding in one embodiment of GCSI/CTIS operation. An alphanumeric string may be associated with content to which a JagTag code is ultimately to be associated 3301. In one implementation, a five character string is employed. Each character of the alphanumeric string may then be converted into a corresponding integer, such as may be based on a correspondence table 3302. FIG. 30b shows an implementation of such a corresponding table relating decoded characters, including lowercase letters 3313, numbers 3314, and uppercase letters 3315, to encoded values 3316 comprising integers between 0 and 62. To convert the alphanumeric string into a JagTag code, each character in the string is converted into a corresponding integer between 0 and 62 using the table in FIG. 30b. A determination may then be made as to whether any of the characters comprise punctuation marks or other unrecognizable or unconvertible characters 3303. If so, those characters are set to blanks or zeros in the resulting string of integers 3304. A determination may also be made as to whether the number of characters in the alphanumeric string exceeds a pre-designated maximum number 3305 (e.g., 5 characters). If so, additional characters are ignored 3306.

Each resulting integer may then be converted to a corresponding binary value 3307, and a determination may be made as to whether there are a sufficient number of “on” bits (i.e., bits equal to 1) 3308. For example, the GCSI/CTIS may require the existence of at least some minimum number (e.g., 9) of on bits. If not, then the system may return an error message and/or recommend that the user try a different initial alphanumeric string 3309. Otherwise, the GCSI/CTIS system may concatenate the string of binary numbers to yield a single 32-bit long bitset array 3310. The system may then generate a JagTag bit representation 3311, as described below, and output the resulting JagTag to a physical display and/or storage (e.g., storing an image formatted JagTag in a database, printing the JagTag, displaying the JagTag on a display screen, and/or the like) 3312.

The first bit of the bitset array may be considered a most-significant bit and the last bit of the bitset array may be considered a least-significant bit. Once complete, the 32-bit binary bitset array may be converted into a JagTag code representation. FIG. 30c further illustrates JagTag encoding in one implementation. The JagTag may include an L-shaped component 3318 that may, in one implementation, promote orientational and/or size discrimination of the JagTag, such as by a scanning or analyzing device. The JagTag may further include four circular elements 3319 that may also serve to promote orientational and/or size discrimination. The most significant bit of the bitset array may be encoded as a circle at the position indicated by the crossed circle at 3320, with a white circle (owing to the dark background of the L-shaped component 3318) indicating a 1 and no circle indicating a 0. The next most significant bit of the bitset array, then, may be encoded as a circle at the position indicated by the crossed circle at 3325. The numbering scheme indicated at 3330 shows how the circles (or lack of circles) at positions numbered from 0 to 31 correspond to the bits in the 32-bit bitset array, with 0 the most significant bit and 31 the least significant bit. If the bit falls on the L-shaped component 3318, a white circle is drawn for a bit value of 1, and otherwise a dark circle is drawn for a bit value of 1.

In one implementation, a shell script may be configured to accept an alphanumeric string comprising characters to be encoded and to return a JagTag in an image format, such as a PNG, JPG, GIF, BMP, and/or the like file format. In one implementation, the shell script may be further configured to receive a color specification (e.g., an HTML-style RGB triplet).

Configuring a JagTag for optimal recognition may be accomplished in a variety of different ways within different implementations. For example, a color for the JagTag code may be selected to as to have high contrast with the background color. A high number of “on” bits (i.e., bits equal to 1) may also improve code recognition, as discussed above. Accordingly, in one implementation, resulting JagTag codes having less than a minimum number of on bits may be rejected. Other measures that may be taken in various implementations to improve JagTag recognition may include maximizing code dimensions, ensuring that the code is surrounded by a substantial margin (e.g., at least 25% of the code's width and height), and ensuring fidelity of the code by eliminating any obscuring interferences. JagTag codes may be configured for a wide variety of physical manifestations, including printing on magazine pages, billboards, newspapers, and/or the like, displaying on video display screens, television broadcasts, websites, and/or the like. JagTags may also be configured into different shapes or display configurations in various implementations.

FIG. 30d shows one non-limiting embodiment of data loss resilient codes 3331, with characteristics that include: reducing errors based on “bleeding” of encoded data points by using circles/dots rather than squares that touch each other (this combats fuzziness of image as well as reduced light conditions); using a stronger identifier to discover processing directionality (rotation, skew, slant)—this is the black line with white dots shown in the figure; including data points within the identifier in order to maximize encoded data as well as allow for reduction in size of code; using equidistant lengths on identifier to process for skew and slant; using constant data points within the directional identifier to process for skew and slant—this may be top left, bottom right and bottom left white dots (not indicated in FIG. 30d); reducing the amount of data encoded in the code—most likely 5-8 characters—in order to allow for size reduction of the code; developing code characteristics so partial decoding allows for matching code to correct data on the server—for example, if only 70% of the characters from a code are discernible, the GCSI/CTIS can use server logic to extrapolate what the code is as well as the campaign/client it's associated with, i.e., information about the exact publication the code is in may be lost, but the GCSI/CTIS system can figure out the campaign and return an appropriate message; with regard to partial decode matching, server side and database logic focuses both on creating codes for clients and campaigns that are unique sets in order to enable partial decode matching as well as providing a set of rules around time, mobile number, and likelihood in order to determine the best potential match for partial decodes.

In the embodiment of the basic codes 3331 shown in FIG. 30d, design wrapped around the code does not impact the effectiveness of the decoding. High tone color differentials are allowed, so rather than black, dark blue or red could be used. The white dots in the identifiers are less likely to allow for color changes although a very light yellow or gray may be allowed.

In a further embodiment, the dots most likely to be lost in an image may be assessed and the least useful information encoded appropriately based on that assessment. An interesting opportunity for this code is that it allows for some logos to potentially replace the dots. For example, an Alltel logo can be used nearly as well as the dots, or a Nike logo is decodable with some server side code modifications.

The codes have an additional benefit in that they are in and of themselves, aesthetically pleasing, and as such offer significant advantages over previous codes. The ability in one embodiment, to vary the colors of the code, allows it to better integrate and look better in marketing contexts.

FIG. 30e shows some implementations of alternative JagTag display configurations, including circular 3335, triangular 3340, modified squares (3345, 3350, 3365), rectangular 3370, letter shaped (J shapes shown at 3355 and 3360), and/or the like. JagTags may also be displayed in proximity to and/or integrated with other codes, logos, insignias, and/or the like, such as shown at 3375.

### Ambiguous Codes

In an embodiment, a processor-implemented method is disclosed for processing and responding to ambiguous content requests. A scanned code image and a user ID are received and analyzed to determine if the information encoded therein is fully decodable. A scanned code disambiguation process is selected and applied to the ambiguous scanned code images to determine a most likely code. Accumulated user information in a user profile associated with the user ID is queried. A content database is queried to extract requested content based on the most likely code and the accumulated user information. The requested content is sent to the user.

### Coupon and Content Sharing

In another embodiment, the CTIS provides targeted coupons to consumers. By scanning a code in an article or advertisement of interest, a user may be provided with a coupon code for a store or establishment near the location where the scan took place, thereby increasing the likelihood that the coupon would be used. Choosing the coupon based on the contents of the user profile may further increase the likelihood of a consummated transaction.

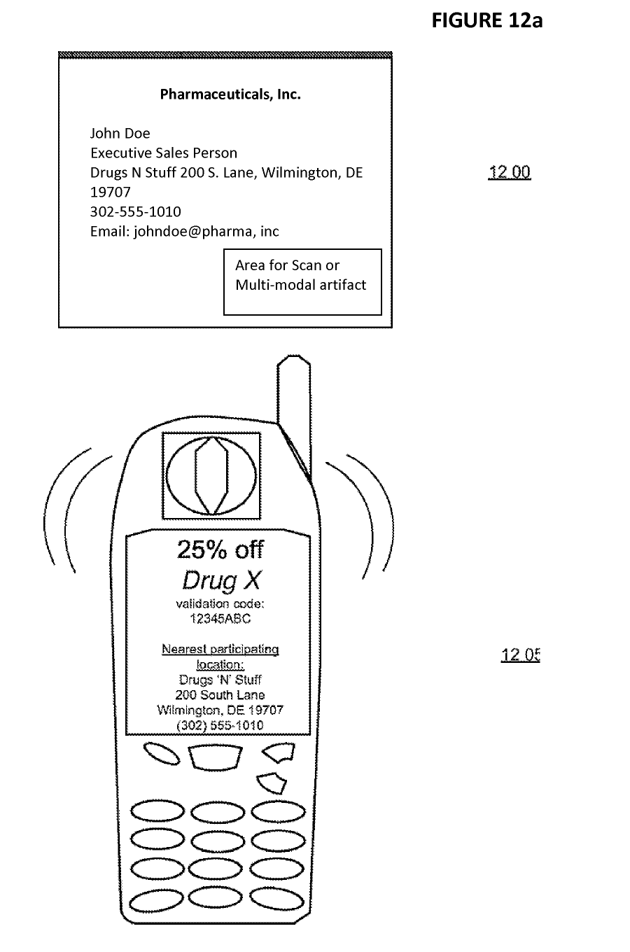

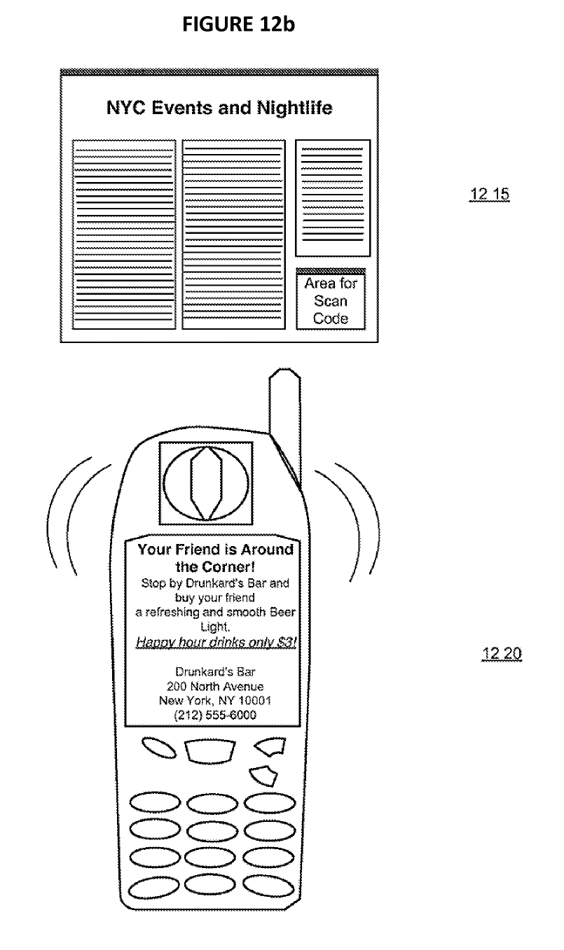

FIGS. 12a-b show two examples wherein the CTIS supplies coupons and/or discount info to a user. FIG. 12a shows an advertisement 1200 for hay fever medication that contains a scan code. Upon scanning the code, the user's cell phone is supplied with a coupon 1205 for 25% off the advertised medication, along with a nearby store at which to redeem the coupon. FIG. 12b shows an article related to events and nightlife in New York City 1215 that contains a scan code. Upon scanning the code to obtain additional content, the user may also be provided with a contextual advertisement for a local bar 1220, including an announcement of happy hour discount prices based on the time of the scan. In an alternative embodiment, the coupon could be provided to the user based on an anticipated provider zone breach rather than a contiguous, causal code scan.

### Product Information

In another embodiment, the CTIS can be used to provide information regarding consumer products that cannot be included on the product packaging. By scanning a code printed on a consumer product package, the user could be provided with nutritional information, ingredients, website links, coupons, etc. Additional advertisements could also be served based on the nature of the product scanned and the user profile. For example, a user who scans a container of mustard and has “grilling” listed among his/her interests may be served an advertisement and/or coupon for hot dogs in addition to the mustard information.

The CTIS provides a targeted information serving system that may be applied to a wide variety of marketing and information dispensation applications. In one embodiment, the CTIS creates enhanced ads with content that cannot be included in a print ad. For example, a user who scans a code related to an automobile ad is provided additional content pertaining to the automobile such as detailed images, video, audio, reviews, and links to additional information. Based on the geocode provided in the Scan Message, the CTIS may provide a list of local dealerships and pricing. Based on the user profile, the CTIS may suggest other automobiles by the same manufacturer that are popular with customers that share the same income bracket, geographic address, number of children, etc., as the user.

A method for directing a user to a position within a multi-dimensional space, comprising: receiving multi-modal artifact data scanned from a multi-modal artifact by a user engaging with the multi-modal artifact; communicating at least some of the multi-modal artifact data to a data repository; comparing the communicated data with data present in the data repository to determine a product/service of interest to the user; determining a first position corresponding to the user's current position in the multi-dimensional space, based on the communicated data; comparing the product/service of interest to the user with a user profile accessible to the data repository; identifying at least one second position corresponding to the location of the product/service of interest to the user within the multi-dimensional space, based upon information accessible by the data repository; accessing a planogram for the at least one second position, which reflects inventory of the product/service of interest; determining if the inventory of the product/service available at the at least one second position matches product/service requirements drawn from the user profile; prompting the user to select from the at least one second position where the product/service matching requirements drawn from the user profile is available; calculating a route between the first position of the user and the user selected second position of the product/service of interest to the user; sending at least one reply message from the data repository to the user's digital device based upon the communicated data and calculated route; and displaying the route to the user.

A method for directing a user to a position within a multi-dimensional space, comprising: identifying a product/service of interest to the user; acquiring identification data related to the product/service of interest to the user with the user's digital device; communicating at least some of the identification data to a data repository; comparing the communicated data with data present in the data repository to determine the product/service of interest to the user; determining a first position corresponding to the user's current position in the multi-dimensional space, based on the communicated data; identifying at least one second position corresponding to the location of the product/service of interest to the user within the multi-dimensional space, based upon information accessible by the data repository; accessing a planogram for the at least one second position, which wherein the planogram for the at least one second position reflects inventory of the product/service of interest; calculating a route between the first position of the user and the user selected second position of the product/service of interest to the user; communicating at least one reply message to the user's digital device based upon the communicated data and calculated route; and displaying the route to the user.

A system for directing a user to a position within a multi-dimensional space, comprising: a processor; a memory in communication with the processor and containing program instructions; an input and output in communication with the processor and memory; wherein the processor executes program instructions contained in the memory and the program instructions comprise: receiving multi-modal artifact data scanned from a multi-modal artifact by a user engaging with the multi-modal artifact; communicating at least some of the multi-modal artifact data to a data repository; comparing the communicated data with data present in the data repository to determine a product/service of interest to the user; determining a first position corresponding to the user's current position in the multi-dimensional space, based on the communicated data; identifying a second position corresponding to the location of the product/service of interest to the user within the multi-dimensional space, based upon information accessible by the data repository; calculating a route between the first position of the user and the second position of the product/service of interest to the user; sending at least one reply message from the data repository to the user's digital device based upon the communicated data and calculated route; and displaying the route to the user.

What is claimed is:

1. A method for directing a user to a position within a multi-dimensional space, comprising:
a. identifying a product/service of interest;
b. communicating the identity of the product/service of interest to a data store;
c. determining a first position corresponding to the user's current position in the multi-dimensional space;
d. determining a position of the identity of the product/service of interest within the multi-dimensional space based upon information in the data store;
e. calculating a route between the first position of the user and the position of the product/service of interest to the user; and
f. displaying the route.

2. A method for directing a user to a position within a multi-dimensional space, comprising the steps of:
a. Receiving multi-modal artifact data captured from a multi-modal artifact;
b. Communicating at least some of the received multi-modal artifact data to a data repository;
c. Comparing the communicated data with data present in the data repository; and
d. Sending at least one reply message from the data repository based upon the communicated data.

3. A method for directing a user to a position within a multi-dimensional space, comprising:
a. Receiving multi-modal artifact data scanned from a multi-modal artifact;
b. Communicating at least some of the multi-modal artifact data to a data repository;
c. Comparing the communicated data with the data present in the data repository to determine a product/service of interest to the user;
d. Determining a first position corresponding to the user's current position in the multi-dimensional space, based on the communicated data;
e. Identifying a second position corresponding to the location of the product/service of interest to the user within the multi-dimensional space, based upon information accessible by the data repository;
f. Calculating a route between the first position of the user and the second position of the product/service of interest to the user;
g. Sending at least one reply message from the data repository to the user based upon the communicated data and calculated route; and
h. Displaying the route to the user.

4. The method of claim 3, wherein the multi-modal artifact comprises data being representative of at least one sensory input of visual, auditory, haptics, olfactory, or gustatory.

5. The method of claim 3, wherein the multi-modal artifact comprises data that is representative of a barcode, 2D code, 3D code, 3D-VR code, matrix code, data matrix, QR code, Near Field Communications (NFC) tag, Radio Frequency Identification (RFID) tag, Bluetooth, Infrared (IR), and/or Wireless communication.

6. The method of claim 3, further comprising the step of accessing a user profile, based upon the communicated data and wherein the user profile reflects repeated or similar user interest in a particular brand, style, size, color, product, and/or service.

7. The method of claim 3, wherein the route between the first and second positions is calculated by an ant colony optimization algorithm.

8. The method of claim 3, wherein the route between the first and second positions is calculated using bundled savings reports.

9. The method of claim 3, further comprising prompting the user to select from a plurality of locations of the product/service of interest to the user.

10. The method of claim 9, wherein the user is prompted to select a range within which they would be interested in locating the product/service of interest.

11. The method of claim 9, wherein the plurality of locations are determined by the data repository based upon the communicated data and information accessible to the data repository.

12. The method of claim 3, wherein the data repository accesses a planogram to indentify the second position corresponding to the location of the product/service of interest to the user within the multi-dimensional space.

13. The method of claim 12, wherein the planogram data is supplied by a third party or a retailer and reflects a store inventory of the product/service of interest to the user within the multi-dimensional space.

14. The method of claim 13, wherein the local store inventory is acquired by direct inventory query to the store or stores carrying inventory or via communication by the digital device with a server system capable of inventory queries of stores carrying inventory of the product/service of interest.

15. The method of claim 14, further comprising comparing the local store inventory with a user profile accessible to the data repository, to determine the second position.

16. The method of claim 3, wherein the calculation of the route between the first and second positions involves a tri-level mapping formula.

17. The method of claim 3, further comprising collecting ambient data and wherein the ambient data is collected by the digital device.

18. The method of claim 17, further comprising utilizing at least some of the collected ambient data as a means for user product/service selection.

19. The method of claim 18, further comprising utilizing at least some of the collected ambient data in a tri-level mapping formula or algorithm in directing the user to a location or locations where the product/service of interest is located.

20. The method of claim 3, further comprising displaying coupon or store/vendor authorized discount to the user, based upon the product/service of interest.
